(19) United States
(12) Patent Application Publication
(10) Pub. No.: US 2004/0161192 A1
(43) Pub. Date: Aug. 19, 2004

(54) Exposing apparatus and image forming apparatus using organic electroluminescence element

(75) Inventors: Takafumi Hamano, Fukuoka (JP); Akira Gyotoku, Saga (JP); Yuji Toyomura, Fukuoka (JP); Hideki Maruyama, Fukuoka (JP); Tetsuro Nakamura, Hyogo (JP); Kenichi Masumoto, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/736,747

(22) Filed: Dec. 17, 2003

(30) Foreign Application Priority Data
Dec. 18, 2002 (JP) P. 2002-366563
Dec. 18, 2002 (JP) P. 2002-366564
Dec. 18, 2002 (JP) P. 2002-366565
Jul. 9, 2003 (JP) P. 2003-194211

(51) Int. Cl. G02B 6/26

(52) U.S. Cl. 385/31

(57) ABSTRACT

A light source includes a light emitting unit including a light emitting layer for electrically emitting a light, and a waveguide for emitting a light irradiated from the light emitting unit into air through a light take-out surface formed on an end face, wherein an area of the light take-out surface of the waveguide is set to be smaller than that of the light emitting layer. Thus, the light irradiated from the light emitting layer is emitted through the light take-out surface of the waveguide. Therefore, it is possible to freely determine the size of the light source by the size of the light take-out surface of the waveguide. Consequently, it is possible to easily obtain a very small light source.

### BACKGROUND OF THE INVENTION

1. Field of the Invention

The present invention relates to an image forming apparatus using exposing means constituting a light source thereof by an organic electroluminescence element.

Further, the present invention relates to a light source such as a backlight for various display devices or display devices, or a light source to be used in a light emitting unit utilized in an optical communication apparatus, a parallel light illuminating apparatus using the light source, and an image projecting apparatus.

2. Conventional Art

An electroluminescence element is a luminescence device utilizing electroluminescence of a solid fluorescent substance, currently, an inorganic electroluminescence element using an inorganic species material as a luminescence substance is reduced into practice and application and development thereof to a back light, a flat display or the like of a liquid crystal display is partially achieved. However, according to an inorganic electroluminescence element, voltage necessary for being luminescent is as high as 100V or higher, blue color luminescence is difficult and therefore, full color formation by three principal colors of RGB is difficult. Further, according to an inorganic electroluminescence element, a refractive index of a material used as a luminescence substance is very large and therefore, the material undergoes intensive influence of total reflection at an interface or the like, an efficiency of taking out light into air with regard to actual luminescence is as low as about 10 through 20% and high efficiency formation is difficult.

Meanwhile, researches on an electroluminescence element using an organic material have long attracted attention and various investigations have been carried out, however, since a luminescence efficiency is very poor, the researches have not progressed to a full scale research on reduction to practice.

However, in 1987, there has been proposed an organic electroluminescence element having a laminated layer structure of a function separating type dividing an organic material into two layers of a hole transporting layer and a luminescent layer by C. W. Tong of Kodak Company and it has been found that a high luminescent brightness equal to or higher than 1000 cd/m² has been achieved regardless of low voltage equal to or lower than 10V [refer to C. W. Tang and S. A. Vanslyke; Appl. Phys. Lett. 51(1987)913 etc.].

Thereafter, an organic electroluminescence element has started to suddenly attract attention, currently, researches on an organic electroluminescence element having a similar laminated layer structure of a function separating type are intensively carried out. Investigations are carried out sufficiently particularly on high efficiency formation/long service life formation which is indispensable for reducing an organic electroluminescence element into practice and in recent years, a display or the like using an organic electroluminescence element is realized.

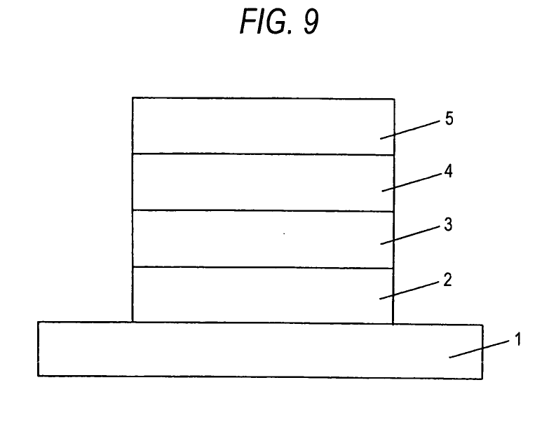

The structure of a conventional general organic electroluminescence element will be described with reference to FIG. 9.

FIG. 9 is a sectional view showing the main part of the conventional organic electroluminescence element.

In FIG. 9, 22 denotes a glass board, 23 denotes an anode, 24 denotes a hole transporting layer, 25 denotes a light emitting layer, and 26 denotes a cathode.

As shown in FIG. 9, the organic electroluminescence element comprises the anode 23 formed by a transparent conductive film such as ITO which is provided on the glass board 22 by a sputtering method or a resistance heating evaporation method, the hole transporting layer 24 formed of N,N′-diphenyl-N,N′-bis(3-methylphenyl)-1,1′-diphenyl-4,4′-diamine (hereinafter abbreviated to TPD), the light emitting layer 25 formed of 8-Hydroxyquinoline Aluminum (hereinafter abbreviated to Alq3) which is provided on the hole transporting layer 24 by the resistance heating evaporation method, and the cathode 26 formed by a metal film having a thickness of 100 nm to 300 nm which is provided on the light emitting layer 25 by the resistance heating evaporation method.

When a DC voltage or a DC current is applied by setting the anode 23 and the cathode 26 in the organic electroluminescence element having the structure to be plus and minus poles respectively, a hole is injected from the anode 23 into the light emitting layer 25 through the hole transporting layer 24 and an electron is injected from the cathode 26 to the light emitting layer 25. In the light emitting layer 25, the recombination of the hole and the electron is generated. When an exciton generated correspondingly is changed from an excitation state to a normal state, a light emitting phenomenon is caused.

Herein, a light irradiated from a general light source excluding a special light source such as a laser is a dispersed light. In an exposing device for irradiating a light on a specific place, most of the light is wasted so that an efficient light irradiation cannot be carried out. Accordingly, it is necessary to use an optical system capable of carrying out the efficient light irradiation. In the case in which a light source having a problem of a lifetime, for example, an organic electroluminescence element is used, particularly, it is necessary to use the optical system for implementing the efficient light irradiation.

A recording apparatus using an electrophotographic technology is provided with an exposing device for irradiating an exposed light corresponding to image data on a photosensitive member charged uniformly to have a predetermined electric potential and writing an electrostatic latent image onto the photosensitive member. A conventional exposing method in the exposing device mainly includes a method of scanning a laser. In the case in which the laser is used in the exposing method, however, a space occupied by an optical component such as a polygon mirror or a lens is large so that it is hard to reduce the size of the apparatus.

Further, when the above-described organic electroluminescence element is used as a light source of a printer, the problems can be resolved. However, the organic electroluminescence element poses a problem with regard to long time period stability in which a luminescence efficiency is deteriorated in accordance with a luminescence amount and therefore, it is difficult to irradiate bright exposure light for a long period of time. Hence, when an optical system of a waveguide or the like is used, a bright exposing apparatus having a long life can be realized. Further, there is an element structure of an organic electroluminescence element disclosed in U.S. Pat. No. 5,917,280 or, U.S. Pat. No. 5,932,895 or the like.

However, these light sources are applied variously. In the use for irradiating a light from a very small point light source onto a minute region, particularly, the area of a very small light emitting section in a current point light source such as an inorganic LED has a problem in consideration of the dispersion of the light. Also in the use for obtaining a parallel light by utilizing the dispersed light which is irradiated from the point light source, moreover, a sufficiently small point light source having a size of several μm or less has been required in order to obtain a small-sized parallel light source. However, it is hard to reduce the area of a light emitting section while maintaining a sufficient amount of the light. At present, a sufficiently small point light source is not used practically.

In the case in which a surface light source such as an electroluminescence element is used for the point light source, furthermore, it is possible to use the surface light source as a false point light source by setting a spot for shielding and taking out a light to be dotted. Alternatively, it is also possible to implement a very small point light source by shielding the light of the point light source. In case of the application, however, there is a problem in that most of lights are wasted or a point light source having a greater brightness than that of an original light source cannot be implemented. In any case, a small point light source having a great brightness has not been implemented.

As described above, the exposing device using the laser requires a space for scanning the laser. For this reason, it is hard to form a small-sized exposing device. In order to implement the small-sized exposing device using no laser, therefore, it is necessary to utilize a light source such as an inorganic LED or an organic electroluminescence element.

In recent years, in an exposing device using, for a light source, an inorganic LED which is practically used as an exposing device for a small-sized printer, exposure is carried out by a dispersed light emitted from the inorganic LED. However, it is hard to form an optical system for efficiently propagating a light for the dispersed light. For this reason, the optical system in the exposing device has a low light utilization efficiency. In the exposing device using the inorganic LED method, accordingly, it is necessary to cause the inorganic LED to emit a light excessively.

In the case in which the organic electroluminescence element for emitting the dispersed light is used as a light source and an exposing device having the same structure as that of the inorganic LED is formed, similarly, it is apparent that the organic electroluminescence element is to emit a light excessively. In the case in which a light source having the problem of a lifetime, for example, the organic electroluminescence element is used, however, a large amount of a light is obtained if a current to be applied to an electrode is increased. Consequently, a load in a light emitting layer is increased so that the lifetime of the element is shortened and the frequency of the exchange of components is increased, which is not desirable.

However, light irradiated from the organic electroluminescence element is diffused light and therefore, when the element of the prior art is used as an exposure light source of a printer as it is, a desired electrostatic latent image cannot be provided by the diffused light and therefore, an optical system for focusing or irradiating light is needed and small-sized formation of the apparatus cannot be sufficiently carried out by a total of the exposing apparatus. Further, according to the element of the prior art, the latent image is formed on the photosensitive member by exposure light having a small light amount. Then, the image quality is deteriorated such that the provided image becomes unclear.

Here, in order to avoid such a problem, wasteful diffused light may be shielded by increasing current applied to the electrode of the organic electroluminescence element without using a complicated optical system. Thereby, exposure light having a light amount necessary for forming the electrostatic latent image is provided, however, in this case, load of the organic electroluminescence element is increased to shorten element life and increase a frequency of interchanging parts and therefore, the constitution is not preferable.

However, the exposing apparatus using the optical system such as a wave guide and the organic electroluminescence element is characterized in that an area of a luminescent layer is larger than that of the exposing apparatus comprising the organic electroluminescence element of the prior art. Therefore, there poses a problem with regard to long time period stability of an element in which a possibility of shortcircuiting an anode and a cathode in the luminescent layer which is brought about by being caused by a foreign matter or the like in the luminescent layer becomes high in proportion to the area of the luminescent layer and which has not been problematic in the exposing apparatus comprising the organic electroluminescence element of the prior art.

Further, according to the exposing apparatus using the optical system such as the wave guide and the organic electroluminescence element, not only the area of the luminescent layer is enlarged but also the shape of the luminescent layer becomes a slender shape similar to the shape of the wave guide and therefore, a total of lengths of surrounding sides forming the luminescent layer becomes longer than that of a luminescent layer having the same area. The long surrounding sides signifies a large number of stepped differences formed by the anode and the cathode forming the sides to thereby pose a problem with regard to long time period stability of the element that possibility of shortcircuiting the anode and the cathode at an end portion of the luminescent layer brought about by being caused by the stepped differences becomes high.

### SUMMARY OF THE INVENTION

Hence, it is an object of the invention to provide an exposing apparatus and an image forming apparatus using a small-sized organic electroluminescence element capable of providing an exposure light amount necessary for exposure without shortening element life.

In order to solve the problems of the very small point light source, a light source according to the invention comprises at least a light emitting unit including a light emitting layer for electrically emitting a light, and a waveguide for emitting a light irradiated from the light emitting unit into air through a light take-out surface formed on an end face, wherein an area of the light take-out surface of the waveguide is set to be smaller than that of the light emitting layer.

Thus, the light irradiated from the light emitting layer is emitted through the light take-out surface of the waveguide. Therefore, it is possible to freely determine the size of the light source by the size of the light take-out surface of the waveguide. Consequently, it is possible to easily obtain a very small light source.

In order to attain the object, an exposing device according to the invention is a light source comprising at least a light emitting unit including a light emitting layer for electrically emitting a light, and a waveguide for receiving a light irradiated from the light emitting unit onto a light incidence plane and emitting the light into air from a light emitting plane formed on a surface other than the light incidence plane, wherein the waveguide has an area of the light emitting plane which is smaller than that of the light incidence plane, and has a size decreased gradually from the light incidence plane toward the light emitting plane.

By using the waveguide which has the smaller area of the light emitting plane than that of the light incidence plane and has a size decreased gradually, thus, the incident light is emitted from the light emitting plane with a reduction. Therefore, it is possible to utilize a light wasted when the waveguide is used as a dispersed light source. Consequently, it is possible to increase the amount of a light without increasing a burden for a light emitting layer. Thus, it is possible to easily obtain an efficient large light amount. With such a structure, in the case in which an organic electroluminescence element is particularly used as a light source, it is possible to obtain a necessary light amount for exposure by simply increasing the area of the light emitting layer. Therefore, it is possible to easily implement the exposing device using the organic electroluminescence element without increasing an applied current to shorten the lifetime of the element.

In order to resolve the problem, an exposing apparatus of the invention is an exposing apparatus constituting a light source by an organic electroluminescence element comprising at least an anode for injecting holes, a luminescent layer having a luminescent region and a cathode for injecting electrons above a board, the exposing apparatus including a wave guide an end face in a sub scanning direction of which is made to constitute a light taking out face and light irradiated from the luminescent layer and incident on the wave guide and emitted from the light taking out face is used as exposure light.

In this way, light irradiated from the luminescent layer of the organic electroluminescence element and emitted from the light taking out face which is the end face in the sub scanning direction of the wave guide is made to constitute exposure light and therefore, a luminescent light amount is increased only by enlarging an area of the luminescent layer. Further, since light can be taken out from a side of the end face relative to the luminescent layer, a small-sized formation and a thin-sized formation of a total of the exposing apparatus can be achieved. Thereby, a luminescent light amount necessary for exposure can be provided without shortening element life by increasing applied current and small-sized formation and thin-sized formation having a high degree of freedom of arrangement can be achieved.

In order to resolve the problem, there is provided an exposing apparatus comprising at least an organic electroluminescence element constituting a light source and a wave guide an end face in a sub scanning direction of which is made to constitute a light taking out face above aboard, wherein light irradiated from the organic electroluminescence element and incident on the wave guide and emitted from the light taking out face is used as exposure light and wherein the organic electroluminescence element includes at least an anode constituting an electrode for injecting holes, a cathode constituting an electrode for injecting electrons and a luminescent layer formed between the anode and the cathode and having a luminescent region and a thickness of the luminescent layer is made to be thicker than a thickness of the electrode.

In this way, the thickness of the luminescent layer of the organic electroluminescence element is made to be thicker than the thickness of the electrode and therefore, a possibility of shortcircuit in the luminescent layer becomes low. Further, the thickness of the luminescent layer is sufficiently thinner than that of the board of the organic electroluminescence element and therefore, a small-sized exposing apparatus can be realized. Thereby, a luminescent light amount necessary for exposure can be provided by increasing applied current without shortening element life and an exposing apparatus having a high degree of freedom of arrangement and capable of achieving small-sized formation and thin-sized formation can be realized.

Further, in order to resolve the problem, there is provided an exposing apparatus comprising at least an organic electroluminescence element constituting a light source and a wave guide an end face in a sub scanning direction of which is made to constitute a light taking out face wherein light irradiated from the organic electroluminescence element and incident on the wave guide and emitted from the light taking out face is used as exposure light and wherein the organic electroluminescence element includes at least an anode constituting an electrode for injecting holes, a cathode constituting an electrode for injecting electrons and charge generating layers respectively formed between the anode and the cathode for injecting electrons to a luminescent layer on a side proximate to the anode and injecting holes to a luminescent layer on a side proximate to the cathode and a luminescent layer having a plurality of luminescent regions by way of the charge generating layer.

In this way, by forming the luminescent layers of the organic electroluminescence element by a plurality of luminescent layers, a thickness of the luminescent layer is thickened in a state of being excellent in a luminescence efficiency and therefore, a possibility of shortcircuit in the luminescent layer becomes low and since luminescence is carried out by the plurality of luminescent layers and therefore, a luminescent light amount of the organic electroluminescence element can be increased. Further, since an efficiency of injecting holes to the luminescent layer and an efficiency of injecting electrons thereto are increased, the luminescent light amount in the luminescent layer is further increased, as a result, a bright exposing apparatus capable of further increasing the luminescent light amount of the organic electroluminescence element can be realized. Further, since the thickness of the luminescent layer is sufficiently thinner than that of the board of the organic electroluminescence element, a small-sized exposing apparatus can be realized. Thereby, there can be realized an exposing apparatus capable of providing a luminescent exposure light amount necessary for exposure without shortening the element life by increasing applied current and capable of achieving small-sized formation and thin-sized formation having a high degree of freedom of arrangement.

Further, in order to resolve the problem, there is provided an exposing apparatus comprising at least an organic electroluminescence element constituting a light source and a wave guide an end face in a sub scanning direction of which is made to constitute a light taking out face above a board wherein light irradiated from the organic electroluminescence element and incident on the wave guide and emitted from the light taking out face is used as exposure light and wherein the organic electroluminescence element includes at least a plurality of anodes constituting electrodes for injecting holes, a plurality of cathodes arranged alternately with the anodes and constituting electrodes for injecting electrons and a plurality of luminescent layers respectively formed between the anodes and the cathodes and having luminescent regions prescribed by the anodes and the cathodes.

In this way, by forming the luminescent layers of the organic electroluminescence element by the plurality of luminescent layers, a thickness of the luminescent layer is thickened in a state in which a luminescence efficiency is excellent and therefore, a possibility of shortcircuit in the luminescent layer becomes low and since luminescence is carried out by the plurality of luminescent layers, a luminescent light amount of the organic electroluminescence element can be increased. Further, since an efficiency of injecting holes to the luminescent layer and an efficiency of injecting electrons thereto are increased, the luminescent light amount at the luminescent layer is further increased, as a result, a bright exposing apparatus capable of further increasing the luminescent light amount of the organic electroluminescence element can be realized. Further, the thickness of the luminescent layer is sufficiently thinner than a thickness of the board of the organic electroluminescence element and therefore, a small-sized exposing apparatus can be realized. Thereby, there can be realized an exposing apparatus capable of providing a luminescent light amount necessary for exposure without shortening element life by increasing applied current and capable of achieving small-sized formation and thin-sized formation having a high degree of freedom of arrangement.

Further, in order to resolve the problem, there is provided an exposing apparatus comprising at least an organic electroluminescence element constituting a light source and a wave guide an end face in a sub scanning direction of which is made to constitute a light taking out face above a board wherein light irradiated from the organic electroluminescence element and incident on the wave guide and emitted from the light taking out face is used as exposure light and wherein the organic electroluminescence element includes at least an anode constituting an electrode for injecting holes, a cathode constituting an electrode for injecting electrons and a luminescent layer formed between the anode and the cathode and having a luminescent region and the luminescent layer is formed by a material capable of forming the luminescent layer at least by coating.

In this way, the luminescent layer of the organic electroluminescence element can be formed by coating and therefore, a thickness of the luminescent layer can easily be thickened and therefore, a possibility of shortcircuit in the luminescent layer becomes low. Further, since the thickness of the luminescent layer is sufficiently thinner than a thickness of the board of the organic electroluminescence element, a small-sized exposing apparatus can be realized. Thereby, a luminescent light amount necessary for exposure can be provided without shorting element life by increasing applied current and an exposing apparatus capable of achieving small-sized formation and thin-sized formation having a high degree of freedom of arrangement can be realized.

Further, in order to resolve the problem, there is provided an exposing apparatus comprising at least an organic electroluminescence element constituting a light source and a wave guide an end face in a sub scanning direction of which is made to constitute a light taking face wherein light irradiated from the organic electroluminescence element and incident on the wave guide and emitted from the guide taking out face is used as exposure light and wherein the organic electroluminescence element includes at least an anode constituting an electrode for injecting holes, a cathode constituting an electrode for injecting electrons and a luminescent layer formed between the anode and the cathode and having a luminescent region and a stepped difference formed by the board and the electrode formed above the board is made to be equal to or smaller than a thickness of the luminescent layer.

In this way, the thickness of the luminescent layer of the organic electroluminescence element is made to be thicker than the stepped difference formed by the electrode and therefore, a possibility of shortcircuit in the luminescent layer becomes low. Further, the thickness of the luminescent layer is sufficiently thinner than the thickness of the board of the organic electroluminescence element and therefore, a small-sized exposing apparatus can be realized. Thereby, there can be realized an exposing apparatus capable of providing the luminescent light amount necessary for exposure without shorting element life by increasing applied current and capable of achieving small-sized formation and thin-sized formation having a high degree of freedom of arrangement.

In order to resolve the problem, an image forming apparatus of the invention uses any of the exposing apparatus and a photosensitive member formed with an electrostatic latent image by the exposing apparatus.

### BRIEF DESCRIPTION OF THE PREFERRED EMBODIMENTS

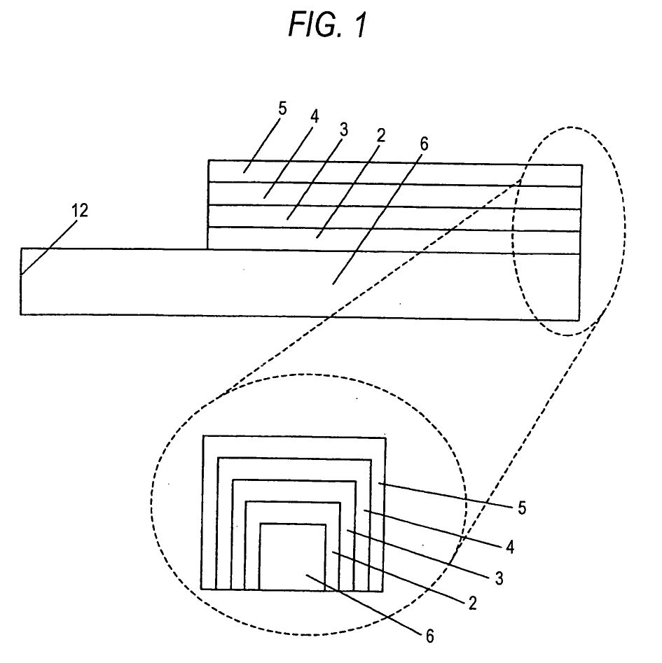

FIG. 1 is a schematic sectional view showing a light source using a waveguide according to an embodiment of the invention.

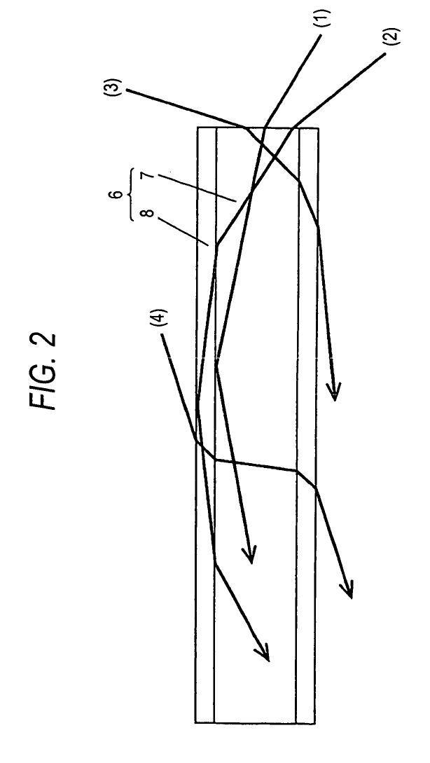

FIG. 2 is a schematic sectional view showing the waveguide according to the invention.

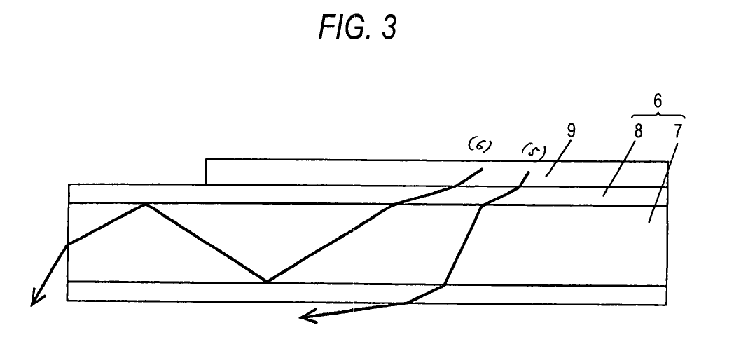

FIG. 3 is a schematic sectional view showing another waveguide according to the invention.

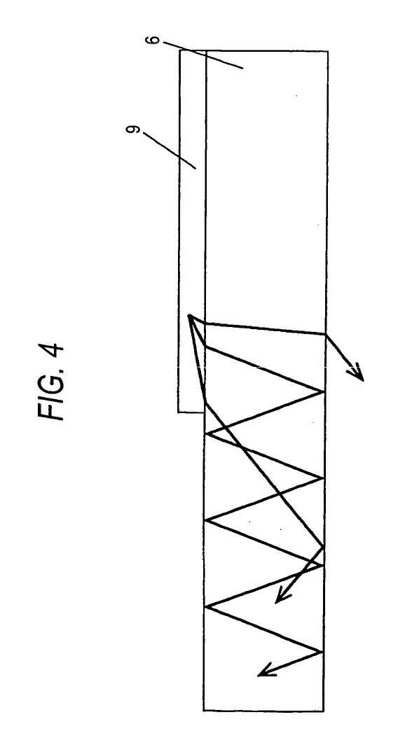

FIG. 4 is a schematic sectional view showing a waveguide having a high refractive index according to the invention.

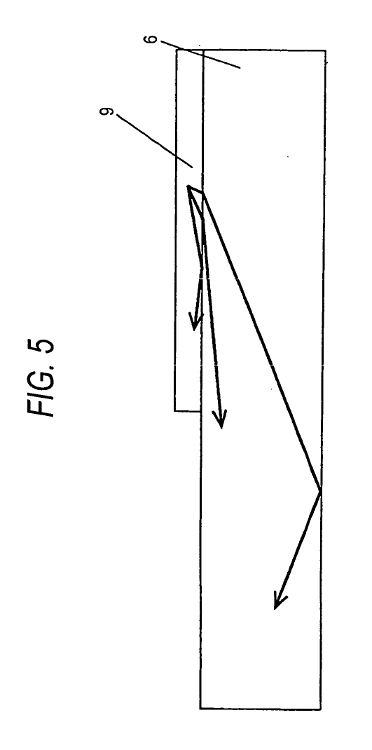

FIG. 5 is a schematic sectional view showing a waveguide having a low refractive index according to the invention.

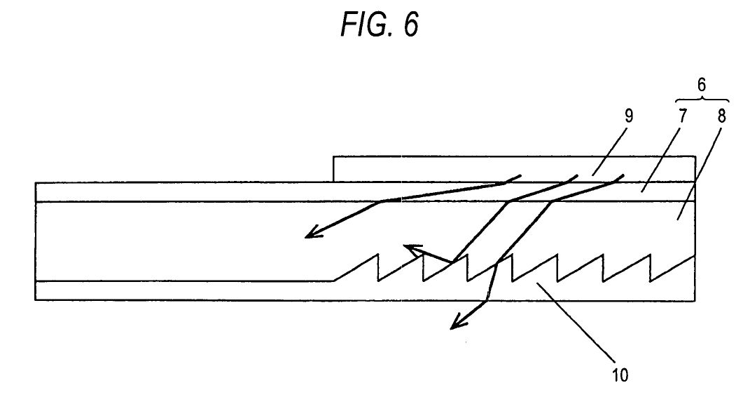

FIG. 6 is a schematic sectional view showing a waveguide having an angle converting structure according to the invention.

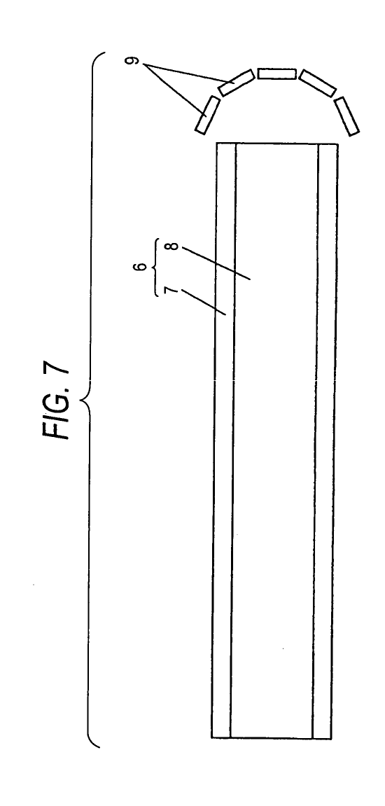

FIG. 7 is a schematic sectional view showing a light source using a waveguide according to another embodiment of the invention.

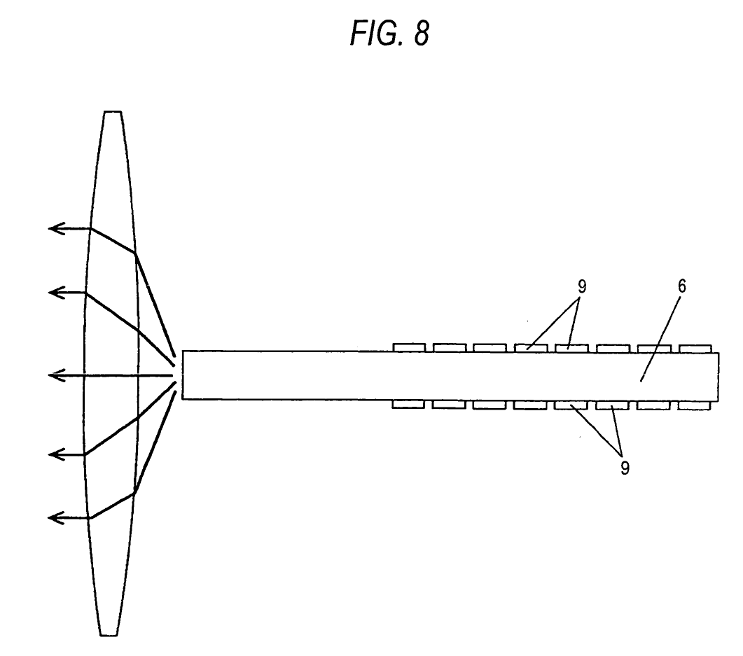

FIG. 8 is a schematic sectional view showing a light source using a waveguide according to a further embodiment of the invention.

FIG. 9 is a sectional view showing the main part of a conventional organic electroluminescence element.

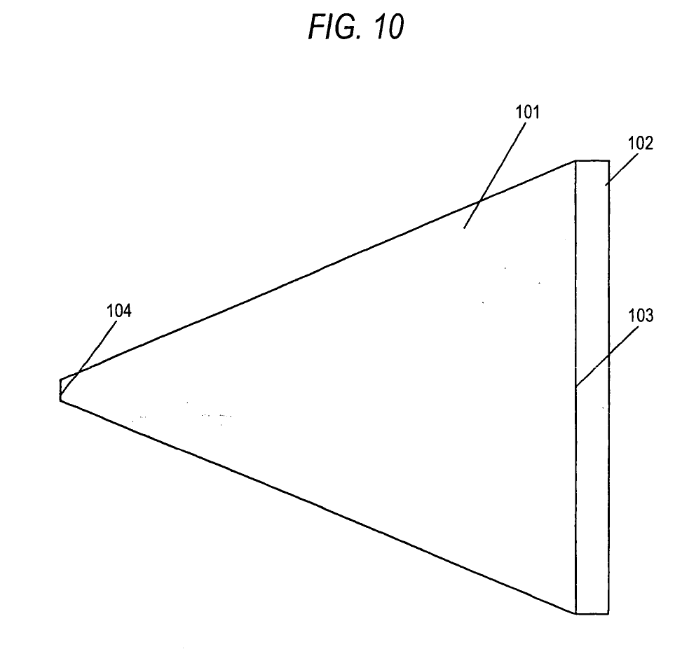

FIG. 10 is a schematic sectional view showing the structure of a waveguide light source according to an embodiment of the invention.

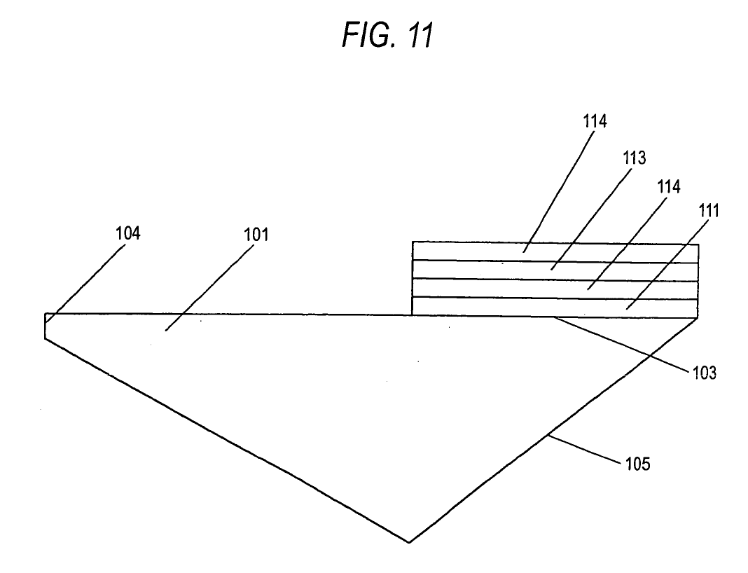

FIG. 11 is a schematic sectional view showing the structure of a waveguide light source according to an embodiment of the invention.

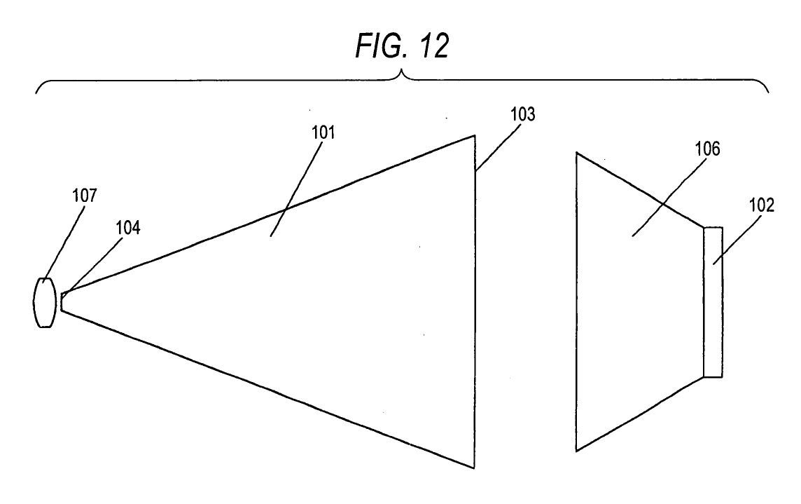

FIG. 12 is an explanatory view showing, in detail, the light emitting unit section of the waveguide light source in FIG. 10.

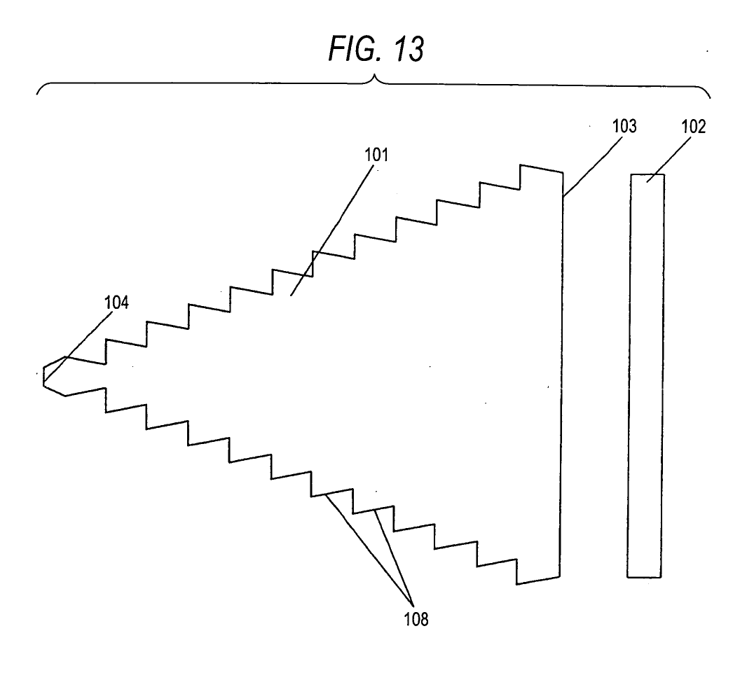

FIG. 13 is an explanatory view showing, in detail, the propagation interface of the waveguide light source in FIG. 10.

FIG. 14 is a schematic sectional view showing the structure of an exposing device using a waveguide light source according to an embodiment of the invention.

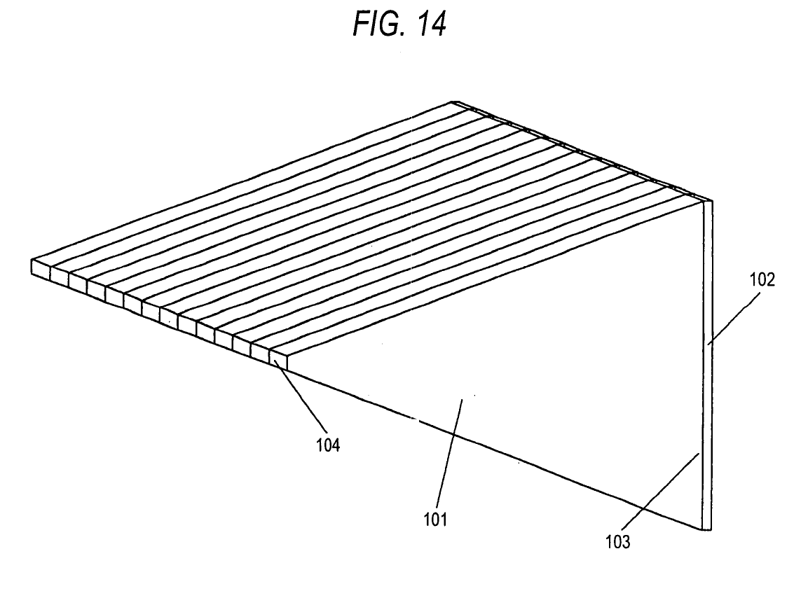

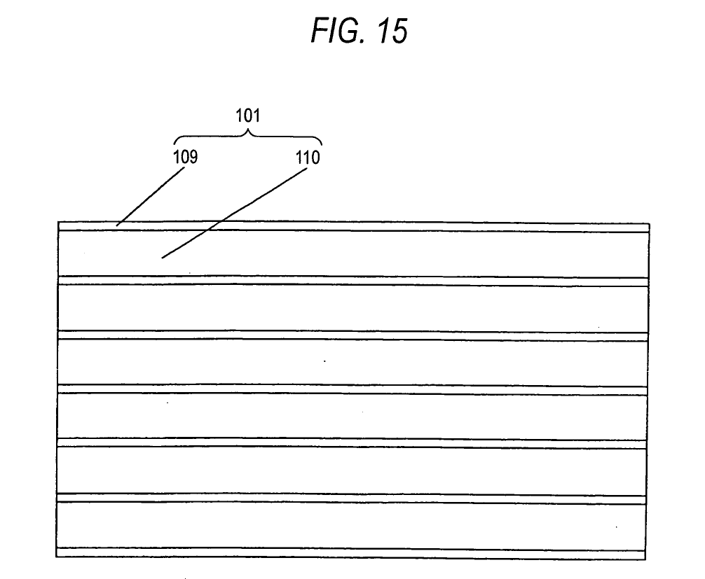

FIG. 15 is an explanatory plan view showing, in detail, the light shielding structure of an exposing device in FIG. 13.

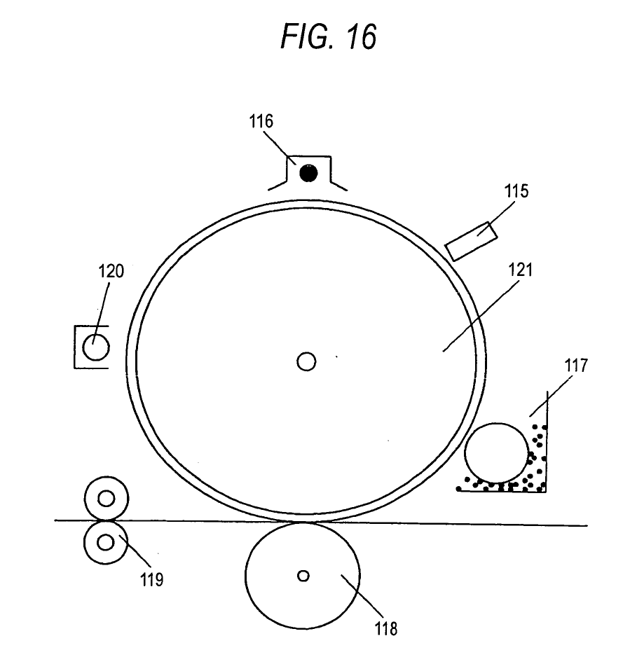

FIG. 16 is a schematic sectional view showing the structure of a printer in which the waveguide-light source in FIG. 11 is used as exposing means according to an embodiment of the invention.

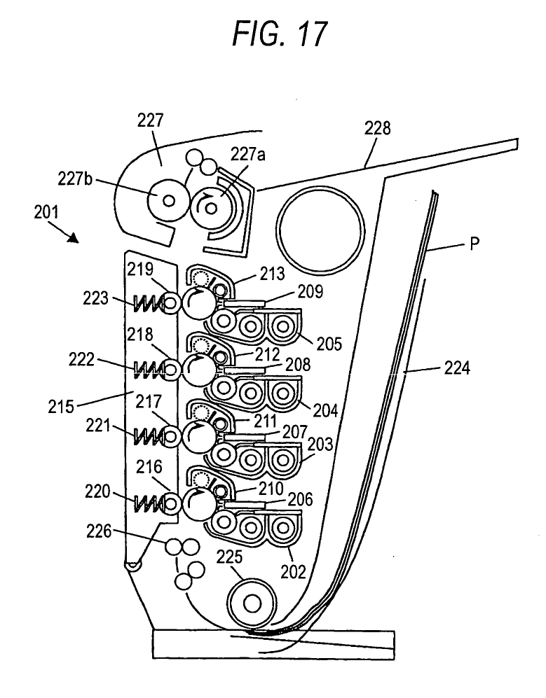

FIG. 17 is an outline view showing a constitution of a color image forming apparatus according to Embodiment of the invention.

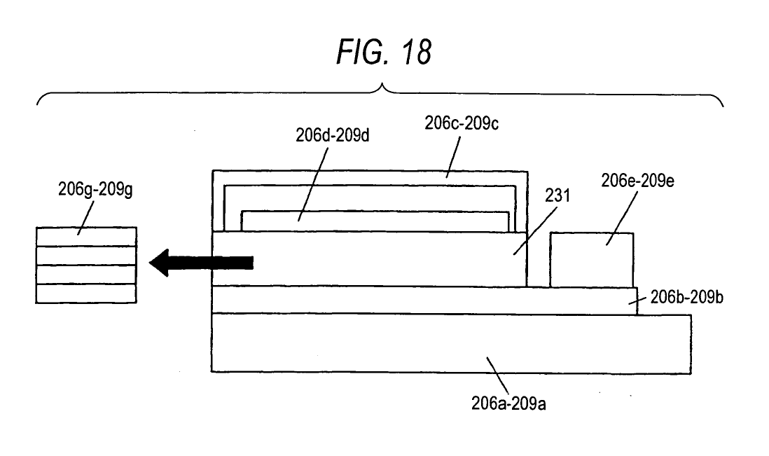

FIG. 18 is an explanatory view showing in details an exposing portion of the color image forming apparatus of FIG. 17.

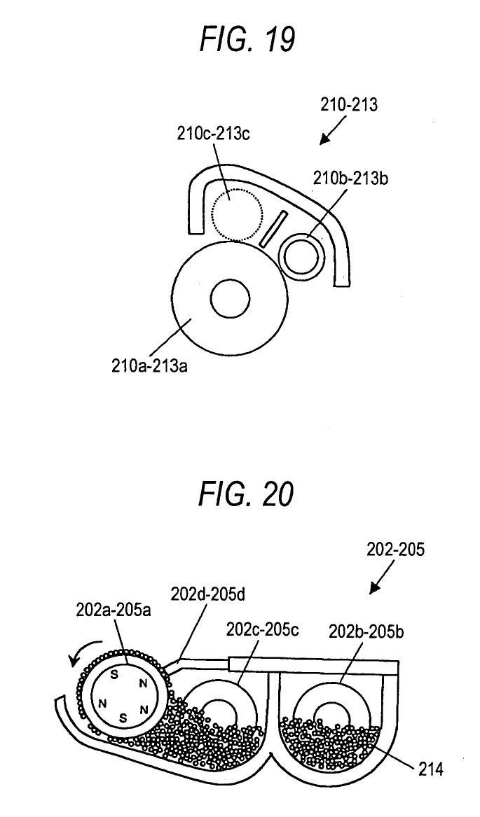

FIG. 19 is an explanatory view showing in details a photosensitive portion of the color image forming apparatus of FIG. 17.

FIG. 20 is an explanatory view showing in details a developing portion of the color image forming apparatus of FIG. 17.

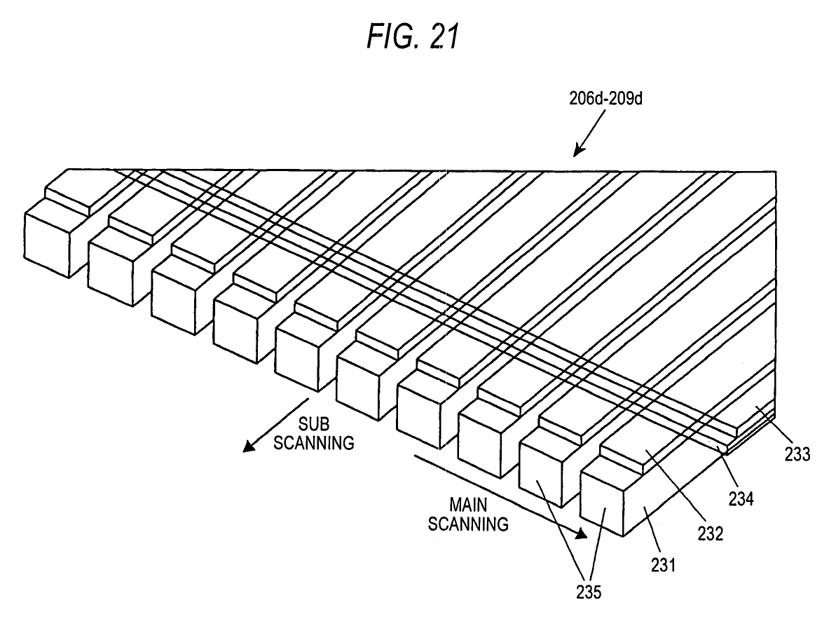

FIG. 21 is a perspective view showing an essential portion of an organic electroluminescence element used as a light source of the exposing portion of FIG. 18.

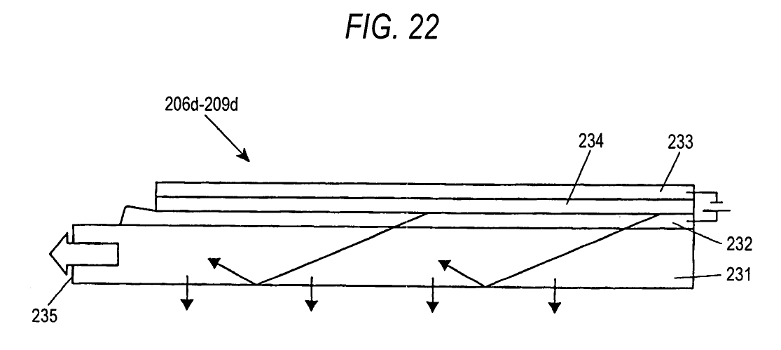

FIG. 22 is a sectional view showing the organic electroluminescence element used as the light source of the exposing portion of FIG. 18.

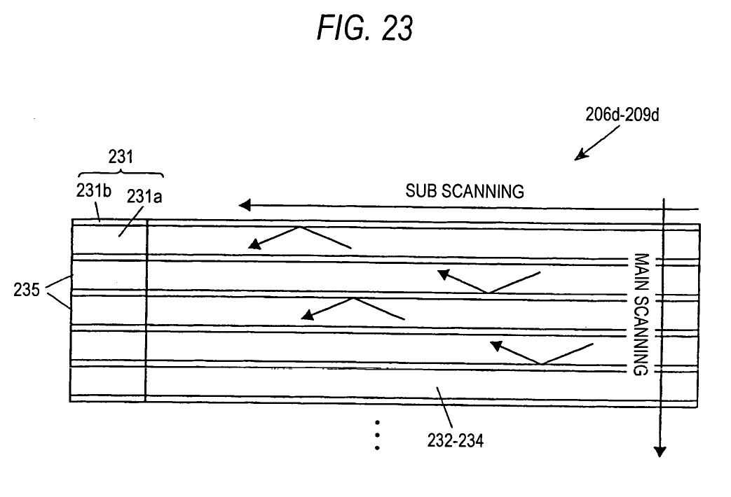

FIG. 23 is a plane view showing the organic electroluminescence element used as the light source of the exposing portion of FIG. 18.

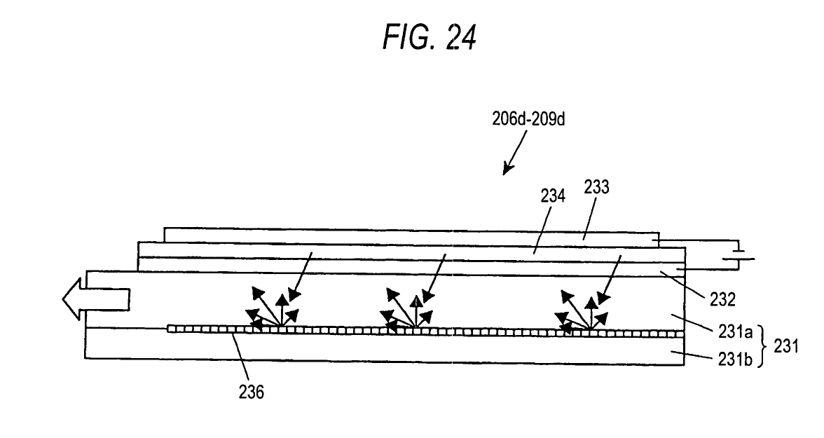

FIG. 24 is a sectional view showing an organic electroluminescence element as a modified example used as a light source of the exposing portion of FIG. 18.

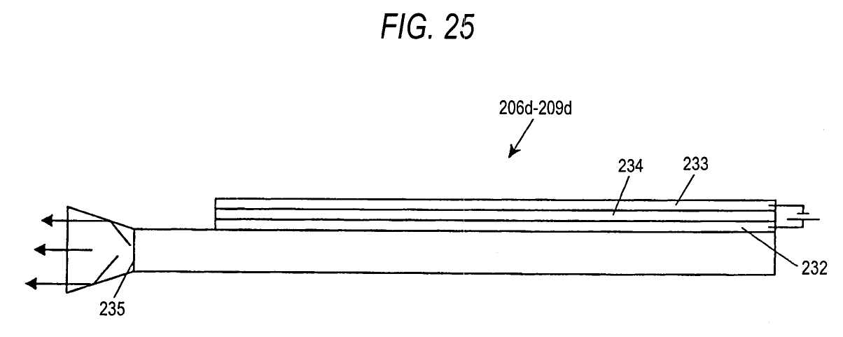

FIG. 25 is a sectional view showing an organic electroluminescence element as other modified example used as a light source of the exposing portion of the FIG. 18.

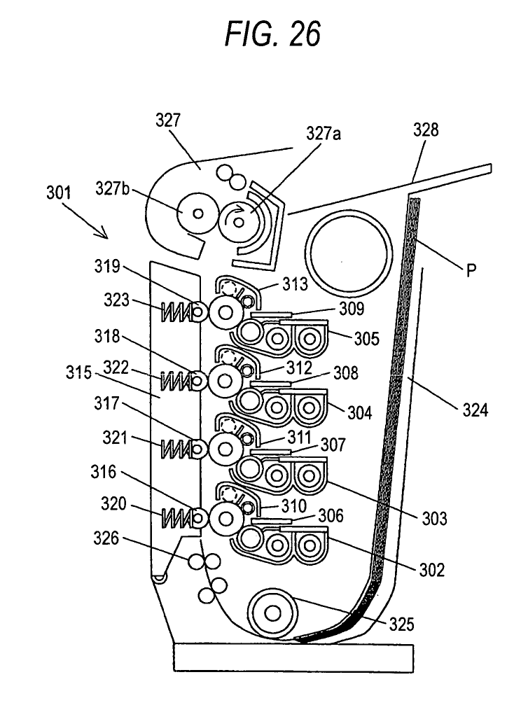

FIG. 26 is an outline view showing a constitution of a color image forming apparatus according to Embodiment of the invention.

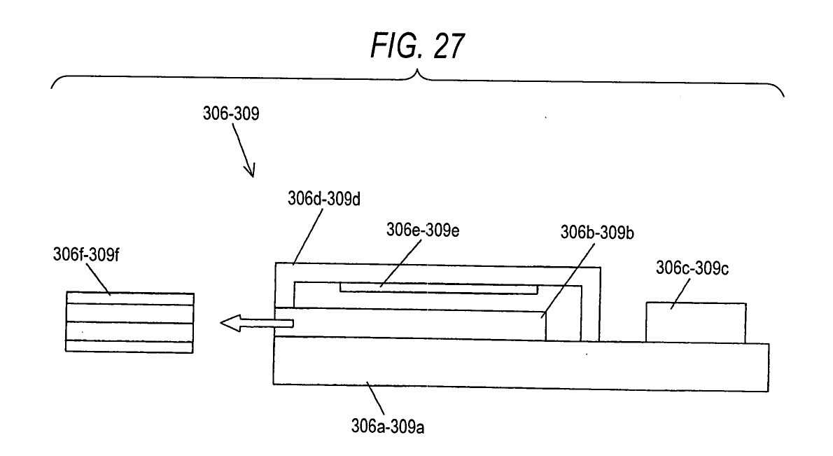

FIG. 27 is an explanatory view showing in details an exposing portion in the color image forming apparatus of FIG. 26.

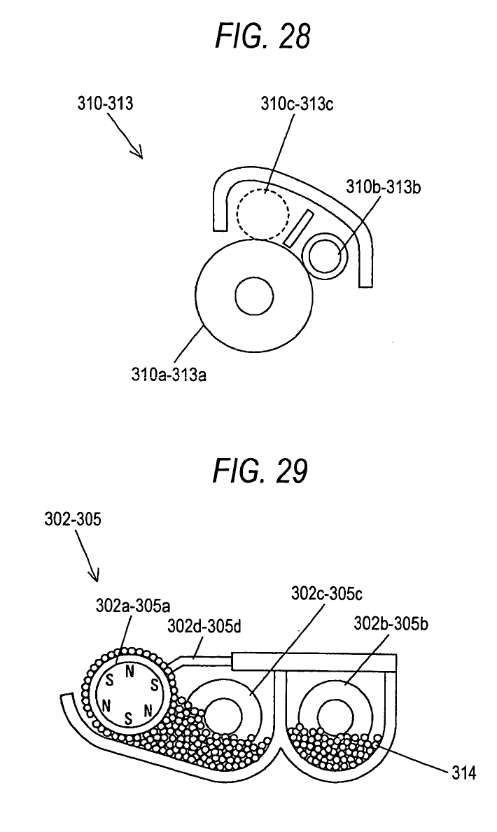

FIG. 28 is an explanatory view showing in details a photosensitive portion in the color image forming apparatus of FIG. 26.

FIG. 29 is an explanatory view showing in details a developing portion in the color image forming apparatus of FIG. 26.

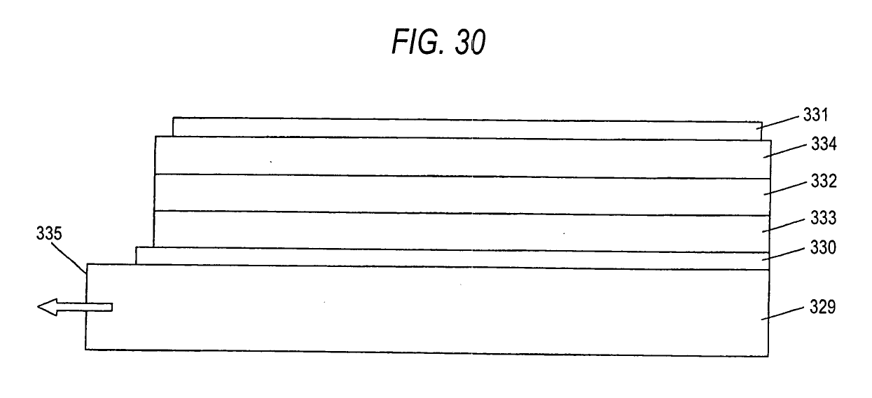

FIG. 30 is a sectional view showing an organic electroluminescence element used as a light source of the exposing portion of FIG. 27.

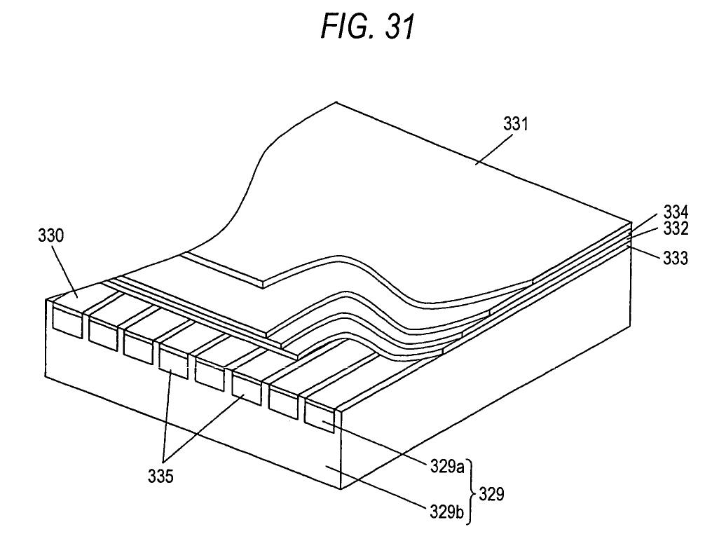

FIG. 31 is a perspective view showing an essential portion of the organic electroluminescence element used as the light source of the exposing portion of FIG. 27.

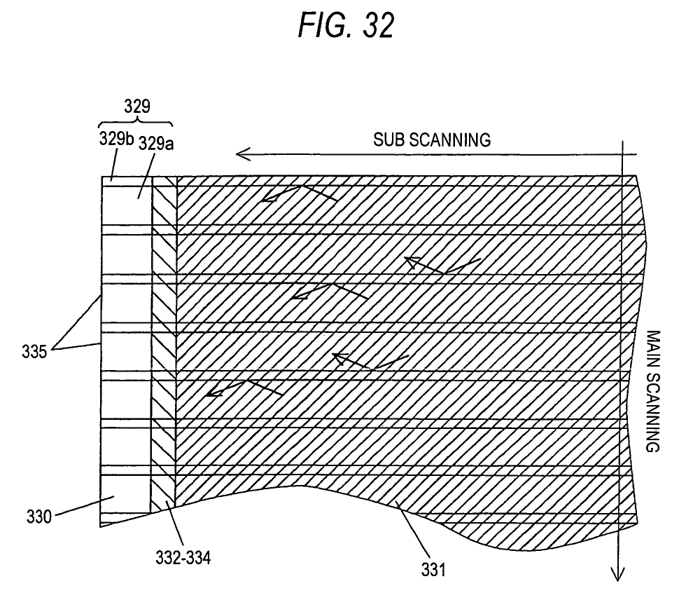

FIG. 32 is a plane view showing the organic electroluminescence element used as the light source of the exposing portion of FIG. 27.

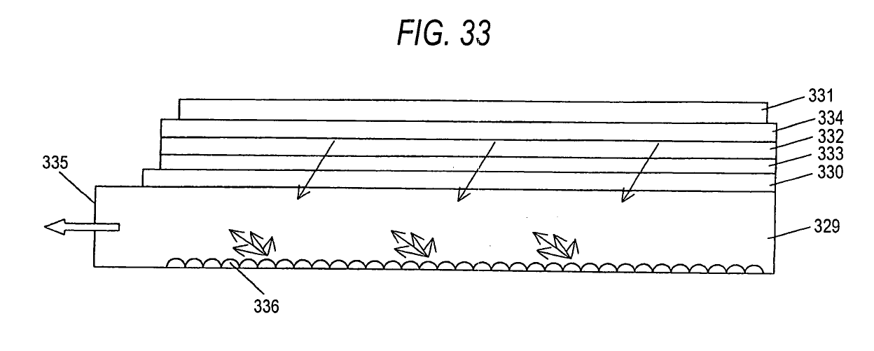

FIG. 33 is a sectional view showing an organic electroluminescence element as a modified example used as the light source of the exposing portion of FIG. 27.

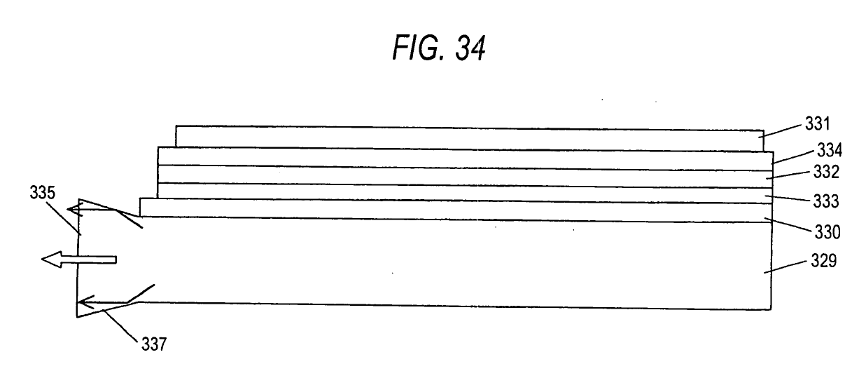

FIG. 34 is a sectional view showing an organic electroluminescence element as other modified example used as the light source of the exposing portion of FIG. 27.

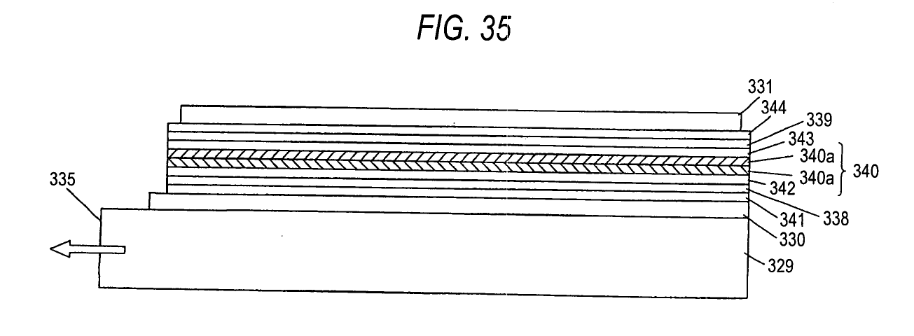

FIG. 35 is a sectional view showing an organic electroluminescence element used as a light source of the exposing portion of the color image forming apparatus according to Embodiment of the invention.

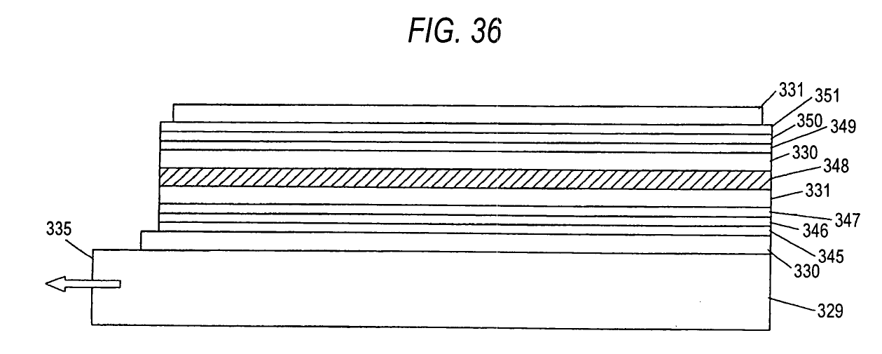

FIG. 36 is a sectional view showing an organic electroluminescence element used as a light source of the exposing portion of the color image forming apparatus according to Embodiment of the invention.

### DETAILED DESCRIPTION OF THE PREFERRED EMBODIMENTS

### First Mode of Embodiments

The wave guiding configuration of a light according to the invention will be described below in detail.

First of all, the characteristics of a waveguide will be described with reference to FIG. 2.

FIG. 2 is a schematic sectional view showing a waveguide according to the invention.

The waveguide is a path for a light which is formed by at least two media having different refractive indices, and is a structure including a core 7 formed by a layer having a high refractive index in an inner part and a clad 8 formed by a layer having a small refractive index in an outer part. Moreover, an air layer can be used in place of the clad 8 in the outer part, and a structure having only the core 7 can also be employed.

In the case in which a light is to be propagated in the waveguide, generally, the light is incident from an end face placed in an opposed position to a light take-out surface in the direction of the light take-out surface. The light incident into the waveguide is subjected to actions such as a refraction and a reflection over an interface formed by the media having the different refractive indices. In some cases, a reflection having a low loss which is referred to as a total reflection is particularly caused on an interface between the core 7 and the clad 8, an interface between the clad 8 and air and an interface with a change from the medium having a high refractive index to the medium having a low refractive index. A light having a greater incidence angle on the interface than a critical angle is totally reflected on the interface. In general, a light reflected totally in the waveguide is also reflected totally on an opposed interface and is propagated in the direction of the light take-out surface while repeating the total reflection. Accordingly, a light incident from the end face of the waveguide includes three lights, that is, a light which is totally reflected on the interface between the core and the clad as shown in (1), a light which is totally reflected on the interface between the clad and the air as shown in (2) and a light which is not totally reflected but transmitted through the waveguide as shown in (3). On the interface where the total reflection is caused, any light is not transmitted but all the lights are reflected. In the case in which the waveguide is used, therefore, it is possible to implement an efficient light propagation having a very small propagation loss. Moreover, the waveguide can be formed freely if a light propagating portion has such a small size as to disregard the wavelength of the light. Consequently, it is possible to easily implement a very small waveguide.

In the case in which the light is incident from the side surface of the waveguide, moreover, the incident light is not totally reflected but most of the incident light is transmitted through the waveguide also on an interface with a change from the medium having a high refractive index to the medium having a low refractive index as shown in (4). The reason is that a direct ray is not incident on the medium having a high refractive index differently from the case of the incidence from the end face. Description will be briefly given based on the Snell's law for the refraction and reflection of a light. In the case in which a light is propagated from the medium having a low refractive index to the medium having a high refractive index, it is refracted to have a great angle with respect to the interface and is propagated in the medium having a high refractive index. For this reason, a light having an angle which is equal to or greater than a critical angle is not present on an interface for the propagation from a layer having a high refractive index to a layer having a low refractive index, and any of the lights is not totally reflected but transmitted in the waveguide. In the case in which the light is incident from the side surface of the waveguide into the waveguide, accordingly, it is necessary to take measures, for example, to use, in the waveguide, a structure for converting the angle of the light.

Similarly, a light is propagated in accordance with the Snell's law also in a light emitting unit of a so-called internal light emission type such as an inorganic LED, a laser diode or an electroluminescence element, and a light irradiated from the light emitting section is influenced by a reflection and a refraction, and particularly, a total reflection is caused on an interface with an air layer. Accordingly, a light emitting unit including a light emitting layer having a high refractive index is greatly influenced by the total reflection on the interface between the unit and the air, and furthermore, the light reflected totally is influenced by the absorption of the light in the light emitting unit. In the light emitting unit of the internal light emission type, therefore, only a part of the light irradiated from the light emitting layer is taken into the air.

In the case in which the light is incident from the side surface of the waveguide, most of the incident light is transmitted through the waveguide as described above. In the case in which the light emitting unit of the internal light emission type is formed without air on the waveguide, however, a situation is different from that in the case described above. With reference to FIG. 3, description will be given to the case in which the light emitting unit is formed on the waveguide. In the case in which a light irradiated from a light emitting layer having a high refractive index is incident from the side surface of the waveguide without a medium having a low refractive index such as the air, there are present a light irradiated from the side surface of the waveguide as shown in (5), and furthermore, a light having an angle which is equal to or greater than a critical angle that is totally reflected on an interface with a change from a medium having a high refractive index to a medium having a low refractive index in the waveguide as shown in (6). Thus, a light is propagated to the light take-out surface by the total reflection.

By providing the light emitting unit of the internal light emission type on the waveguide without the air, accordingly, it is possible to form a structure in which a light is incident from a side surface and is propagated to a light take-out surface by a total reflection. Consequently, it is possible to easily implement a very small point light source including a light emitting unit having a large area.

In case of a structure in which a light is emitted through the waveguide, moreover, it is not necessary to cause the area of the light take-out surface to be equal to that of the light emitting unit. Therefore, a light emitting unit having a large area or a plurality of light emitting units is arranged to cause a light to be incident into the waveguide. Consequently, it is possible to easily implement a very small point light source in which the area of the light emitting unit is larger than that of the light take-out surface. In particular, the area of the light emitting unit can be increased. Therefore, it is possible to implement a point light source having a very great brightness In case of a structure in which the light emitting unit is formed on the side surface of the waveguide, it is possible to easily increase the area of the light emitting unit by sufficiently increasing a length in the direction of a propagation in the waveguide. Thus, it is possible to easily implement a point light source having a great brightness. It is apparent that a point light source having a greater brightness can be implemented with a larger area of a light emission for the light take-out surface. In the case in which a waveguide having an equal length is used, therefore, it is possible to implement a point light source having a greater brightness by providing the light emitting unit on at least two surfaces in place of only one surface.

In order to efficiently propagate a light to the light take-out surface, moreover, it is preferable that the refractive index of the waveguide should be set to be lower than that of the light emitting layer, and furthermore, should be higher than a refractive index which is lower than the refractive index of the waveguide by 0.3. As described above, the light irradiated from the light emitting layer is propagated on each interface in accordance with the Snell's law. In this case, if the refractive index of the waveguide is higher than that of the light emitting layer as shown in FIG. 4, more lights have great angles in the waveguide and an optical path length is increased before arrival at the light take-out surface. Such lights are greatly influenced by the absorption of the light in the waveguide. For this reason, an efficient light propagation cannot be carried out. In the case in which the refractive index of the waveguide is almost equal to or lower than that of the light emitting layer as shown in FIG. 5, moreover, a large number of lights are propagated in the direction of a light emitting surface in the waveguide. Consequently, the light can be propagated efficiently. In the case in which the refractive index of the waveguide is lower than that of the light emitting layer, however, the total reflection of the light is caused on the interface with the waveguide according to a difference in the refractive index between the waveguide and the light emitting layer. For this reason, in the case in which the refractive index of the light emitting layer is lower than that of the waveguide by 0.3 or more, particularly, a reduction in the amount of a light caused by the total reflection cannot be disregarded so that an efficient light propagation cannot be carried out. By forming the waveguide using the same material as the material of the light emitting layer, accordingly, it is possible to easily form the waveguide for propagating an efficient light without strictly selecting the refractive index of the waveguide.

In order to obtain the efficient light propagation, moreover, it is preferable to have an angle converting structure for converting the angle of a light in the waveguide in place of the waveguide having a simple shape. For example, as shown in FIG. 6, in the case in which such a saw-toothed angle converting structure as to convert the angle of a light in the direction of a light take-out surface is provided, the angle of a light having such an angle as to be transmitted in the waveguide taking a simple shape and not to be propagated in the waveguide is converted in the same waveguide. Consequently, the light can be utilized as an effective light emitted from the light take-out surface. In the simple waveguide, moreover, the light propagated in the waveguide without the conversion of the angle of the light rarely reaches the interface between the waveguide and the air. Therefore, the angle of the light is not converted but the light is propagated in the waveguide. As described above, the light angle converting structure is provided in the waveguide so that the light transmitted through the waveguide can be propagated in the simple waveguide. Consequently, it is possible to implement an efficient light propagation.

In the case in which the waveguide includes a core having a high refractive index and a clad having a lower refractive index than that of the core, moreover, it is preferable that the light angle converting structure should be provided on an interface between the core and the clad. In the case in which an effective light angle conversion is carried out on the interface between the core and the clad, a light subjected to the angle conversion is propagated in the core and is then irradiated from a light take-out surface. On the other hand, in the case in which the angle converting structure is provided on an interface between the clad and air, the light subjected to the effective light angle conversion is propagated through both the core and the clad and is then irradiated from the light take-out surface. For this reason, it is possible to shorten an optical path length in the propagation through the waveguide by providing the light angle converting structure on the interface between the core and the clad. Thus, it is possible to implement an efficient light propagation over the surface of the clad.

In the case in which the light emitting unit is not formed on an opposed surface to the light take-out surface but the side surface of the waveguide, a part of a light incident from the light emitting unit into the waveguide is propagated to the opposed surface to the light take-out surface and is emitted as an ineffective light from the opposed surface into the air. For this reason, the light take-out surface is set to be a reflecting plane in the waveguide having a high symmetry so that the ineffective light is utilized as an effective light. Consequently, an efficient light propagation can be implemented. Moreover, the opposed surface to the light take-out surface is not set to be a simple reflecting plane but a surface which is not perpendicular to the waveguide. Consequently, it is possible to form a reflecting plane having a light loss reduced and utilizing a total reflection, and to implement an efficient light propagation. By designing the angle of the light take-out surface, particularly, it is also possible to use the same surface as the light angle converting structure. Furthermore, it is possible to easily implement the efficient light propagation.

Next, the waveguide will be described.

The waveguide is constituted by a transparent core and a clad having a lower refractive index than that of the core around the core. An air layer can be used in place of the clad and the waveguide can also be constituted by only the core.

The waveguide of each of the organic electroluminescence elements of the invention is constituted by a transparent core and a clad having a refractive index smaller than that of the core at the surrounding of the core and the clad can be substituted for by an air layer and can also be constituted to comprise only the core. Further, according to the invention, the definition of transparent or semitransparent indicates transparency to a degree of not hampering optical recognition of luminescence by the organic electroluminescence element.

As a material used for the wave guide, there can be pertinently selected to use inorganic oxide glass of transparent or semitransparent soda-lime glass, barium/strontium including glass, lead glass, aluminosilicate glass, borosilicate glass, barium borosilicate glass, quartz glass or the like, inorganic glass of inorganic fluoride glass or the like, or, a polymer film of transparent or semitransparent polyethylene terephthalate, polycarbonate, polymethyl methacrylate, polyethersulfone, polyfluoride vinyl, polypropylene, polyethylene, polyacrylate, noncrystalline olefin, fluororesin or the like, or calcogenide glass of transparent or semitransparent As₂S₃, As₄₀S₁₀, S₄₀Ge₁₀ or the like, materials of metal oxides and metal nitrides of ZnO, Nb2O5, Ta₂O₅, SiO, Si₃N₄, HfO₂, TiO₂ or the like, or the above-described transparent board material including pigment or the like, and a laminated layer board laminated with a plurality of board materials can also be used, or a resist can be bleached to use. Further, in order to make values of the refractive index of the waveguide and the refractive index of the luminescent layer proximate to each other, the waveguide can also be formed by using a material the same as the material of the luminescent layer.

A structure of converting an angle of light is a structure in which at an interface between two different media, when incident light reaches the interface, light is reflected by an angle different from an angle of incidence to the interface and is a face and a structural body which are not in parallel with any of respective faces forming the board.

Specifically, there is pointed out a face which is not in parallel with the interface and not orthogonal thereto, which is a structural body comprising, for example, a triangular cylinder, a circular cylinder, a triangular cone, a circular cone, or a composite body, a scattering face or the like three-dimensionally or two-dimensionally aligned therewith and comprising bending of a wave guide, recesses and projections of a surface of a wave guide, a structure of a small lens, a small prism, a small mirror and an aggregate thereof.

Further, the structure of converting an angle of light can be formed at either of surface of the wave guide and inside of the wave guide.

When the structure of converting the angle of light is formed on the surface of the wave guide, recesses and projections can be formed by polishing the surface of the wave guide and the structure can be realized by forming a clad or a luminescent element on the recesses and projections. Or, the structure can be realized also by bonding a small lens or the like on the surface of the wave guide and when the structure of converting the angle of light is formed on the surface of the wave guide, the interface may be an interface between air and the board and in this case, air is used as the clad layer. When the structure of converting the angle of light is formed on the surface of the waveguide in this way, the surface may be worked after forming the organic electroluminescence element and can easily be formed since forming steps are simple.

Further, when the structure of converting the angle of light is formed at inside of the waveguide, the structure of converting the angle of light can be formed by incorporating recesses and projections or a small lens in the waveguide and the structure can be formed at inside of the core or the clad or the interface between the core and the clad. When the structure is formed at the interface between the core and the clad, the structure can be realized by forming recesses and projections by polishing, blasting, etching or the like the surface of the core and forming the clad layer on the surface. In the case of such a structure, the structure of converting the angle of light is not exposed, stable conversion of the angle of light is carried out, the surface of the wave guide can be flattened and therefore, the anode or the like can easily be formed on the waveguide.

An organic electroluminescence element according to the invention will be described below in detail.

First of all, a substrate will be described. For the substrate of the organic electroluminescence element according to the invention, a transparent or opaque substrate can be used. In the case in which a light is to be taken out of the substrate side, the transparent substrate can be used. In other cases, any of the substrates can be properly selected and used. It is preferable that the substrate should have such a strength as to hold the organic electroluminescence element. The substrate of the organic electroluminescence element can also be shared as a support member for a driver IC.

The substrate can be properly selected for use from a material utilized in a waveguide such as a transparent or opaque soda lime glass, a semiconductor material such as opaque silicon, germanium, silicon carbide, gallium arsenide or gallium nitride, the transparent substrate material containing a pigment, and a metal material having a surface subjected to an insulation processing, and it is also possible to use a laminated substrate having a plurality of substrate materials laminated. Moreover, a circuit comprising a resistor, a conductor, an inductor, a diode and a transistor for driving the organic electroluminescence element may be formed on the surface of the substrate or in the inner part of the substrate.

An anode is an electrode for injecting a hole, and the hole is to be efficiently injected into a light emitting layer or a hole transporting layer.

As the anode of each of the organic electroluminescence elements, there can be used a transparent conductive film comprising a metal oxide of indium tin oxide (ITO), tin oxide (SNO₂), zinc oxide (ZnO) or the like, or a mixture of SnO:Sb (antimony), ZnO:Al (aluminum), IZO (In₂O₃:AnO), or a metal thin film of Al (aluminum), Cu (copper), Ti (titanium), Ag (silver), Au (gold) having a thickness to a degree of not deteriorating transparency, a metal thin film of a thin film of a mixture of the metals, a thin film laminated with the metals, or a conductive polymer of polypryrole or the like. Further, a transparent electrode can be constituted by laminating a plurality of the above-described transparent electrode materials and is formed by various polymerization methods of resistance heating vapor deposition, electron beam vapor deposition, sputtering method, electrolytic polymerization method and the like. Further, it is preferable to constitute the thickness of the transparent electrode equal to or larger than 1 nm in order to provide sufficient conductivity or to prevent nonuniform luminescence by recesses and projections of the surface of the board. Further, it is preferable to constitute the thickness equal to or smaller than 500 nm to provide sufficient transparency.

Further, as an anode, other than the transparent electrodes, there can be used a metal having large work function of Cr (chromium), Ni (nickel), Cu (copper), Sn (tin), W (tungsten), Au (gold) or the like, or an alloy or an oxide or the like of these and a laminated structure of a plurality of materials using the anode materials can also be used. However, when a transparent electrode is not used as the anode, in order to maximally utilize the effect of the angle converting means of light, it is preferable to form the anode by a material reflecting light. Further, when a transparent electrode is not used as an anode, the cathode may be constituted by a transparent electrode.

Moreover, an amorphous carbon film may be provided on the anode. In this case, both of them have the function of a hole injecting electrode. More specifically, a hole is injected from the anode to a light emitting layer or a hole transporting layer through the amorphous carbon film. Furthermore, the amorphous carbon film is formed between the anode and the light emitting layer or hole transporting layer by a sputtering method. A carbon target for the sputtering includes isotropic graphite, anisotropic graphite and glassy carbon, and is not particularly restricted but the isotropic graphite having a high purity is suitable. More specifically, the amorphous carbon film is excellent as follows. By a measurement carried out using a surface analyzer AC-1 manufactured by Riken Keiki Co., Ltd., the amorphous carbon film has a work function of W_{C}=5.40 eV. ITO to be often used generally as the anode has a work function of W_{ITO}=5.05 eV. By using the amorphous carbon film, the hole can be injected into the light emitting layer or the hole transporting layer more efficiently. When forming the amorphous carbon film by the sputtering method, moreover, reactive sputtering is carried out in a mixed gas atmosphere of nitrogen or hydrogen and argon in order to control the electric resistance value of the amorphous carbon film. In a thin film forming technique using the sputtering method, furthermore, a film is caused to have an island-shaped structure so that a homogeneous film cannot be obtained if a film thickness is set to be 5 nm or less. For this reason, an efficient light emission cannot be obtained with the amorphous carbon film having a thickness of 5 nm or less, and the effect of the amorphous carbon film cannot be expected. If the thickness of the amorphous carbon film is set to be 200 nm or more, moreover, the color of the film becomes dark so that the emitted light of the organic electroluminescence element cannot be transmitted sufficiently.

The luminescent layer of each of the organic electroluminescence elements is preferably provided with a fluorescent or phosphorescent characteristic in a visible region and is provided with excellent film forming performance and there can be used, other than Alq₃ or Be-benzoquinolinol (BeBq₂), benzoxazolol species of 2,5-bis(5,7-di-t-pentyl-2-benzoxazolil)-1,3,4-thiaziazol, 4,4′bis(5,7-pentyl-2-benzoxazolil)stilbene, 4,4′-bis[5,7-di-(2-methyl-2-butyl)-2-benzoxazolil]stilbene, 2,5-bis(5,7-di-t-pentyl-2-benzosazolil)thiophene, 2,5-bis([5-α,α-dimethylbenzyl]-2-benzoxazolil)thiophene, 2,5-bis[5,7-di-(2-mehyl-2-butyl)-2-benzoxazolil]-3,4-diphenyltiophene, 2,5-bis(5-methyl-2-benzoxazoil)thiophene, 4,4′-bis(2-benzoxazolil)biphenyl, 5-methyl-2-[2-[3-(5-methyl-2-benzosazolil)phenyl]vinyl]benzoxazolil, 2-[2-(4-chlorophenyl)vinyl]naphth[1,2-d]oxazolil or the like, benzothiazole species of 2,2′-(p-phenylenedivininylene)-bisbenzothiazole or the like, fluorescent white enhancing agent of benzimidazole species of 2-[2-[4-(2-benzimidazole)phynyl]vinyl]benzoimidazol, 2-[2-(4-caroxyphenyl)vinyl]benzoimidazole or the like, 8-hydroxyquinolin species metal complex of tris(8-quinolinol)aluminum, bis(8-quinolinol)magnesium, bis(benzo[f]-8-quinolinol)zinc, bis(2-methyl-8-quinolinolate)alminium oxide, tris(8-quinolinol)indium, tris(5-methyl-8-quinolinol)aluminium, 8-quinolinol lithium, tris(5-chloro-8-quinolinol)gallium, bis(5-chloro-8-quinolinol)calcium, poly[zinc-bis(8-nydroxy-5-quinolinolyl)methane] or the like or metal chelate oxynoid compound of dilithiumepindrizion or the like, styryl benzene species compound of 1,4-bis(2-methylstyryl benzene, 1,4(3-methylstyryl)benzene, 1,4-bis(4-methylstyryl)benzene, distyryl benzene, 1-4-bis(2-ethylstyryl)benzene, 1,4-bis(3-ethylstyryl)benzene, 1,4-bis(2-methylstyryl)2-methylbenzene or the like, diststilpyrazine derivative of 2,5-bis(4-methylstyryl)pyrazine, 2,5-bis(4-ethylstyryl)pyrazine, 2,5-bis[2-(1-naphthyl)vinyl]pyrazine, 2,5-bis(4-methoxystyryl)pyrazine, 2,5-bis[2-(4-biphenyl)vinyl]pyrazine, 2,5-bis[2-(1-pyrenyl)vinyl]pyrazine or the like, naphthalimide derivative, perylene derivative, oxadianol derivative, aldazine derivative, cyclopenthadiene derivative, stylylamine derivative, coumarin derivative, aromatic dimethylidine derivative or the like. Further, anthracene, salicylate, pyrene, chronene or the like is also used. Or, a phosphorescence material of fac-tris(2-phenylpyridine)iridium or the like or a polymer luminescence material of PPV (polyparaphenylenevinylene), polyfluorene or the like may be used.

Further, other than a single layer structure of only a luminescent layer, there may be used any structure of two-layer structure of a hole transporting layer and a luminescent layer or a luminescent layer and an electron transporting layer and a three layer structure of a hole transporting layer, a luminescent layer and an electron transporting layer. However, in the case of the two-layer structure or the three layer structure, the hole transporting layer and the anode or the electrode transporting layer and the cathode are formed to laminate to be brought into contact with each other. Or, there may be constructed a structure of plural layers constituting laminated layers or mixed layers by pertinently selecting layers functions of which are separated such as a structure of providing an electron blocking layer between the hole transporting layer and the luminescent layer, a structure of providing a hole blocking layer between the luminescent layer and the electron transporting layer, or a structure providing a hole injecting layer between the anode and the hole transporting layer or a structure of providing an electron injecting layer between the electron injecting layer and the cathode.

The hole transporting layer which is provided with high hole mobility, transparent and having excellent film forming performance is preferable. Other than TPD, there are used organic materials of polyfiline compounds of porfin, tetraphenyl porfin copper, phthalocyanine, copper phthalocyanine, titanium phthalocyanine oxide and the like, aromatic third class amines of 1,1-bis {4-(di-P-tolylamino)phenyl} cyclohexane, 4,4′,4″-trimethyl triphenyl amine, N,N,N′,N′-tetrakis(P-tolyl)-P-phenylenediamine, 1-(N,N-di-P-torylamino)naphthalene, 4,4′-bis(dimethylamino)-2-2′-dimethyltriphenylmethane, N,N,N′,N′-tetraphenyl-4,4′-diaminobiphenyl, N,N,-diphenyl-N,N′-di-m-tolyl-4, N,N-diphenyl-N,N′-bis(3-methylphenyl)-1,1′-4,4′-diamine, 4′-diaminobiphenyl, N-phenylcarbazole and the like, stilbene compound of 4-di-P-tolylaminostilbene, 4-(di-P-tolylamino)-4′-[4-(di-P-torylamino)styryl]stilbene and the like, triazole derivative, oxaziazole derivative, imidazole derivative, polyallylalkane derivative, pyrazoline derivative, pyrazolone derivative, phenylenediamine derivative, anilamine derivative, amino substituted chalcone derivative, oxazole derivative, styrylanthracene derivative, fluorenone derivative, hydrazone derivative, silazane derivative, polysilane species aniline species copolymer, high molecular obigomer, styrylamine compound, aromatic dimethylidine species compound, poly 3-methylthiophene and the like. Further, there is also used a hole transporting layer of polymer dispersing species in which an organic material for a low molecular hole transporting layer is dispersed in polymer of polycarbonate or the like. Further, the hole transporting materials can be used also for hole injecting material or an electron blocking material.

Further, as the electron transporting layer 34, there can be used oxadiazole derivatives of 1,3-bis(4-tert-butylphenil-1,3,4-oxadiazolyl)phenylene(OXD-7) and the like, anthraquinomethane derivative, diphenylquinone derivative or PEDOT (polyethylenedioxithiophene), BAlq, BCP (bathophbroine) and the like. Further, the electron transporting materials can also be used as the electron injecting materials or the hole blocking materials.

A cathode is an electrode for injecting an electron, and the electron is to be efficiently injected into a light emitting layer or an electron transporting layer. A metal having a small work function such as Al (aluminum), In (indium), Mg (magnesium), Ti (titanium), Ag (silver), Ca (calcium) or Sr (strontium) or their metal oxides and fluorides and alloys thereof, and a laminated product are generally used for the cathode. A light which once reaches a light/air interface and is not taken out into the air by the Fresnel reflection is propagated into the element again and reaches the cathode. Alternatively, the light is isotropically irradiated in the light emitting layer. Therefore, a half of the light irradiated from the light emitting layer reaches the cathode before arriving at the light take-out surface. In this case, if the cathode is formed by a material for reflecting the light, the light reaching the cathode can be reflected and can be propagated in the direction of the light take-out surface again, and might be utilized as an effective light. In order to cause this advantage to be effective, it is preferable that the cathode should be formed by a material for reflecting a light, and furthermore, a reflectance should be 50% or more. The foregoing is applied to the anode when the cathode is used as a transparent electrode.

For the cathode, moreover, a very thin film using a metal having a small work function and having a high light transmittivity is formed on an interface provided in contact with the light emitting layer or the electron transporting layer, and a transparent electrode is provided thereon. Thus, a transparent cathode can also be formed. In particular, Mg, having a small work function, an Mg—Ag alloy, an Al—Li alloy, an Sr—Mg alloy, an Al—Sr alloy, an Al—Ba alloy or a lamination structure of LiO₂/Al or LiF/Al which has been described in JP-A-5-121172 is suitable for a cathode material.

Furthermore, a resistance heating evaporation method, an electron beam evaporation method or a sputtering method is used for a method of forming these cathodes.

It is sufficient that at least one of the anode and the cathode is a transparent electrode. Furthermore, both of them may be the transparent electrodes. In order to enhance a light take-out efficiency, it is preferable that one of them should be formed by a material for reflecting a light if the other is the transparent electrode.

In order to cut off the organic electroluminescence element from the outside air and to guarantee a long-time stability, moreover, a protective film is formed on the surface of the element in some cases. The material of the protective film includes a thin film formed of an inorganic oxide, an inorganic nitride or an inorganic fluoride such as SiON, SiO, SiN, SiO₂, Al₂O₃ or LiF, a glass film formed by an inorganic oxide, an inorganic nitride, an inorganic fluoride or their mixture, a thermosetting or photo-curing resin or a silane type polymer material having a sealing effect, and the protective film is formed by evaporation, sputtering or a coating method.

A very small point light source forming a light emitting unit on the side surface of a waveguide can be used as the light source of an illuminating device. In particular, a parallel light source can easily be formed by a combination with a simple optical system in respect of an advantage that the light source is very small. The point light source can be used as a light source of a parallel light illuminating apparatus using the parallel light source or an image projecting apparatus such as an OHP or a projector using the parallel light source.

Embodiments of the invention will be described below.

(First Embodiment)

A light source according to an embodiment of the invention will be described.

FIG. 7 is a sectional view showing the main part of a light source using a waveguide according to another embodiment of the invention.

In FIG. 7, a waveguide 6, a core 7, a clad 8 and a light emitting unit 9 are the same as those described in the prior art, and therefore, have the same reference numerals and description will be omitted.

The light source using the waveguide according to the embodiment has such a structure that a plurality of light emitting units is arranged on a face at an opposed side to the light take-out surface of the waveguide 6 including the core 7 and the clad 8. The light emitting unit has such a structure that it is arranged to have an angle with a position shifted from the central part of the core and a light irradiated from the light emitting unit is incident from the core portion. By such a structure, it is possible to easily implement a very small point light source comprising a light emitting unit having a large light emitting area by using a very small waveguide. Furthermore, a large light emitting unit can be used for a light take-out surface. Consequently, it is possible to easily implement a point light source having a great brightness. In particular, the light emitting unit is arranged to have an angle as in the embodiment of the invention. Thus, it is possible to increase the amount of a light incident on the very small waveguide and to easily implement a point light source having a great brightness. The components and forming method of the core and the clad can be properly selected and used from the components and forming method described above and well-known materials in order not to hinder a light emission from the light emitting unit.

While the description has been given to the case in which an air layer is provided between the core and the light emitting unit in the embodiment, moreover, the structure is not particularly restricted thereto as described above but the core and the light emitting unit may be coupled to each other by a transparent medium.

As described above, according to the embodiment, it is possible to easily implement a point light source using a light emitting unit having a large area by using a very small waveguide. A light emitting unit having a large light emitting area is used for a light take-out surface. Consequently, it is possible to implement a point light source having a great brightness.

It is apparent that the light source according to the embodiment can be used as a light source for an illuminating device or a display device. In particular, it is apparent that a parallel light source can easily be formed by a combination with a simple optical system and can be used as a light source for an image projecting device such as a projector.

(Second Embodiment)

A light source according to an embodiment of the invention will be described.

FIG. 8 is a sectional view showing the main part of a light source using a waveguide according to a further embodiment of the invention.

In FIG. 8, a waveguide 6 and a light emitting unit 9 are the same as those described in the prior art, and therefore, have the same reference numerals and description will be omitted. 11 denotes a lens.

The light source using the waveguide according to the embodiment has such a structure that a plurality of light emitting units is arranged on the side surface of the waveguide 6. Moreover, the light emitting unit is arranged on two different surfaces in the waveguide and a light irradiated from the light emitting unit is incident from the side surface into the waveguide without an air layer. By such a structure, it is possible to easily implement a very small point light source comprising a light emitting unit having a large light emitting area by using a very small waveguide. Furthermore, a large light emitting unit can be used for a light take-out surface. Consequently, it is possible to easily implement a point light source having a great brightness. In particular, the light emitting unit is arranged on the two different surfaces of the waveguide as in the embodiment of the invention so that the area of the light emitting unit for the light take-out surface can be increased. Thus, it is possible to increase the amount of a light incident on the very small waveguide and to easily implement a point light source having a great brightness. The components and forming method of the core and the clad can be properly selected and used from the components and forming method described above and well-known materials in order not to hinder a light emission from the light emitting unit.

A sufficiently larger lens than the waveguide is provided on the outside of the light take-out surface according to the invention. Consequently, a light emitted from the light take-out surface is converted into a parallel light through the lens. Thus, it is possible to form a parallel light source which can be used for various illuminations. In particular, since the parallel light source according to the invention carries out a conversion from a very small point light source to a parallel light, it can easily carry out the conversion into the parallel light and can be used as a very small parallel light source.

While the description has been given to the waveguide comprising the core having no clad layer and the air layer in the embodiment, moreover, the structure of the waveguide is not particularly restricted thereto as described above but the clad layer can also be provided on the optional surface of the waveguide and may be provided over a whole surface including an element after the formation of the element.

As described above, according to the embodiment, it is possible to easily implement a point light source using a light emitting unit having a large area by using a very small waveguide. A light emitting unit having a large light emitting area is used for a light take-out surface. Consequently, it is possible to implement a point light source having a great brightness.

It is apparent that the light source according to the embodiment can be used as a light source for an illuminating device or a display device. In particular, it is apparent that a parallel light source can easily be formed by a combination with a simple optical system and can be used as a light source for an image projecting device such as a projector.

(Third Embodiment)

A light source according to an embodiment of the invention will be described.

FIG. 1 is a schematic sectional view showing the light source using a waveguide according to the embodiment of the invention.

In FIG. 1, an anode 2, a hole transporting layer 3, a light emitting layer 4, a cathode 5 and a waveguide 6 are the same as those described in the prior art, and therefore, have the same reference numerals and description will be omitted.

The light source using the waveguide according to the embodiment has such a structure that an organic electroluminescence element to be a surface light emitting unit is arranged on the side surface of the waveguide 6. Moreover, the organic electroluminescence element is arranged on three different surfaces in the waveguide and a light emitted from the light emitting unit is incident from a side surface into the waveguide without an air layer. By using the organic electroluminescence element as the light emitting unit as in the embodiment of the invention, particularly, it is possible to easily form the light emitting unit on a plurality of surfaces of the waveguide. In the case in which the organic electroluminescence element is used, moreover, the waveguide can also be utilized as a substrate. In this case, the substrate can be omitted. Therefore, the element can easily be caused to be very small. In the case in which the organic electroluminescence element is used as the light emitting unit, particularly, the lifetime of the element causes a problem so that it is hard to cause the light emitting layer to have a great brightness. By a point light source having such a structure, therefore, it is possible to implement a light source having a great brightness without increasing a burden to the light emitting layer and to implement a light source which avoids the problem of the lifetime.

By such a structure, it is possible to easily implement a very small point light source comprising a light emitting unit having a large light emitting area by using a very small waveguide. Furthermore, a large light emitting unit can be used for a light take-out surface. Consequently, it is possible to easily implement a point light source having a great brightness. In particular, the light emitting unit is arranged on at least two different surfaces of the waveguide as in the embodiment of the invention so that the area of the light emitting unit for the light take-out surface can easily be increased. Thus, it is possible to increase the amount of a light incident on the very small waveguide and to easily implement a point light source having a great brightness. The components and forming method of the core and the clad can be properly selected and used from the components and forming method described above and well-known materials in order not to hinder a light emission from the light emitting unit.

While the description has been given to the waveguide comprising the core having no clad layer and the air layer in the embodiment, moreover, the structure is not particularly restricted thereto as described above but the clad layer can also be provided on the optional surface of the waveguide and may be provided over a whole surface including an element after the formation of the element.

As described above, according to the embodiment, it is possible to easily implement a point light source using the organic electroluminescence element by using a very small waveguide. A light emitting unit having a large light emitting area is used for a light take-out surface. Consequently, it is possible to implement a point light source having a long lifetime and a great brightness.

It is apparent that the light source according to the embodiment can be used as a light source for an illuminating device or a display device. In particular, it is apparent that a parallel light source can easily be formed by a combination with a simple optical system and can be used as a light source for an image projecting device such as a projector.

### EXAMPLES

### Example 1

By a low temperature sputtering apparatus decompressed to a degree of vacuum of 2×10⁻⁶ Torr or less, a transparent SiON film having a thickness of 10 μm was provided over a transparent substrate formed of quartz by using a sputtering method, and a resist material (OFPR-800 manufactured by Tokyo Ohka Co., Ltd.) was then applied onto the SiON film by a spin coating method, thereby forming a resist film having a thickness of 3 μm and masking, exposure and development were carried out to pattern the resist film to have a predetermined shape. Thus, a waveguide was formed.

Next, an optical bonding agent having an equal refractive index to that of the SiON film was applied onto the surface of an inorganic LED comprising GaAs and AlGaAs arranged in the same pattern as the waveguide, and a light emitting section and the waveguide were arranged to be placed in the same position and were pressed and stuck.

### Example 2

A polycarbonate film having a thickness of 10 μm was provided on a transparent substrate formed by a glass. A trench having a width of 10 μm was formed on the polycarbonate film by using a cutting tool and a clad layer was provided. A resist material was applied onto the substrate provided with the clad layer and a resist film was applied onto the trench formed on the polycarbonate film by utilizing a capillary tube phenomenon, and furthermore, the resist film thus patterned was exposed and bleached so that a waveguide substrate comprising the transparent resist was formed.

Next, the patterning substrate was subjected to a cleaning treatment in order of cleaning with a cleaning agent (SEMICO CLEAN manufactured by FURUUCHI KAGAKU Co., Ltd.), cleaning with pure water and cleaning with pure water at 50° C., and water stuck to the substrate was then removed by means of a nitrogen blower, and furthermore, the same substrate was heated and dried.

Subsequently, ITO was formed in a thickness of approximately 150 nm as an anode on a surface provided with the waveguide of the waveguide substrate in a sputtering apparatus decompressed to have a degree of vacuum of 2×10⁻⁶ Torr or less.

Then, a resist having a thickness of 3 μm was applied onto the patterning substrate by a spin coating method, and exposure and development were carried out in such a pattern as to cause the resist to remain in only the waveguide portion formed by the resist, and the ITO was etched. Thus, the patterning substrate provided with the anode comprising the ITO was formed on the waveguide.

Subsequently, the patterning substrate was cleaned in the same manner and TPD was then formed in a thickness of approximately 50 nm as a hole transporting layer on a surface at an anode side in a resistance heating evaporation apparatus decompressed to have a degree of vacuum of 2×10⁻⁶ Torr or less.

Next, Alq₃ was formed in a thickness of approximately 60 nm as a light emitting layer on the hole transporting layer in the resistance heating evaporation apparatus in the same manner. Both the TPD and the Alq₃ had an evaporation speed of 0.2 nm/s.

Thereafter, a cathode was formed in a thickness of 150 nm on a light emitting layer by using, as an evaporation source, an Al—Li alloy containing 15 at % of Li in the resistance heating evaporation apparatus in the same manner.

### Comparative Example

An ITO film having a thickness of 160 nm was formed on a transparent substrate formed by a glass and a resist material was then applied onto the ITO film by a spin coating method to form a resist film having a thickness of 10 μm, and masking, exposure and development were carried out to etch the ITO so that an anode having a width of 10 μm was formed.

Next, a resist film was applied in a thickness of 3 μm onto the surface of the substrate provided with the anode and patterning was then carried out in such a configuration as to remove the resist in a width of 10 μm in a perpendicular crossing direction to the anode so that a patterning substrate provided with an anode of 10 μm square was obtained.

Subsequently, the patterning substrate was subjected to a cleaning treatment in order of ultrasonic cleaning for 5 minutes with a cleaning agent (SEMICO CLEAN manufactured by FURUUCHI Chemical Co., Ltd.), ultrasonic cleaning for 10 minutes with pure water, ultrasonic cleaning for 5 minutes with a solution mixing aqueous hydrogen peroxide and water in a ratio of 1 to 5 for 1 of aqueous ammonia (volume ratio) and ultrasonic cleaning for 5 minutes with pure water at 70° C., and water stuck to the substrate was then removed by means of a nitrogen blower, and the same substrate was heated and dried.

Thereafter, the patterning substrate was cleaned in the same manner, and TPD was then formed in a thickness of approximately 50 nm as a hole transporting layer on a surface at an anode side in a resistance heating evaporation apparatus decompressed to have a degree of vacuum of 2×10⁻⁶ Torr or less.

Next, Alq₃ was formed in a thickness of approximately 60 nm as a light emitting layer on the hole transporting layer in the resistance heating evaporation apparatus in the same manner. Both the TPD and the Alq₃ had an evaporation speed of 0.2 nm/s.

Then, a cathode was formed in a thickness of 150 nm on a light emitting layer by using, as an evaporation source, an Al—Li alloy containing 15 at % of Li in the resistance heating evaporation apparatus in the same manner.

TABLE 1

| | | Amount of emitted |
|---|---|---|
| | Size of element | light |
| Example 1 | ⊚ | ⊚ |
| Example 2 | ⊚ | ⊚ |
| Comparative example | ∘ | Δ |

Description will be given to an evaluating method in an evaluation item in the (Table 1) and an evaluation criterion thereof.

Referring to the size of an element, the light emitting area of a light source was evaluated. The evaluation was carried out in three stages of ⊚, ◯ and Δ. For the element area of a conventional inorganic LED, the evaluation criterion represents ⊚: excellent, ◯: good and Δ: permissible.

Referring to the amount of an emitted light, moreover, the amount of a light emitted from a light source was evaluated. The evaluation was carried out in three stages of ⊚, ◯ and Δ. For the amount of a light according to the comparative example, the evaluation criterion represents ⊚: excellent, ◯: good and Δ: permissible.

A first aspect of the invention is directed to a light source comprising at least a light emitting unit including a light emitting layer for electrically emitting a light, and a waveguide for emitting a light irradiated from the light emitting unit into air through a light take-out surface formed on an end face, wherein an area of the light take-out surface of the waveguide is set to be smaller than that of the light emitting layer. The area of the light take-out surface can be set to be smaller than that of the light emitting layer, and an area for irradiation can be determined by the size of the light take-out surface. Therefore, it is possible to easily implement a very small point light source.

A second aspect of the invention is directed to the light source according to the first aspect of the invention, wherein the light emitting unit is formed on a side surface of the waveguide. The area of the light take-out surface can be set to be smaller than that of the light emitting layer, and an area for irradiation can be determined by the size of the light take-out surface. Therefore, it is possible to easily implement a very small point light source. By forming the light emitting unit on the side surface, moreover, it is possible to sufficiently increase the area of the light emitting layer with respect to the light take-out surface. Consequently, it is possible to easily implement a point light source having a great brightness.

A third aspect of the invention is directed to the light source according to the first or second aspect of the invention, wherein a direction of a light propagation of the waveguide is different from a direction of a normal of the light emitting layer. The area of the light take-out surface can be set to be smaller than that of the light emitting layer, and an area for irradiation can be determined by the size of the light take-out surface. Therefore, it is possible to easily implement a very small point light source. By such a structure that the direction of the normal of the light emitting unit is different from the direction of the propagation of the light, moreover, it is possible to sufficiently increase the area of the light emitting layer with respect to the light take-out surface. Consequently, it is possible to easily implement a point light source having a great brightness.

A fourth aspect of the invention is directed to the light source according to any of the first to third aspects of the invention, wherein the light emitting unit is optically coupled to the waveguide without an air layer provided therebetween. The area of the light take-out surface can be set to be smaller than that of the light emitting layer, and an area for irradiation can be determined by the size of the light take-out surface. Therefore, it is possible to easily implement a very small point light source. Moreover, it is possible to reduce the loss of a light by a total reflection before incidence on the waveguide. Consequently, it is possible to enhance the utilization efficiency of a light and to easily implement a point light source having a great brightness.

A fifth aspect of the invention is directed to the light source according to any of the first to fourth aspects of the invention, wherein the waveguide has a lower refractive index than that of the light emitting layer. The area of the light take-out surface can be set to be smaller than that of the light emitting layer, and an area for irradiation can be determined by the size of the light take-out surface. Therefore, it is possible to easily implement a very small point light source. Since the light incident on the waveguide is increased in the direction of the propagation of the light, moreover, the loss of the light can be reduced in the waveguide. Consequently, it is possible to enhance the utilization efficiency of a light- and to easily implement a point light source having a great brightness.

A sixth aspect of the invention is directed to the light source according to any of the first to fifth aspects of the invention, wherein the waveguide has a refractive index which is higher than a refractive index obtained by subtracting 0.3 from a value of the refractive index of the light emitting layer. The area of the light take-out surface can be set to be smaller than that of the light emitting layer, and an area for irradiation can be determined by the size of the light take-out surface. Therefore, it is possible to easily implement a very small point light source. Moreover, it is possible to reduce the loss of a light by a total reflection before incidence on the waveguide. Consequently, it is possible to enhance the utilization efficiency of a light and to easily implement a point light source having a great brightness.

A seventh aspect of the invention is directed to the light source according to any of the first to sixth aspects of the invention, wherein the waveguide is formed by using the same material as a material of the light emitting layer. The area of the light take-out surface can be set to be smaller than that of the light emitting layer, and an area for irradiation can be determined by the size of the light take-out surface. Therefore, it is possible to easily implement a very small point light source. Moreover, it is possible to easily set the refractive indices of the waveguide and the light emitting layer to be equal to each other without the complicated selection of the material and to reduce the loss of a light caused by a total reflection before incidence on the waveguide and the loss of a light in the waveguide caused by an increase in an optical path length. Consequently, it is possible to enhance the utilization efficiency of a light and to easily implement a point light source having a great brightness.

An eighth aspect of the invention is directed to the light source according to any of the first to seventh aspects of the invention, wherein the waveguide is provided with an angle converting layer for converting an angle of a light. The area of the light take-out surface can be set to be smaller than that of the light emitting layer, and an area for irradiation can be determined by the size of the light take-out surface. Therefore, it is possible to easily implement a very small point light source. Moreover, a wasted light in the simple waveguide can be utilized as an effective light. Consequently, it is possible to enhance the utilization efficiency of a light and to easily implement a point light source having a great brightness.

A ninth aspect of the invention is directed to the light source according to any of the first to eighth aspects of the invention, wherein the waveguide is constituted by a core having a predetermined refractive index and a clad formed on an outer periphery of the core and having a lower refractive index than the refractive index of the core, and the angle converting structure for converting an angle of a light is formed on an interface between the core and the clad on an opposite side to the light emitting layer. The area of the light take-out surface can be set to be smaller than that of the light emitting layer, and an area for irradiation can be determined by the size of the light take-out surface. Therefore, it is possible to easily implement a very small point light source. Moreover, a wasted light in the simple waveguide can be utilized as an effective light. Consequently, it is possible to enhance the utilization efficiency of a light. Since a light having an angle converted is efficiently propagated in the waveguide, furthermore, it is possible to easily implement a point light source having a great brightness.

A tenth aspect of the invention is directed to the light source according to any of the first to ninth aspects of the invention, wherein the light emitting layer is formed on two surfaces or more other than the light take-out surface of the waveguide. The area of the light take-out surface can be set to be smaller than that of the light emitting layer, and an area for irradiation can be determined by the size of the light take-out surface. Therefore, it is possible to easily implement a very small point light source. By forming the light emitting unit on the two surfaces or more, moreover, it is possible to sufficiently increase the area of the light emitting layer with respect to the light take-out surface. Consequently, it is possible to easily implement a point light source having a great brightness.

An eleventh aspect of the invention is directed to the light source according to any of the first to tenth aspects of the invention, wherein the waveguide is provided with a reflecting plane on an opposed surface to the light take-out surface. The area of the light take-out surface can be set to be smaller than that of the light emitting layer, and an area for irradiation can be determined by the size of the light take-out surface. Therefore, it is possible to easily implement a very small point light source. Moreover, a wasted light in the waveguide having no reflecting plane can be utilized as an effective light. Consequently, it is possible to enhance the utilization efficiency of a light and to easily implement a point light source having a great brightness. Moreover, the wasted light is irradiated on an unnecessary portion. For this reason, measures such as light shielding are required. By such a structure, however, extra measures such as light shielding are not required.

A twelfth aspect of the invention is directed to the light source according to any of the first to eleventh aspects of the invention, wherein the waveguide has an opposed surface to the light take-out surface which is not formed perpendicularly. The area of the light take-out surface can be set to be smaller than that of the light emitting layer, and an area for irradiation can be determined by the size of the light take-out surface. Therefore, it is possible to easily implement a very small point light source. Moreover, the non-perpendicular surface is formed. Consequently, the wasted light in the waveguide by a total reflection over this surface can be utilized as an effective light. Therefore, it is possible to enhance the utilization efficiency of a light and to easily implement a point light source having a great brightness.

A thirteenth aspect of the invention is directed to the light source according to any of the first to twelfth aspects of the invention, wherein the light emitting unit is an organic electroluminescence element. The area of the light take-out surface can be set to be smaller than that of the light emitting layer, and an area for irradiation can be determined by the size of the light take-out surface. Therefore, it is possible to easily implement a very small point light source. Moreover, it is possible to easily form a light source having a great brightness without increasing a burden to the light emitting unit. Consequently, it is possible to easily implement a point light source having a great brightness by using the organic electroluminescence element having a problem of a lifetime.

A fourteenth aspect of the invention is directed to a parallel light illuminating apparatus constituted by at least the light source according to any of the first to thirteenth aspects of the invention and an optical system. A very small point light source having a great brightness can be used. Consequently, it is possible to easily implement a small-sized parallel light illuminating apparatus having a great brightness.

A fifteenth aspect of the invention is directed to an image projecting apparatus using the parallel light illuminating apparatus according to the thirteenth aspect of the invention. A small-sized parallel light illuminating apparatus having a great brightness can be used. Consequently, it is possible to easily implement a small-sized image projecting apparatus.

### Second Mode of Embodiment

Embodiments of the invention will be described below with reference to FIGS. 10 to 16. In these drawings, the same members have the same reference numerals, and furthermore, repetitive description will be omitted.

FIG. 10 is a schematic sectional view showing the structure of a waveguide light source according to a first embodiment of the invention, FIG. 11 is a schematic sectional view showing the structure of a waveguide light source according to a second embodiment of the invention, FIG. 12 is an explanatory view showing, in detail, the light emitting unit section of the waveguide light source in FIG. 10, FIG. 13 is an explanatory view showing, in detail, the propagation interface of the waveguide light source in FIG. 10, FIG. 14 is a schematic sectional view showing the structure of an exposing device using a waveguide light source according to a third embodiment of the invention, FIG. 15 is an explanatory plan view showing, in detail, the light shielding structure of an exposing device in FIG. 13, and FIG. 16 is a schematic sectional view showing the structure of a printer in which the waveguide light source in FIG. 11 is used as exposing means according to a fourth embodiment of the invention.

In FIG. 10, 101 denotes a waveguide, 102 denotes a light emitting unit, 103 denotes a light incidence plane and 104 denotes a light emitting plane. In FIG. 10, the light emitting unit 102 is formed on the light incidence plane 103 of the waveguide 101. A light incident from the light incidence plane 103 is reflected by the side surface of the waveguide 101 and thus reaches the light emitting plane 104. At this time, the area of the light emitting plane 104 is smaller than that of the light incidence plane 103 and the incident light is gradually reduced with a propagation, and a brighter light than a light emitted from the light emitting unit 102 can be emitted from the light emitting plane 104. With such a structure that the light is reduced and emitted, it is sufficient that the waveguide 101 is almost trapezoidal.

In FIG. 11, 105 denotes a reflecting plane. In FIG. 11, the light incidence plane 103 of the waveguide 101 is formed on an adjacent surface to the light emitting plane 104 and the light emitting unit 102 is formed on the light incidence plane 103. By such a structure, the light emitting unit 102 can be arranged freely and a small-sized light source can easily be implemented.

The light incident from the light incidence plane 103 is reflected by the reflecting plane 105, and thus reaches the light emitting plane 104 with a reflection by the side surface of the waveguide 101 in the same manner as in the waveguide light source shown in FIG. 11. At this time, the area of the light emitting plane 104 is smaller than that of the light incidence plane 103. Consequently, a brighter light than the light emitted from the light emitting unit 102 can be obtained from the light emitting plane 104. By using the waveguide 1 coupling the waveguide 101 including the reflecting plane 105 for converting the direction of the emission of a triangular light and the waveguide 101 for reducing a light as shown in FIG. 11, it is possible to freely arrange the light emitting unit 102 and to reduce the size of an exposing device. While the description has been given to the case in which the reflecting plane 105 is used as a surface for converting the emitting angle of a light, moreover, it is not restricted but a prism-shaped structure utilizing a difference in a refractive index between the waveguide 101 and an air layer may be employed, for example. It is sufficient that the angle of the light incident from the light incidence plane 103 is converted in almost the direction of the light emitting plane 104.

In FIG. 12, a mesa structure 106 to be a light incidence angle converting structure is provided between the light emitting unit 102 and the waveguide 101, and a lens 107 to be a light emitting angle converting structure is provided on the light emitting plane 104 of the waveguide 101. In the case in which a light is propagated through the trapezoidal waveguide 101, a light having a small angle is increased in the direction of progress of a light with the propagation of the light. Furthermore, the light having a small angle does not reach the light emitting plane 104 of the waveguide 101 but is emitted as an ineffective light from the side surface of the waveguide 101. For this reason, it is preferable that the light incident from the light incidence plane should have a great angle in the direction of the progress, and the angle of the light irradiated from the light emitting unit 102 is converted by the mesa structure 106 and the same light is incident as a light having a great angle. While the light angle converting effect on a mesa plane obtained by the mesa structure 106 has been used, a lens may be utilized. It is possible to properly select and use an incidence angle converting structure for increasing the angle of a light.

Although the light is emitted from the light emitting plane 104 into the air, moreover, the light is refracted on an interface between the light emitting plane 104 and the air and the angle thereof is further reduced. In a light source, particularly, a light source for irradiating a light on a specific position, for example, an exposing device, therefore, it is preferable that the angle of the light should be increased over the light emitting plane 104. A light emitting angle converting structure is formed on the light emitting plane 104 so that a light having a great angle is emitted. While the light angle converting effect obtained by the lens has been used, the mesa structure 106 may be employed. It is possible to properly select and use an emitting angle converting structure for increasing the angle of a light.

In FIG. 13, an air layer is provided between the light emitting unit 102 and the waveguide 101, and a saw-toothed light propagation angle converting structure is provided on two side surfaces of the waveguide 101. As described above, when the light is to be propagated in the waveguide 101, the light having a small angle is increased. In order to prevent this situation, accordingly, the light propagation angle converging structure is provided on the waveguide 101 surface so that the effect of reducing the angle of a light can be suppressed. Furthermore, the air layer is provided between the light emitting unit 102 and the waveguide 101. Consequently, the light incident from the light incidence plane 103 is changed to be a light having a great angle in the direction of progress by a refraction on the light incidence plane 103. Thus, an efficient light propagation is carried out.

While the description has been given by using the waveguide 101 constituted by only the core in FIGS. 10 to 13, moreover, it is also possible to use the waveguide 101 formed by a core having a predetermined refractive index and a clad having a lower refractive index than that of the core on the outer periphery of the core. In such a waveguide 101 formed by the core and the clad, the total reflection of a light is generated on both an interface between the core and the clad and an interface between the clad and the air. However, a part of the light is emitted from the interface between the clad and the air other than the light emitting plane 104 and is wasted. In order to utilize such a wasted light as an effective light, accordingly, it is preferable that the reflecting plane 5 should be formed around the waveguide 101, particularly, around the clad. Consequently, a reflectance is smaller than that of the total reflection so that a light loss is generated in a small amount. However, a light emitted from the clad can be utilized again as the wasted light so that a light source having a great brightness can be implemented.

Moreover, an exposing device using these waveguide light sources will be described with reference to FIG. 15. In FIG. 15, 109 denotes a core and 110 denotes a clad. The exposing device has such a structure that a plurality of light sources capable of emitting a light corresponding to an image signal is arranged in a line. In order to form such a structure, it is necessary to divide at least the light sources themselves, thereby emitting a light independently. Furthermore, it is preferable to employ such a structure that a plurality of waveguides 101 divided optically for each pixel is arranged in parallel. By employing such a structure, it is possible to implement an efficient light emission having less cross-talk of the light.

In FIG. 15, a total reflection based on a difference in a refractive index between the core 109 and the clad 110 is utilized for the optical division in each pixel. In case of such a structure that a plurality of waveguides 101 is arranged, a light shielding layer is formed between two different waveguides 101 in order to prevent the cross talk of the light with an adjacent pixel. Consequently, it is possible to prevent the cross talk of the light from being caused by the light which has not been totally reflected over the interface between the core 109 and the clad 110. However, more lights which are not totally reflected over the interface between the core 109 and the clad 110 generally have small angles in the direction of the propagation of the waveguide 101 as compared with the lights reflected totally. Even if these lights are irradiated from the light emitting plane 104 of another pixel, they do not reach a photosensitive member to be an exposing object. In case of such a structure that the light is reduced in a different direction from the direction of the adjacent pixels with respect to the direction of the propagation of the light as in the invention, particularly, the light to be irradiated from the light emitting plane 104 of a corresponding pixel has a sufficiently great brightness as a result of the reduction, and the lights incident from other pixels are sufficiently small and can be disregarded. Even if the light shielding layer is not formed between the adjacent waveguides 101, therefore, a problem is rarely caused practically.

As described above, the light emitted from the light source using the waveguide 101 is a dispersed light. In the case in which the same light source is used as the light source of the exposing device, accordingly, an optical system is to be provided on the light emitting plane 104 to irradiate a light corresponding to a pixel. In order to efficiently irradiate the light on the corresponding pixel, it is preferable that light amount transmitting means for forming an erected equal magnification image should be provided as the optical system on the light emitting plane 104.

Moreover, the organic electroluminescence element according to the invention can be used as a light source of a recording apparatus using an electrophotographic method such as a laser printer or a scanner.

Next, FIG. 16 shows an example of an image forming apparatus using the electrophotographic method according to the invention. A photosensitive member is constituted by at least an indicating member and a light transmitting layer in which a transmitting property is changed by the irradiation of a light. By irradiating a light, it is possible to control the transmitting property of the surface of the photosensitive member, thereby forming an image corresponding to image information.

The photosensitive member having a nonuniform surface potential distribution is charged by charging means using a contact or non-contact charging method, thereby forming a charged surface which is charged uniformly to have a predetermined potential on the surface of the photosensitive member. The charging method includes a method of carrying out a corona discharge and charging in non-contact with the surface of the photosensitive member and a method of causing a charging section having a voltage applied thereto, for example, a charging roller, a fur brush roller, a magnetic brush roller or a charging blade to come in contact with the surface of the photosensitive member. In recent years, the contact charging method has been used practically because the generation of ozone can be suppressed or a power consumption in the charging section is small. Any charging method may be used. Moreover, a bias to be added to the photosensitive member may be a DC bias or an alternating bias such as a sine wave, a rectangular wave or a triangular wave can also be applied, and a bias comprising an optional cyclic ON/OFF signal may be applied.

A light based on image information is irradiated on the charged surface of the photosensitive member by using the exposing means so that an electrical latent image having a surface potential corresponding to the image information is formed on the charged surface of the photosensitive member. The electrical latent image is developed as a toner image on the surface of the photosensitive member corresponding to the image information by sticking an insulating toner by an electrostatic power in toner sticking means. A developing method includes a contact developing method, a non-contact developing method, a one-component developing method, a 2-component developing method, an inversion developing method or a normal developing method, and any of the developing methods may be used. An applied voltage in a developing device is the same as the bias of the charging member and an optional DC or alternating bias can be properly selected and used.

Furthermore, a toner image formed on the photosensitive member is transferred as a toner image on a transfer material such as a paper or an intermediate transfer member including a belt and a drum by a predetermined pressing force and a transfer bias in toner transfer means. A transfer method includes roller transfer, blade transfer and corona discharge transfer which can be properly selected and used.

Finally, the transfer material receiving the toner image is separated from the surface of the photosensitive member, and is fixed onto the surface of a printing object by fixing means such as thermal fixing and is discharged as a printed matter. Moreover, the residual toner is properly removed from the photosensitive member after the toner image transfer by cleaning means so that the surface is cleaned up.

In case of a monochrome printer, a black toner is used as a toner. The monochrome printer is implemented by the image forming apparatus, the fixing means and paper feeding and discharging means.

In case of a full color printer, four different toner sticking means are used, and serve to develop, as respective toner images, latent images corresponding to respective image information and to transfer a black toner, a cyan toner, a magenta toner and an yellow toner, thereby obtaining a predetermined full color printed matter on a printing object. Alternatively, it is possible to implement a full color printed matter by collectively developing and transferring, as one toner image; a plurality of image information for latent images corresponding to respective image information. Alternatively, a plurality of image forming apparatuses is provided corresponding to black, cyan, magenta and yellow and respective toner images are transferred to implement a full color printed matter. Moreover, it is also possible to collect these optional processes as one removable process cartridge.

In the image forming apparatus having such a structure, first of all, a latent image is formed and transferred onto a photosensitive member in accordance with image information about an yellow component. At this time, a latent image of a magenta component is simultaneously formed and the transfer of the yellow component is followed by the transfer of the magenta component. Similarly, toner images are superposed in order of a cyan component and a black component so that a full color printed matter is formed.

Embodiments of the invention will be described below.

(First Embodiment)

A light source according to an embodiment of the invention will be described.

A light source using a waveguide 101 according to the embodiment has such a structure that a light incidence plane 103 is provided on an opposed surface to a light emitting plane 104 of the waveguide 101, and a light emitting unit 102 is formed on the light incidence plane 103 as shown in FIG. 10. The light emitting unit 102 can easily implement a waveguide light source narrowing a light through the light emitting unit 102 having a large light emitting area, and furthermore, the larger light emitting unit 102 than the light emitting plane 104 can be used. Therefore, it is possible to easily implement a light source having a great brightness without increasing a burden to the light emitting unit 102. The components and forming method of the waveguide 101 can be properly selected and used from the components and forming method described above and well-known materials in order not to hinder a light emission from the light emitting unit 102.

While the structure of the waveguide comprising only the core has been described in the embodiment, moreover, it is not particularly restricted thereto as described above but a structure comprising a core and a clad may be employed.

As described above, according to the embodiment, it is possible to easily implement a light source having a great brightness without increasing a burden to the light emitting unit 102 by using the waveguide 1 in which the light emitting plane 104 is smaller than the light incidence plane 103.

It is apparent that the light source according to the embodiment can be used as a light source for an illuminating device or a display device.

(Second Embodiment)

A light source according to an embodiment of the invention will be described.

A light source using a waveguide 101 according to the embodiment has such a structure that a light incidence plane 103 is provided on an adjacent surface to a light emitting plane 104 of the waveguide 101, and an organic electroluminescence element comprising an anode 111, a hole transporting layer 112, a light emitting layer 113 and a cathode 114 is formed on the light incidence plane 103 as shown in FIG. 11. The angle of a light irradiated from the organic electroluminescence element is converted in almost the direction of the light emitting plane 104 by a reflecting plane 105 formed in the direction of a normal of the light incidence plane 103. By such a structure, it is possible to easily implement a waveguide light source having a light reduced from the light emitting unit 102 having a large light emitting area, and furthermore, to use the large light emitting unit 102 for the light emitting plane 104. Consequently, it is possible to easily implement a light source having a great brightness using the organic electroluminescence element without increasing a burden to the light emitting unit 102. In the embodiment of the invention, furthermore, the light incidence plane 103 and the light emitting plane 104 are formed on the adjacent surfaces to each other. Therefore, a thin light source can easily be formed and a small-sized exposing device can readily be formed. Because of the thin light source, particularly, it is possible to easily implement a light source having a high degree of arrangement freedom which can be arranged freely at a small pitch. The components and forming method of the waveguide 101 can be properly selected and used from the components and forming method described above and well-known materials in order not to hinder a light emission from the light emitting unit 102.

While the structure of the waveguide comprising only the core has been described in the embodiment, moreover, it is not particularly restricted thereto as described above but a structure comprising a core and a clad may be employed.

As described above, according to the embodiment, it is possible to easily implement a light source having a great brightness using the organic electroluminescence element without increasing a burden to the light emitting layer by using the waveguide 101 in which the light emitting plane 104 is smaller than the light incidence plane 103. By using the reflecting plane 105, furthermore, it is possible to form the light incidence plane 103 and the light emitting plane 104 on adjacent surfaces to each other. Thus, it is possible to implement a light source having a high degree of arrangement freedom.

It is apparent that the light source according to the embodiment can be used as a light source for an illuminating device or a display device, and particularly, is the most suitable for a light source in a small-sized illuminating device or display device.

(Third Embodiment)

An exposing device according to an embodiment of the invention will be described.

An exposing unit using a waveguide light source according to the embodiment is constituted by arranging a plurality of waveguide light sources having such a structure that a waveguide 101 comprising a core 109 and a clad 110 is used and a light emitting unit 102 is provided on a light incidence plane 103 in the waveguide 101 in which a light emitting plane 104 is smaller than the light incidence plane 103 as shown in FIG. 14. Moreover, the light emitting unit 102 is formed on the light incidence plane 103 opposed to the light emitting plane 104 in the waveguide 101. By such a structure, it is possible to easily implement an illuminating device for giving a good light by the waveguide light source in which a light emitted from the light emitting unit 102 having a large light emitting area is narrowed. Consequently, it is possible to freely use an element having a problem of a lifetime or an element which does not give a high luminance, for example, an organic electroluminescence element. The components and forming method of the waveguide 101 can be properly selected and used from the components and forming method described above and well-known materials in order not to hinder a light emission from the light emitting unit 102.

While the structure of the waveguide comprising the core 109 and the clad 110 has been described in the embodiment, moreover, it is not particularly restricted thereto as described above but a structure comprising only the core 109 may be used. In this case, a light shielding layer or a reflecting layer is always formed between adjacent pixels in order to carry out excellent exposure.

As described above, according to the embodiment, it is possible to implement an exposing device having a great brightness which can reduce a burden to the light emitting unit 102 by using the waveguide light source in which the light emitting plane 104 is smaller than the light incidence plane 103.

The exposing device according to the embodiment can be used as an exposing device of a recording apparatus using an electrophotographic method such as a printer or a copying machine.

(Fourth Embodiment)

Next, description will be given to a recording apparatus using an electrophotographic method which utilizes the waveguide light source according to the invention.

In FIG. 16, an exposing device 115 is the same as the exposing device described in the art according to the third embodiment, and furthermore, 116 denotes a charging device to be charging means, 117 denotes a developing device to be toner sticking means, 118 denotes a transfer device to be toner transfer means, 119 denotes a fixing device to be fixing means, and 120 denotes a cleaner to be cleaning means.

As described above, according to the embodiment, the exposing device 115 using a light source having a great brightness which does not impose a burden on an element is utilized. Therefore, the amount of a light on a photosensitive member can be increased and high-speed printing can easily be implemented. In the case in which an organic electroluminescence element which can be formed at a simple step is used as a light source, particularly, it is possible to implement a small-sized and inexpensive recording apparatus. In the case in which a full color electrophotographic type printer provided with a plurality of image forming apparatuses is to be implemented, particularly, it is possible to implement a small-sized full color electrophotographic type printer by using a small-sized image forming apparatus according to the embodiment.

### EXAMPLES

### Example 1

By a sputtering apparatus decompressed to a degree of vacuum of 2×10⁻⁶ Torr or less, transparent SiO₂ and SiON films having thicknesses of 2 μm and 8 μm respectively were alternately provided over a transparent substrate formed by a glass using a sputtering method and were then cut out to be trapezoid-shaped. Thus, an almost trapezoidal waveguide was formed.

Next, an optical bonding agent having an equal refractive index to that of the SiON film was applied onto the surface of an inorganic LED comprising GaAs and AlGaAs arranged in the same pattern as the waveguide, and a light emitting section and the waveguide were then arranged to be placed in the same position and were pressed and stuck.

### Example 2

By a sputtering apparatus decompressed to a degree of vacuum of 2×10⁻⁶ Torr or less, transparent SiO₂ and ITO films having thicknesses of 2 μm and 8 μm respectively were alternately formed over a transparent substrate formed by a glass using a sputtering method and were then cut out to take a shape coupling a trapezoid to a triangle. Thus, an anode was formed on a core layer, and furthermore, a waveguide provided with a light angle converting surface was formed in the direction of the normal of a light incidence plane.

Next, the patterning substrate was subjected to a cleaning treatment in order of cleaning with a cleaning agent (SEMICO CLEAN manufactured by FURUUCHI Chemical Co., Ltd.), cleaning with pure water and cleaning with pure water at 5° C., and water stuck to the substrate was then removed by means of a nitrogen blower, and furthermore, the same substrate was heated and dried.

Subsequently, TPD was formed in a thickness of approximately 50 nm as a hole transporting layer on a surface at an anode side in a resistance heating evaporation apparatus decompressed to have a degree of vacuum of 2×10⁻⁶ Torr or less.

Then, Alq₃ was formed in a thickness of approximately 60 nm as a light emitting layer on the hole transporting layer in the resistance heating evaporation apparatus in the same manner. Both the TPD and the Alq₃ had an evaporation speed of 0.2 nm/s.

Thereafter, a cathode was formed in a thickness of 150 nm on a light emitting layer by using, as an evaporation source, an Al—Li alloy containing 15 at % of Li in the resistance heating evaporation apparatus in the same manner.

### Comparative Example

An ITO film having a thickness of 160 nm was formed on a transparent substrate comprising a glass and a resist material was then applied onto the ITO film by a spin coating method to form a resist film having a thickness of 10 μm, and masking, exposure and development were carried out to etch the ITO so that an anode having a width of 10 μm was formed.

Next, a resist film was applied in a thickness of 3 μm onto the surface of the substrate provided with the anode and patterning was then carried out in such a configuration as to remove the resist in a width of 10 μm in a perpendicular crossing direction to the anode so that a patterning substrate provided with an anode of 10 μm square was obtained.

Subsequently, the patterning substrate was subjected to a cleaning treatment in order of ultrasonic cleaning for 5 minutes with a cleaning agent (SEMICO CLEAN manufactured by FURUUCHI Chemical Co., Ltd.), ultrasonic cleaning for 10 minutes with pure water, ultrasonic cleaning for 5 minutes with a solution mixing aqueous hydrogen peroxide and water in a ratio of 1 to 5 for 1 of aqueous ammonia (volume ratio) and ultrasonic cleaning for 5 minutes with pure water at 70° C., and water stuck to the substrate was then removed by means of a nitrogen blower, and furthermore, the same substrate was heated and dried.

Subsequently, the patterning substrate was cleaned in the same manner, and TPD was then formed in a thickness of approximately 50 nm as a hole transporting layer on a surface at an anode side in a resistance heating evaporation apparatus decompressed to have a degree of vacuum of 2×10⁻⁶ Torr or less.

Thereafter, Alq₃ was formed in a thickness of approximately 60 nm as a light emitting layer on the hole transporting layer in the resistance heating evaporation apparatus in the same manner. Both the TPD and the Alq₃ had an evaporation speed of 0.2 nm/s.

Next, a cathode was formed in a thickness of 150 nm on a light emitting layer by using, as an evaporation source, an Al—Li alloy containing 15 at % of Li in the resistance heating evaporation apparatus in the same manner.

TABLE 2

| | | Amount of emitted |
|---|---|---|
| | Size of element | light |
| Example 1 | ∘ | ⊚ |
| Example 2 | ⊚ | ⊚ |
| Comparative example | Δ | Δ |

Description will be given to an evaluating method in an evaluation item in the (Table 2) and an evaluation criterion thereof.

Referring to the size of an element, the size of a light source including a waveguide was evaluated. The evaluation was carried out in three stages of ⊚, ◯ and Δ. For the waveguide light source according to the comparative example, the evaluation criterion represents ⊚: excellent, ◯: good and Δ: permissible.

Referring to the amount of an emitted light, moreover, the amount of a light emitted from a light source was evaluated. The evaluation was carried out in three stages of ⊚, ◯ and Δ. For the amount of a light according to the comparative example, the evaluation criterion represents ⊚: excellent, ◯: good and Δ: permissible.

A first aspect of the invention is directed to a light source comprising at least a light emitting unit including a light emitting layer for electrically emitting a light, and a waveguide for receiving a light irradiated from the light emitting unit onto a light incidence plane and emitting the light into air from a light emitting plane formed on a surface other than the light incidence plane, wherein the waveguide has an area of the light emitting plane which is smaller than that of the light incidence plane, and has a size decreased gradually from the light incidence plane toward the light emitting plane. A light irradiated from the light emitting unit is incident from the light incidence plane and is emitted from the light emitting plane with a reduction. Therefore, it is possible to implement a light source having a great brightness which does not impose a burden on the light emitting plane.

A second aspect of the invention is directed to the light source according to the first aspect of the invention, wherein the waveguide has an almost trapezoidal section. A light irradiated from the light emitting unit is incident from the light incidence plane and is emitted from the light emitting plane with a reduction. Therefore, it is possible to implement a light source having a great brightness which does not impose a burden on the light emitting plane. Furthermore, the waveguide having such a function can easily be formed in a simple shape.

A third aspect of the invention is directed to the light source according to the first or second aspect of the invention, wherein the waveguide is formed with an emitting angle converting structure capable of increasing a light emitting angle on the light emitting plane. A light irradiated from the light emitting unit is incident from the light incidence plane and is emitted from the light emitting plane with a reduction. Therefore, it is possible to implement a light source having a great brightness which does not impose a burden on the light emitting plane. By the light emitting angle converting structure, moreover, it is possible to intensify a light in a front direction. Consequently, it is possible to implement a light source having a large light amount in the front direction which is suitable for various uses.

A fourth aspect of the invention is directed to the light source according to any of the first to third aspects of the invention, wherein the emitting angle converting structure is of a mesa type in which a section is continuously enlarged with respect to the light emitting plane. A light irradiated from the light emitting unit is incident from the light incidence plane and is emitted from the light emitting plane with a reduction. Therefore, it is possible to implement a light source having a great brightness which does not impose a burden on the light emitting plane. By the mesa type structure, moreover, it is possible to easily implement a light emitting angle converting structure having this function.

A fifth aspect of the invention is directed to the light source according to any of the first to fourth aspects of the invention, wherein the emitting angle converting structure is a lens formed on the light emitting plane. A light irradiated from the light emitting unit is incident from the light incidence plane and is emitted from the light emitting plane with a reduction. Therefore, it is possible to implement a light source having a great brightness which does not impose a burden on the light emitting plane. By the lens, moreover, it is possible to easily implement a light emitting angle converting structure having this function.

A sixth aspect of the invention is directed to the light source according to any of the first to fifth aspects of the invention, wherein the waveguide forms a propagation angle converting mechanism for changing a reflecting angle of a light on a surface excluding the light emitting plane. A light irradiated from the light emitting unit is incident from the light incidence plane and is emitted from the light emitting plane with a reduction. Therefore, it is possible to implement a light source having a great brightness which does not impose a burden on the light emitting plane. Moreover, an efficient light propagation is carried out by the propagation angle converting structure. Consequently, an efficient light source having a great brightness can be arranged freely.

A seventh aspect of the invention is directed to the light source according to any of the first to sixth aspects of the invention, wherein the propagation angle converting structure is saw-toothed. Alight irradiated from the light emitting unit is incident from the light incidence plane and is emitted from the light emitting plane with a reduction. Therefore, it is possible to implement a light source having a great brightness which does not impose a burden on the light emitting plane. Moreover, an efficient light propagation is carried out by the propagation angle converting structure. Consequently, an efficient light source having a great brightness can be arranged freely, and a propagation angle converting structure having this function can easily be implemented by the saw-toothed structure.

An eighth aspect of the invention is directed to the light source according to any of the first to seventh aspects of the invention, wherein the light emitting unit is constituted by an organic electroluminescence element including at least an anode for injecting a hole, a light emitting layer having a light emitting region and a cathode for injecting an electron. A light irradiated from the light emitting unit is incident from the light incidence plane and is emitted from the light emitting plane with a reduction. Therefore, it is possible to implement a light source having a great brightness which does not impose a burden on the light emitting plane. By the structure in which the burden imposed on the light emitting plane is lessened, moreover, it is possible to implement a light source using the organic electroluminescence element as the light emitting unit.

A ninth aspect of the invention is directed to the light source according to any of the first to eighth aspects of the invention, wherein the waveguide is constituted by a core having a predetermined refractive index, and a clad formed on an outer periphery of the core and having a lower refractive index than that of the core. A light irradiated from the light emitting unit is incident from the light incidence plane and is emitted from the light emitting plane with a reduction. Therefore, it is possible to implement a light source having a great brightness which does not impose a burden on the light emitting plane. Since the core is covered with the clad, moreover, it is possible to propagate a stable light having less influence of a refuse in an external part.

A tenth aspect of the invention is directed to the light source according to any of the first to ninth aspects of the invention, wherein the waveguide has a periphery covered with a reflecting plane. A light irradiated from the light emitting unit is incident from the light incidence plane and is emitted from the light emitting plane with a reduction. Therefore, it is possible to implement a light source having a great brightness which does not impose a burden on the light emitting plane. Since the waveguide is covered with the reflecting plane, moreover, it is possible to propagate a stable light having less influence of a refuse in an external part and to prevent a light from being emitted as a wasted light to an outside, and furthermore, to utilize the light as an effective light. Thus, an efficient light propagation can be carried out.

An eleventh aspect of the invention is directed to the light source according to any of the first to tenth aspects of the invention, wherein the light emitting unit is provided with an air layer interposed together with the light incidence plane. A light irradiated from the light emitting unit is incident from the light incidence plane and is emitted from the light emitting plane with a reduction. Therefore, it is possible to implement a light source having a great brightness which does not impose a burden on the light emitting plane. Furthermore, the angle of the light incident in the waveguide can be increased by a simple method. Thus, an efficient light propagation can be carried out.

A twelfth aspect of the invention is directed to the light source according to any of the first to eleventh aspects of the invention, wherein the light emitting unit is formed with an emitting angle converting structure on a light emitting plane. A light irradiated from the light emitting unit is incident from the light incidence plane and is emitted from the light emitting plane with a reduction. Therefore, it is possible to implement a light source having a great brightness which does not impose a burden on the light emitting plane. Furthermore, the light having a great angle on the light incidence plane is incident. Thus, an efficient light propagation can be carried out.

A thirteenth aspect of the invention is directed to the light source according to any of the first to twelfth aspects of the invention, wherein the light emitting plane is formed on a surface other than an opposed surface to the light incidence plane. A light irradiated from the light emitting unit is incident from the light incidence plane and is emitted from the light emitting plane with a reduction. Therefore, it is possible to implement a light source having a great brightness which does not impose a burden on the light emitting plane. Moreover, the light emitting unit can be arranged freely. Consequently, it is possible to implement a small-sized light source having a great brightness.

A fourteenth aspect of the invention is directed to the light source according to any of the first to thirteenth aspects of the invention, wherein the waveguide has such a shape that a waveguide structure having an almost trapezoidal section and a waveguide structure having a triangular section are coupled to each other. A light irradiated from the light emitting unit is incident from the light incidence plane and is emitted from the light emitting plane with a reduction. Therefore, it is possible to implement a light source having a great brightness which does not impose a burden on the light emitting plane. Moreover, the light emitting unit can be arranged freely. Consequently, it is possible to implement a small-sized light source having a great brightness.

A fifteenth aspect of the invention is directed to an optical printer head comprising at least an exposing device having a plurality of light emitting units arranged in a line which can emit a signal light corresponding to a data signal, and a photosensitive member capable of forming an optional latent image by irradiation of the signal light, wherein the exposing device is constituted by the light source according to any of the first to fourteenth aspects of the invention. A light source having a great brightness can be used. Consequently, it is possible to easily implement an exposing device having a great brightness.

A sixteenth aspect of the invention is directed to the exposing device according to the fifteenth aspect of the invention, wherein a plurality of waveguides divided optically in a main scanning direction for each pixel is arranged in parallel with each other. Since a light source having a great brightness can be used, it is possible to easily implement an exposing device having a great brightness. By the waveguide divided optically, furthermore, it is possible to implement an exposing device having no cross talk of a light.

A seventeenth aspect of the invention is directed to the exposing device according to the fifteenth or sixteenth aspect of the invention, wherein the waveguide is not provided with a light shielding layer between substrates which are adjacent to each other. Since a light source having a great brightness can be used, it is possible to easily implement an exposing device having a great brightness. By the simple structure in which the light shielding layer is not provided, furthermore, it is possible to implement an inexpensive exposing device having no cross talk of a light.

An eighteenth aspect of the invention is directed to the exposing device according to anyof the fifteenth to seventeenth aspects of the invention, wherein the waveguide is provided with light amount transmitting means for forming an erected equal magnification image together with a light emitting plane on an outside thereof. Since a light source having a great brightness can be used, it is possible to easily implement an exposing device having a great brightness. By the simple structure, furthermore, it is possible to easily implement an exposing device having a high resolution.

A nineteenth aspect of the invention is directed to an image forming apparatus comprising at least a photosensitive member capable of forming an electrostatic latent image, charging means for forming a uniform electric potential on a surface of the photosensitive member by discharging means, exposing means for irradiating a signal light corresponding to an image signal, thereby forming a latent image, toner sticking means for sticking a toner onto a surface on which the latent image is formed, toner transferring means for transferring a toner onto a transfer material, and control means for controlling each portion, wherein a recording apparatus uses, as the exposing means, the exposing device according to any of the fifteenth to eighteenth aspects of the invention. It is possible to use an exposing device having a great brightness and a high resolution. Consequently, it is possible to easily implement a recording apparatus having a high performance.

### Third Mode of Embodiment

Embodiments of the invention will be explained in reference to FIG. 17 through FIG. 24 as follows. Further, in the drawings, the same members are attached with the same notations and a duplicated explanation thereof will be omitted.

FIG. 17 is an outline view showing a constitution of a color image forming apparatus according to Embodiment of the invention, FIG. 18 is an explanatory view showing in details an exposing portion of the color image forming apparatus of FIG. 17, FIG. 19 is an explanatory view showing in details a photosensitive portion of the color image forming apparatus of FIG. 17, FIG. 20 is an explanatory view showing in details a developing portion of the color image forming apparatus of FIG. 17, FIG. 21 is a perspective view showing an essential portion of an organic electroluminescence element used as a light source of the exposing portion of FIG. 18, FIG. 22 is a sectional view showing the organic electroluminescence element used as the light source of the exposing portion of FIG. 18, FIG. 23 is a plane view showing the organic electroluminescence element used as the light source of the exposing portion of FIG. 18, FIG. 24 is a sectional view showing an organic electroluminescence element as a modified example used as a light source of the exposing portion of FIG. 18 and FIG. 25 is a sectional view showing an organic electroluminescence element as other modified example used as a light source of the exposing portion of FIG. 18.

In FIG. 17, a color image forming apparatus 201 is successively arranged with developing portion 202, 203, 204, 205 for respectively forming toner images of respective colors of yellow (Y), magenta (M), cyan (C) and black (K) and includes exposing portions (exposing means) 206, 207, 208, 209 and photosensitive portions 210, 211, 212, 213 in correspondence with respectives of the developing portions 202 through 205.

As shown by FIG. 18, the exposing portions 206 through 209 include head support members 206a through 209a, organic electroluminescence elements 206d through 209d as light sources constituting an exposure head mounted to base members 206b through 209b and sealed in air tight by sealing members 206c through 209c provided above the head support members 206a through 209a, and drivers 206e through 209e provided above the base members 206b through 209b for supplying voltages in correspondence with image data to the organic electroluminescence elements 206d through 209d to be luminescent. Further, substrates (waveguides) 231 for collecting light are mounted above the base members 206b through 209b and fiber arrays 206g through 209g are provided outside of a light output surface.

As shown in FIG. 19 in details, the photosensitive portions 210 through 213 include photosensitive drums (photosensitive members) 210a through 213a as image carriers provided rotatably, chargers (charging means) 210b through 213b brought into press contact with the photosensitive drums 210a through 213a for charging surfaces of the photosensitive drums 210a through 213a to uniform potentials and cleaners 210c through 213c for removing a toner remaining at the photosensitive drums 210a through 213a after transcribing images.

The photosensitive drums 210a through 213a rotated in peripheral directions are arranged in one column such that rotation center axes thereof are in parallel with each other. Further, the chargers 210b through 213b brought into press contact with the photosensitive drums 210a through 213a are rotated in accordance with rotation of the photosensitive drums 210a through 213a.

Further, as shown in FIG. 20 in details, the developing portions 202 through 205 include developing rollers (developing means) 202a through 205a for adhering toners to the photosensitive drums 210a through 213a formed with electrostatic latent images at peripheral faces thereof by irradiated light from the exposing portions 206 through 209 to manifest the electrostatic latent images as toner images, stirring members 202b through 205b for stirring a toner 214 in tanks, supply rollers 202c through 205c for supplying the toner 214 to the developing rollers 202a through 205a while stirring the toner 214 and doctor blades 202d through 205d for regulating the toner 214 supplied to the developing rollers 202a through 205a to predetermined thicknesses and charging the toner 214 by friction.

As shown by FIG. 17, a transcribing portion 215 for forming a color toner image by transcribing toner images of respective colors manifested on the photosensitive drums 210a through 213a on sheet (record medium) P to overlap each other is arranged at a position opposed to the exposing portions 6 through 9, the photosensitive portions 210 through 213 and the developing portions 202 through 205.

The transcribing portion 215 includes transcribing rollers 216 through 219 and springs 220 through 223 for respectively bringing the respective transcribing rollers 216 through 219 into press contact with the photosensitive drums 210a through 213a.

A sheet feeding portion 224 contained with sheet P is provided on a side opposed to the transcribing portion 215. Further, the sheet P is taken out from the sheet feeding portion 224 sheet by sheet by a sheet feeding roller 225.

A resist roller 226 for feeding the sheet P to the transcribing portion 215 at predetermined timings is provided on a sheet transporting path reaching the transcribing portion 215 from the sheet feeding portion 224. Further, a fixing portion 227 is arranged on a sheet transporting path on which the sheet P formed with the color toner image by the transcribing portion 215 travels.

The fixing portion 227 is provided with a heating roller 227a and a pressing roller 227b brought into press contact with the heating roller 227a and a color image transcribed on the paper P is fixed on the sheet P by pressure and heat accompanied by rotating the rollers 227a and 227b to pinch the sheet P.

In the image forming apparatus having such a constitution, first, a latent image having a yellow component color of image information is formed on the photosensitive drum 210a. The latent image is visualized on the photosensitive drum 210a as a yellow toner image by the developing roller 202a having a yellow toner. During the time period, the sheet P taken out from the sheet feeding portion 224 by the sheet feeding roller 225 is transmitted to the transcribing portion 215 by taking a timing by the resist roller 226. Further, the sheet P is pinched by the photosensitive drum 210 and the transcribing roller 216 to transport and at this occasion, the above-described yellow toner image is transcribed from the photosensitive drum 210a.

During a time period in which the yellow toner image is being transcribed on the sheet P, successively, a latent image having a magenta component color is formed and a magenta toner image by a magenta toner is visualized by the developing roller 203a. Further, the magenta toner image is transcribed on the sheet P transcribed with the yellow toner image to overlap the yellow toner image.

In the following, image formation and transcription are carried out similarly with regard to a cyan toner image and a black toner image and four colors of toner images finish to overlap on the sheet P.

Thereafter, the sheet P formed with the color image is transported to the fixing portion 227. At the fixing portion 227, the transcribed toner images are heated to fix on the sheet P and a full color image is formed on the sheet P.

The sheet P finished with a series of color image formation in this way is thereafter discharged onto a discharging tray 228.

In reference to FIGS. 21 and 22, each of the organic electroluminescence elements 206d through 209d constituting light sources provided at the exposing portions 206 through 209, is formed with an anode 232 comprising a transparent conductive film formed by a sputtering method, a resistance heating evaporation deposit method or the like for injecting holes and a cathode 233 which is an electrode formed by the resistance heating evaporation deposit method or the like for injecting electrons on a board 231. Further, a luminescent layer 234 having a luminescent region is formed between the anode 232 and a cathode 233.

When direct current voltage or direct current is applied by constituting a plus electrode by the anode 232 of each of the organic electroluminescence elements 206d through 209d having the above-described constitution and constituting a minus electrode by the anode 233, the luminescent layer 234 is injected with holes from the anode 232 and injected with electrons from the cathode 233. At the luminescent layer 234, holes and electrons injected in this way are recombined and when excitons formed in accordance therewith are shifted from the excited state to the ground state, a luminescence phenomenon is brought about.

In the organic electroluminescence elements 206d through 209d, light irradiated from a fluorescent member (not illustrated) constituting the luminescent region in the luminescent layer 234 is emitted centering on the fluorescent member and irradiated via the board 231. Or, temporarily, light is reflected by the cathode 233 in a direction reverse to a direction of taking out light (direction of board 231) and is irradiated via the board 231.

Next, an explanation will be given of respective members constituting the organic electroluminescence elements.

As the board 231 of each of the organic electroluminescence elements 206d through 209d according to the invention, a board which is transparent or semitransparent or opaque when the board is not used as a face for taking out light can be used and the board may be provided with strength capable of holding each of the organic electroluminescence elements 206d through 209d.

Further, according to the invention, in defining transparent or semitransparent, the definition indicates transparency to a degree of not hindering optical recognition of light emittance by the organic electroluminescence elements 206d through 209d. Because details have been explained above, it is omitted here. Further, depending on use thereof, the board may be of a material for transmitting only a specific wavelength, a material having a light-light conversion function for converting to light having a specific wavelength or the like. Further, although it is preferable that the board is insulating, the board is not particularly limited thereto and may be conductive within a range of not hindering an organic electroluminescence display element from being driven or depending on use thereof. Or, the wave guide may be formed by a wave guide aligned with a plurality of pieces of portions thereof optically isolated in a main scanning direction for respective pixels in parallel with each other, or may be constructed by a structure in which a core portion of the wave guide is provided with conductivity and the clad is provided with insulating performance and a plurality of pieces of core portions isolated electrically can also be used as cathodes or cathodes.

According to the embodiment, the board 231 forms a wave guide in which a plurality of pieces of portions thereof optically isolated in a main scanning direction for respective pixels are aligned in parallel with each other. Further, the board 231 is constituted by the core 231a having a predetermined refractive index and the clad 231b formed at the surrounding of the core 231a and having a refractive index smaller than that of the core 231a. Further, the clad 231b may be formed at an entire face of an outer periphery of the core 231a or may be formed at a face of a portion of the outer periphery.

Further, the refractive index of the core 231a can be provided with a refractive index smaller than that of the luminescent layer or can be set to be larger than a value constituted by subtracting 0.3 from the refractive index of the luminescent layer.

Further, although according to the embodiment, the board 231 is constituted by a wave guide having a section of a square having a side of 8 μm and a pitch of about 10.5 μm and is constituted to correspond to a resolution of 2400 dpi, an arbitrary shape can be adopted for the sectional shape so far as a predetermined latent image can be formed on a photosensitive member and the pitch and the shape can pertinently be constituted in accordance with a printing condition of the resolution, a rotational number of the photosensitive member or the like.

Further, although here, an explanation has been given of a structure using the wave guide as the board, there may be constructed a constitution of separately fabricating the organic electroluminescence element and the wave guide and in this case, the organic electroluminescence element and the wave guide are connected by an optical adhering agent or the like. In this case, when an air layer is present between the organic electroluminescence element and the wave guide, light propagated in the wave guide is reduced by total reflection and therefore, efficient propagation of light is not carried out. Therefore, when the organic electroluminescence element and the wave guide are separately fabricated, it is preferable to connect these such that the air layer is not interposed therebetween.

Here, as described above, at the organic electroluminescence elements 206d through 209d, light irradiated from the luminescent layer is irradiated by way of an opposed face of the board 231 and when light passes a boundary face of respective media, in the case in which a refractive index of a medium on an incident side is larger than a refractive index on an emitting side, light incident thereon by an angle larger than a critical angle which is an angle by which an angle of emittance of a refracted wave becomes 90°, cannot pass the boundary face and is totally reflected by the boundary face between the media.

Therefore, in each of the organic electroluminescence elements 206d through 209d at which light is irradiated isotropically, light irradiated by an angle larger than the critical angle advances by repeating total reflection by the boundary face of the wave guide in the board 231, particularly, according to the embodiment, as shown by FIG. 23, advances by repeating total reflection in the core 231a surrounded by the clad 231b of the board 231 to reach an end face in a sub scanning direction.

Hence, according to the embodiment, attention is paid to the point, the end face in the sub scanning direction of the board 231 is made to constitute a light taking out face 235 and light emitted from the light taking out face 235 is used as exposing light.

That is, the larger the area of the luminescent layer, the larger the amount of light advancing in the board 231 and therefore, a light amount of light reaching the light taking out face 235 constituting the end face in the sub scanning direction of the board 231 is increased. That is, when the exposing light is constituted by the light from the light taking out face 235 which is the end face in the sub scanning direction of the board 231, by only enlarging the area of the luminescent layer 234, the amount of luminescent light is increased and therefore, the luminescent light amount necessary for exposure can be provided by increasing applied current without shortening element life of the organic electroluminescence elements 206d through 209d.

That is, according to the invention, the exposure light is constituted by the light from the light taking out face 235 which is the end face of the wave guide 229. Although according to the embodiment, the board and the wave guide are integrated in this way, the wave guide may separately be formed independently from the board.

Further, according to an image forming apparatus using such an exposing apparatus, the electrostatic latent image can properly be formed on each of the photosensitive drums 210a through 213a and therefore, an image of high quality can be formed.

Particularly, according to the embodiment, the board 231 which is a wave guiding path is constituted by the core 231a and the clad 231b and therefore, light irradiated from the luminescent layer 234 is further efficiently be guided to the light taking out face 235 and a further increase in the luminescent light amount can be achieved. However, there may not be constituted such a two-layer structure of the core 231a and the clad 231b.

Here, a light shielding layer or a reflecting layer can be provided between the boards 231 contiguous to each other. When the light shielding layer or the reflecting layer is provided, light is not incident on a certain one of the board 231 from other of the boards 231 and therefore, there is not a dispersion in the light amount taken out from the light taking out face 235 among the boards. Further, particularly when the reflecting layer is provided, light incident on the boards 231 from the luminescent layer is more reflected to reach the light taking out face 235 and therefore, an increase in the light amount can be achieved.

Further, although the shape of the light taking out face 235 can be constituted, for example, by a rectangular shape or a hexagonal shape or the like, it is preferable to constitute the shape in correspondence with a shape of a pixel. Further, when the board 231 is constituted by the core 231a and the clad 231b, the light taking out face 35 becomes a face constituted by the core 231a and the clad 231b.

As shown by FIG. 24, the board 231 constituting the wave guide can be formed with an angle converting portion 236 for converting an angle of light incident on the board 231 from the luminescent layer 234 to guide to the light taking out face 235. When the angle converting portion 236 is formed, a further increase in the amount of light taken out from the light taking out face 235 can be achieved. Here, although in the illustrated case, the angle converting portion 236 is constituted by a scattering face formed with a number of semispherical bodies at a face of the board 231 on a side opposed to the luminescent layer 234, the angle converting portion 236 can be constituted by various shapes of a face of recesses and projections, a shape of semicircular cylinders uniform in the main scanning direction or a face of recesses ad projections in a sawtooth shape and by providing the angle converting portion 236 aligned with a plurality of one-dimensional shapes in parallel, the angle can be converted to a specific angle. Further, it is preferable that the angle converting portion 236 is not accompanied by angle conversion to the main scanning direction in order to guide light in a direction other than the sub scanning direction to the light taking out face 235. Particularly when there is provided the angle converting portion 236 for carrying out angle conversion to a direction orthogonal to both of main scanning and sub scanning (direction perpendicular to the luminescent layer)., light which is wasted when the angle converging portion 236 is not provided can be guided to the light taking out face 235 without hampering advancement of light in the sub scanning direction and therefore, the constitution is effective. Further, when the board 231 is constituted by the core 231a and the clad 231b, by forming the angle converting portion 236 at the interface between the core 231a disposed on a side opposed to the light emitting layer 232 and the clad 231b, angle conversion by the angle converting portion 236 can be carried out while effectively utilizing an effect of total reflection at the interface between the core 231a and the clad 231b.

Further, in the board 231, the reflecting layer can be formed at a face opposed to the light taking out face 235 or a face disposed on a side opposed to the luminescent layer 234. When the reflecting layer is provided, light incident on the board 231 from the luminescent layer 232 is more reflected to reach the light taking out face 235 and therefore, an increase in the light amount can be achieved. Further, the reflecting layer may be formed only at either face of the face opposed to the light taking out face 235 and the face disposed on the side opposed to the luminescent layer 234.

Further, the light taking out face 235 of the wave guide 229 can be formed with a lens (diffusion restricting means) for narrowing an angle of diffusing light emitted from the light taking out face 235 or constituting parallel light from the light, that is, restraining diffusion of light. Further, in a diversion restraining means, other than a curved face lens of a convex lens or a concave lens, there is a lens of an iron doping type or a UV modifying type in a slit-like shape, a mesa structure utilizing total reflection as shown by FIG. 25, or a taper reflection structure arranged with a mirror face at a position equivalent to that of a total reflection face of the mesa structure. Further, the lens can restrain diffusion of light by an integrated lens such as a structure of forming lenses to individual ones of the light taking out faces 235 one by one, a structure formed with a plurality of lenses to a single one of the light taking face 235, or a structure of forming a single lens to a plurality of the light taking out faces 235, or a structure of a single cylindrical lens or a one-dimensional mesa structure for all of the taking out faces.

Further, when the light taking out face 235 of the board 231 and each of the photosensitive drums 210a through 213a are arranged at positions extremely proximate to each other, for example, at a distance equal to or smaller than a diagonal line of a pixel, light emitted from the light taking out face 235 is irradiated to the photosensitive drum without interposing each of fiber lens arrays 206g through 209g. Or, when the light taking out face 235 and each of the photosensitive drums 210a through 213a are arranged at positions remote from each other, light is focused on each of the photosensitive drums 210a through 213a in an erected image at equal magnification by passing each of the fiber lens arrays 206g through 209g.

Although in the above-described explanation, an explanation has been given of case of applying the invention to the color image forming apparatus, the invention is applicable also to an image forming apparatus of single color of black or the like. Further, when the invention is applied to the color image forming apparatus, developed colors are not limited to four colors of yellow, magenta, cyan and black.

The invention described in first aspect of the invention is an exposing apparatus which is an exposing apparatus constituting a light source by an organic electroluminescence element comprising at least an anode for injecting holes, a luminescent layer having a luminescent region and a cathode for injecting electrons above a board, the exposing apparatus including a wave guide an end face in a sub scanning direction of which is made to constitute a light taking out face and light irradiated from the luminescent layer and incident on the wave guide and emitted from the light taking out face is used as exposure light, by constituting exposure light by light emitted from the light taking out face which is the end face in the sub scanning direction of the wave guide, small-sized formation and thin-sized formation of the exposing apparatus can easily be achieved, since light is emitted from a direction of an end face of a luminescent face by the wave guides a luminescent area can easily be enlarged in the sub scanning direction and therefore, a luminescent light amount is increased only by enlarging the area of the luminescent layer and therefore, the invention carries out operation of capable of providing a luminescent light amount necessary for exposure without shortening element life by increasing applied current.

The invention described in second aspect of the invention is the exposing apparatus wherein the wave guide is integrated with a board, and small-sized formation and thin-sized formation of the exposing apparatus can easily be achieved, since light is emitted from the direction of the end face of the luminescent face by the wave guide, the luminescent area can easily be enlarged in the sub scanning direction and therefore, the luminescent light amount is increased only by enlarging the area of the luminescent layer and therefore, the invention carries out operation of capable of providing the luminescent light amount necessary for exposure without shortening element life by increasing applied current. Further, since the wave guide and the board are integrated, the exposing apparatus can further be downsized, a step of pasting the wave guide is dispensed with, positioning of the wave guide is dispensed with and therefore, the invention carries out operation of capable of inexpensively realizing an exposing apparatus capable of providing a stable light amount.

The invention described in third aspect of the invention is the exposing apparatus wherein a plurality of pieces of the wave guides optically isolated in a main scanning direction for respective pixels are aligned in parallel with each other, and small-sized formation and thin-sized formation of the exposing apparatus can easily be achieved. Since light is emitted from the direction of the end face of the luminescent face by the wave guide, the luminescent area can easily be enlarged in the sub scanning direct-ion and therefore, the luminescent-light amount is increased only by enlarging the area of the luminescent layer and therefore, the invention carries out operation of capable of providing the luminescent light amount necessary for exposure without shortening element life by increasing applied current. Further, the wave guides are optically isolated for the respective pixels and can propagate light for the respective pixels and therefore, the luminescent light amount is increased by a unit of the pixel and the invention carries out operation of capable of realizing high image quality having high resolution.

The invention described in fourth aspect of the invention is the exposing apparatus wherein the wave guide is constituted by a core having a predetermined refractive index and a clad formed at an outer periphery of the core and having a refractive index smaller than the refractive index of the core, and small-sized formation and thin-sized formation of the exposing apparatus can easily be achieved, since light is emitted from the direction of the end face of the luminescent face by the wave guide, the luminescent area in the sub scanning direction can easily be enlarged and therefore, light irradiated from the luminescent layer is further efficiently guided to the light taking out face and therefore, the invention carries out operation of capable of achieving a further increase in the luminescent light amount. Further, light propagated in the wave guide can be propagated in the direction of the light taking out face by total reflection at an interface between the core and the clad and therefore, stable propagation of light having small loss can be carried out and the invention carries out operation of capable of carrying out stable light propagation even when dust and dirt is adhered or a defect is brought about on the surface of the clad.

The invention described in firth aspect of the invention is the exposing apparatus wherein the core is provided with a refractive index smaller than a refractive index of the luminescent layer, and small-sized formation and thin-sized formation of the exposing apparatus can easily be achieved, since light is emitted from the direction of the end face of the luminescent face by the wave guide, the luminescent area can easily be enlarged in the sub scanning direction and therefore, light irradiated from the luminescent layer and incident on the wave guide can further efficiently be guide to the light taking out face and therefore, the invention carries out operation of capable of achieving a further increase in the luminescent amount. Further, light irradiated from the luminescent layer is efficiently guided to the light taking out face since light in the sub scanning direction is increased in the wave guide by refraction of light because the refractive index of the wave guide is small and therefore, the invention carries out operation of capable of achieving a further increase in the luminescent light amount.

The invention described in sixth aspect of the invention is the exposing apparatus wherein the refractive index of the core is larger than a value constituted by subtracting 0.3 from the refractive index of the luminescent layer, and small-sized formation and thin-sized formation of the exposing apparatus can easily be achieved, since light is emitted from the direction of the end face of the luminescent face by the wave guide, the luminescent area can easily be enlarged in the sub scanning direction and therefore, light irradiated from the luminescent layer and incident on the wave guide can further efficiently be guided to the light taking out face and therefore, the invention carries out operation of capable of achieving a further increase in the luminescent light amount. Further, light irradiated from the luminescent layer is further efficiently be guided to the light taking out face by restraining total reflection at the interface of the wave guide and therefore, the invention carries out operation of capable of achieving a further increase in the luminescent light amount.

The invention described in seventh aspect of the invention is the exposing apparatus wherein a light shielding layer or a reflecting layer is provided between the wave guides contiguous to each other, light is not incident from other wave guide and therefore, the invention carries out operation of eliminating a dispersion of the light amount taken out from the light taking out face among the wave guides. Particularly when the reflecting layer is provided, light incident on other wave guide and propagated as ineffective light is propagated as effective light and therefore, the light is guided further efficiently to the light taking out face and therefore, the invention carries out operation of capable of achieving a further increase in the luminescent light amount.

The invention described in eighth aspect of the invention is the exposing apparatus wherein the light taking out face is constituted by a shape in correspondence with a shape of a pixel, and small-sized formation and thin-sized formation of the exposing apparatus can easily be achieved, since light is emitted from the direction of the end face of the luminescent face by the wave guide, the luminescent area can easily be enlarged in the sub scanning direction and therefore, the luminescent light amount is increased only by increasing the area of the luminescent layer and therefore, the invention carries out operation of capable of providing the luminescent light amount necessary for exposure without shortening element life by increasing applied current. Further, since the light taking out face is constituted by the shape in correspondence with the shape of the pixel, the invention carries out operation of capable of easily forming a highly fine latent image.

The invention described in ninth aspect of the invention is the exposing apparatus wherein the wave guide is formed with an angle converting portion for converting an angle of light incident on the wave guide from the luminescent layer to guide to the light taking out face, and the invention carries out operation of capable of achieving a further increase in the light amount taken out from the light taking out face.

The invention described in tenth aspect of the invention is the exposing apparatus wherein the angle converting portion guides light in a direction other than the sub scanning direction to the light taking out face, and influence on light which is inherently effectively taken out is inconsiderable, an angle of ineffective light can be converted to effective light and therefore, the invention carries out operation of capable of achieving a further increase in the light amount taken out from the light taking out face.

The invention described in eleventh aspect of the invention is the exposing apparatus wherein the angle converting portion carries out angle conversion with respect to a direction orthogonal to either of main scanning and sub scanning to guide to the light taking out face, and influence on light which is inherently effectively taken out is inconsiderable, the angle of ineffective light can be converted to effective light and therefore, the invention carries out operation capable of achieving a further increase in the light amount taken out from the light taking out face.

The invention described in twelfth aspect of the invention is the exposing apparatus wherein the angle converting portion is formed at an interface between the core and the clad disposed on a side opposed to the luminescent layer, and influence on light which is inherently effectively be taken out is inconsiderable, the angle of ineffective light can be converted to effective light, light subjected to angle conversion is propagated at inside of the core, light propagation having small loss can be realized and therefore, the invention carries out operation of capable of achieving a further increase in the light amount taken out from the light taking out face.

The invention described in thirteenth aspect of the invention is the exposing apparatus wherein a reflecting layer is formed at least at any face of a face opposed to the light taking out face and a face of the wave guide disposed on a side opposed to the luminescent layer, and light incident on the wave guide from the luminescent layer is more reflected, ineffective light reaches the light taking out face as effective light and therefore, the invention carries out operation of capable of achieving to increase the light amount.

The invention described in fourteenth aspect of the invention is the exposing apparatus wherein the light taking out face is formed with diffusion restraining means for restraining diffusion of light emitted from the light taking out face, and small-sized formation and thin-sized formation of the exposing apparatus can easily be achieved, since light is emitted from the direction of the end face of the luminescent face by the wave guide, the luminescent area can easily be enlarged in the sub scanning direction and therefore, the luminescent light amount is increased only by enlarging the area of the luminescent layer and therefore, the invention carries out operation of capable of providing the luminescent amount necessary for exposure without shortening element life by increasing applied current. Further, by the diffusion restraining means of light, light emitted from the light taking out face strongly advances in a front direction and therefore, light emitted from the light taking out face can further efficiently be utilized for exposure and therefore, the invention carries out operation of capable of realizing the exposing apparatus having an excellent efficiency.

The invention described in fifteenth aspect of the invention is the exposing apparatus wherein light emitted from the light taking out face is focused on a photosensitive member in an erected image at equal magnification, and small-sized formation and thin-sized formation of the exposing apparatus can easily be achieved, since light is emitted from the direction of the end face of the luminescent face by the wave guide, the luminescent area can easily be enlarge in the sub scanning direction and therefore, the luminescent light amount is increased only by enlarging the area of the luminescent layer and therefore, the invention carries out operation of capable of providing the luminescent light amount necessary for exposure without shortening element life by increasing applied current. Further, light emitted from the light taking out face can further efficiently be utilized for exposure by a simple constitution and therefore, the invention carries out operation of capable of inexpensively realizing the exposing apparatus having an excellent efficiency.

The invention described in sixteenth aspect of the invention is an image forming apparatus including the exposing apparatus, and a photosensitive member formed with an electrostatic latent image by the exposing apparatus and the electrostatic latent image is properly formed on the photosensitive member and therefore, the invention carries out operation of capable of forming a high quality image.

### Fourth Mode of Embodiments

(Embodiment 1)

Embodiments of the invention will be explained in reference to FIG. 26 through FIG. 33 as follows. Further, in these drawings, the same members are attached with the same notations and a duplicated explanation thereof will be omitted.

FIG. 26 is an outline view showing a constitution of a color image forming apparatus according to Embodiment 1 of the invention, FIG. 27 is an explanatory view showing in details an exposing portion in the color image forming apparatus, FIG. 28 is an explanatory view showing in details a photosensitive portion in the color image forming apparatus of FIG. 26, FIG. 29 is an explanatory view showing in details a developing portion in the color image forming apparatus of FIG. 26, FIG. 30 is a sectional view showing an essential portion of an organic electroluminescence element used as a light source of the exposing portion of FIG. 27, FIG. 31 is a perspective view showing the organic electroluminescence element used as the light source of the exposing portion of FIG. 27, FIG. 32 is a plane view showing the organic electroluminescence element used as the light source of the exposing portion of FIG. 27, FIG. 33 is a sectional view showing a modified example of an organic electroluminescence element used as the light source of the exposing portion of FIG. 27 and FIG. 34 is a sectional view showing an organic electroluminescence element as other modified example used as the light source of the exposing portion of FIG. 27.

In FIG. 26, a color image forming apparatus 301 is successively arranged with developing portion 302, 303, 304, 305 for respectively forming toner images of respective colors of yellow (Y), magenta (M), cyan (C) and black (K) and includes exposing portions (exposing means) 306, 307, 308, 309 and photosensitive portions 310, 311, 312, 313 in correspondence with respectives of the developing portions 302 through 305.

As shown by FIG. 27, the exposing portions 306 through 309 include head support members 306a through 309a, organic electroluminescence elements 306b through 309b as light sources constituting an exposure head mounted to base members 306a through 309a, and drivers 306c through 309c provided above the base members 306a through 309a for supplying voltages in correspondence with image data to the organic electroluminescence elements 306b through 309b to be luminescent. In order to shield the organic electroluminescence elements 306b through 309b, on the boards 306a through 309a, the elements may be sealed in air tight by sealing members 306d, 307d, 308d, 309d, or drying agents 306e, 307e, 308e, 309e may be arranged in the sealing members to adsorb moisture in the sealing members. Image transmitting optical systems 306f, 307f, 308f, 309f are arranged at outsides of faces of the organic electroluminescence elements 306b through 309b for taking out light.

As shown in FIG. 28 in details, the photosensitive portions 310 through 313 include photosensitive drums (photosensitive members) 310a through 313a as image carriers provided rotatably, chargers (charging means) 310b through 313b brought into press contact with the photosensitive drums 310a through 313a for charging surfaces of the photosensitive drums 310a through 313a to uniform potentials and cleaners 310c through 313c for removing a toner remaining at the photosensitive drums 310a through 313a after transcribing images.

The photosensitive drums 310a through 313a rotated in peripheral directions are arranged in one column such that rotation center axes thereof are in parallel with each other. Further, the chargers 310b through 313b brought into press contact with the photosensitive drums 310a through 313a are rotated in accordance with rotation of the photosensitive drums 310a through 313a.

Further, as shown in FIG. 29 in details, the developing portions 302 through 305 include developing rollers (developing means) 302a through 305a for adhering toners to the photosensitive drums 310a through 313a formed with electrostatic latent images at peripheral faces thereof by irradiated light from the exposing portions 306 through 309 to manifest the electrostatic latent images as toner images, stirring members 302b through 305b for stirring a toner 314 in tanks, supply rollers 302c through 305c for supplying the toner 314 to the developing rollers 302a through 305a while stirring the toner 314 and doctor blades 302d through 305d for regulating the toner 314 supplied to the developing rollers 302a through 305a to predetermined thicknesses and charging the toner 314 by friction.

As shown by FIG. 26, a transcribing portion 315 for forming a color toner image by transcribing toner images of respective colors manifested on the photosensitive drums 310a through 313a on sheet (record medium) P to overlap each other is arranged at a position opposed to the exposing portions 306 through 309, the photosensitive portions 310 through 313 and the developing portions 302 through 305.

The transcribing portion 315 includes transcribing rollers 316 through 319 and springs 320 through 323 for respectively bringing the respective transcribing rollers 316 through 319 into press contact with the photosensitive drums 310a through 313a.

A sheet feeding portion 324 contained with sheet P is provided on a side opposed to the transcribing portion 315. Further, the sheet P is taken out from the sheet feeding portion 324 sheet by sheet by a sheet feeding roller 325.

A resist roller 326 for feeding the sheet P to the transcribing portion 315 at predetermined timings is provided on a sheet transporting path reaching the transcribing portion 315 from the sheet feeding portion 324. Further, a fixing portion 327 is arranged on a sheet transporting path on which the sheet P formed with the color toner image by the transcribing portion 315 travels.

The fixing portion 327 is provided with a heating roller 327a and a pressing roller 327b brought into press contact with the heating roller 327a and a color image transcribed on the paper P is fixed on the sheet P by pressure and heat accompanied by rotating the rollers 327a and 327b to pinch the sheet P.

In the image forming apparatus having such a constitution, first, a latent image having a yellow component color of image information is formed on the photosensitive drum 310a. The latent image is visualized on the photosensitive drum 310a as a yellow toner image by the developing roller 302a having a yellow toner. During the time period, the sheet P taken out from the sheet feeding portion 324 by the sheet feeding roller 325 is transmitted to the transcribing portion 315 by taking a timing by the resist roller 326. Further, the sheet P is pinched by the photosensitive drum 310 and the transcribing roller 316 to transport and at this occasion, the above-described yellow toner image is transcribed from the photosensitive drum 310a.

During a time period in which the yellow toner image is being transcribed on the sheet P, successively, a latent image having a magenta component color is formed and a magenta toner image by a magenta toner is visualized by the developing roller 303a. Further, the magenta toner image is transcribed on the sheet P transcribed with the yellow toner image to overlap the yellow toner image.

In the following, image formation and transcription are carried out similarly with regard to a cyan toner image and a black toner image and four colors of toner images finish to overlap on the sheet P.

Thereafter, the sheet P formed with the color image is transported to the fixing portion 327. At the fixing portion 327, the transcribed toner images are heated to fix on the sheet P and a full color image is formed on the sheet P.

The sheet P finished with a series of color image formation in this way is thereafter discharged onto a discharging-tray 328.

Here, in reference to FIG. 30, each of the organic electroluminescence elements 306b, 307b, 308b, 309b constituting light sources provided at the exposing portions 306 through 309 is formed with an anode 330 which is an electrode comprising a transparent conductive film formed by a sputtering method, a resistance heating vapor deposition method or the like for injecting holes and a cathode 331 which is an electrode formed by a resistance heating vapor deposition method or the like for injecting electrons above a wave guide 329 used as a board.

Further, a luminescent layer 332 is formed between the anode 330 and the cathode 331 and in reference to FIG. 30, a hole transporting layer 333 is formed between the anode 330 and the luminescent layer 332 and an electron transporting layer 334 is formed between the cathode 331 and the luminescent layer 332.

When current is applied by constituting a plus electrode by the anode 330 of each of the organic electroluminescence elements 306b through 309b having the constitution shown in FIG. 30 and constituting a minus electrode by the cathode 331, holes are injected from the anode 330 to the luminescent layer 332 via the hole transporting layer 333 and electrons are injected thereto from the cathode 331 via the electron transporting layer 334. A luminescence phenomenon is brought about in the luminescent layer 332 when holes and electrons injected in this way are recombined and excitons generated in accordance therewith are shifted from the excited state to the ground state.

In such an organic electroluminescence element, light irradiated from a fluorescent substance constituting a luminescent region in the luminescent layer 332 is emitted in all the directions centering on the luminescent substance and irradiated by way of the waveguide 329. Or, the light is temporarily directed in a direction reverse to a direction of taking out light (direction of the waveguide 329), reflected by the cathode 31 and irradiated by way of the waveguide 329.

At this occasion, according to the organic electroluminescence element, in the case of the organic electroluminescence element shown in FIG. 30, a thickness of the luminescent layer of the organic electroluminescence element is preferably constituted to be thicker than the anode 330 or the cathode 331.

Generally, shortcircuit caused by a foreign matter present in the luminescent layer 332 may be brought about in the organic electroluminescence element. Or, shortcircuit may be brought about at an end portion of the anode 330 or the cathode 31 since the thickness of the luminescent layer 332 becomes thinner than a predetermined thickness at a stepped difference formed at the end portion of the anode 330 or the cathode 331. However, by constructing the constitution shown in FIG. 30, the exposing apparatus which is difficult to bring about shortcircuit between the anode 330 and the cathode 331 can be realized.

Respective members constituting the organic electroluminescence elements has been explained in the previous embodiment. Therefore, it is omitted here.

As the cathode 331 of each of the organic electroluminescence elements 306d through 309d, a metal or an alloy having a low work function is used and a metal of Al, In, Mg, Ti or the like, Mg alloys of Mg—Ag alloy, Mg—In alloy and the like, Al alloys of Al—Li alloy, Al—Sr alloy, Al—Ba alloy and the like are used. Or, a laminated structure of LiO₂/Al, LiF/Al or the like is preferable as the cathode material.

A transparent cathode can be formed by forming an ultra thin layer having high light transmitting performance using a metal having small work function and laminating a transparent electrode thereabove.

Further, as a method of forming the film of the cathode, the resistance heating vapor deposition, the electron beam vapor deposition or the sputtering method is used.

Here, as described above, at the organic electroluminescence elements 306d through 309d, light irradiated from the luminescent layer is irradiated by way of an opposed face of the wave guide and when light passes a boundary face of respective media, in the case in which a refractive index of a medium on an incident side is larger than a refractive index on an emitting side, light incident thereon by an angle larger than a critical angle which is an angle by which an angle of emittance of a refracted wave becomes 90°, cannot pass the boundary face and is totally reflected by the boundary face between the media.

Therefore, in each of the organic electroluminescence elements 306d through 309d at which light is irradiated isotropically, light irradiated by an angle larger than the critical angle advances by repeating total reflection by the boundary face of the wave guide in the wave guide, particularly, according to the embodiment, as shown by FIG. 32, advances by repeating total reflection in the core 329a surrounded by the clad 29b of the waveguide 329 to reach an end face in a sub scanning direction.

Hence, according to the embodiment, attention is paid to the point, the end face in the sub scanning direction of the waveguide 329 is made to constitute a light taking out face 335 and light emitted from the light taking out face 335 is used as exposing light.

That is, the larger the area of the luminescent layer, the larger the amount of light advancing in the core 329a and therefore, a light amount of light reaching the light taking out face 335 constituting the end face in the sub scanning direction of the wave guide 329 is increased. That is, when the exposing light is constituted by the light from the light taking out face 335 which is the end face in the sub scanning direction of the wave guide 329, by only enlarging the area of the luminescent layer, the amount of luminescent light is increased and therefore, the luminescent light amount necessary for exposure can be provided by increasing applied current without shortening element life of the organic electroluminescence elements 306d through 309d.

That is, according to the invention, the exposure light is constituted by the light from the light taking out face 335 which is the end face of the wave guide 329. Although according to the embodiment, the board and the wave guide are integrated in this way, the wave guide may separately be formed independently from the board.

Further, according to an image forming apparatus using such an exposing apparatus, the electrostatic latent image can properly be formed on each of the photosensitive drums 310a through 313a and therefore, an image of high quality can be formed.

Particularly, according to the embodiment, the wave guide 329 which is a wave guiding path is constituted by the core 329a and the clad 329b and therefore, light irradiated from the luminescent layer is further efficiently be guided to the light taking out face 335 and a further increase in the luminescent light amount can be achieved. However, there may not be constituted such a two-layer structure of the core 329a and the clad 329b.

Here, a light shielding layer or a reflecting layer can be provided between the cores 329a contiguous to each other. When the light shielding layer or the reflecting layer is provided, light is not incident on a certain one of the core 329a from other of the core 329a and therefore, there is not a dispersion in the light amount taken out from the light taking out face 335 among the cores 329a. Further, particularly when the reflecting layer is provided, light incident on the core 329a from the luminescent layer is more reflected to reach the light taking out face 335 and therefore, an increase in the light amount can be achieved.

Further, although the shape of the light taking out face 335 can be constituted, for example, by a rectangular shape or a hexagonal shape or the like, it is preferable to constitute the shape in correspondence with a shape of a pixel. Further, when the wave guide 329 is constituted by the core 329a and the clad 329b, the light taking out face 335 becomes a face constituted by the core 329a and the clad 329b.

As shown by FIG. 33, the wave guide can be formed with an angle converting portion 336 for converting an angle of light incident on the wave guide 329 from the luminescent layer 332 to guide to the light taking out face 335. When the angle converting portion 336 is formed, a further increase in the amount of light taken out from the light taking out face 335 can be achieved. Here, although in the illustrated case, the angle converting portion 336 is constituted by a scattering face formed with a number of semispherical bodies at a face of the wave guide 329 on a side opposed to the luminescent layer 332, the angle converting portion 336 can be constituted by various shapes of a face of recesses and projections, a shape of semicircular cylinders uniform in the main scanning direction or a face of recesses ad projections in a sawtooth shape and by providing the angle converting portion 336 aligned with a plurality of one-dimensional shapes in parallel, the angle can be converted to a specific angle. Further, it is preferable that the angle converting portion 336 is not accompanied by angle conversion to the main scanning direction in order to guide light in a direction other than the sub scanning direction to the light taking out face 335. Particularly when there is provided the angle converting portion 36 for carrying out angle conversion to a direction orthogonal to both of main scanning and sub scanning (direction perpendicular to the luminescent layer), light which is wasted when the angle converging portion 336 is not provided can be guided to the light taking out face 335 without hampering advancement of light in the sub scanning direction and therefore, the constitution is effective. Further, when the wave guide 329 is constituted by the core 329a and the clad 329b, by forming the angle converting portion 336 at the interface between the core 329a disposed on a side opposed to the light emitting layer 332 and the clad 329b, angle conversion by the angle converting portion 336 can be carried out while effectively utilizing an effect of total reflection at the interface between the core 329a and the clad 329b.

Further, in the wave guide 329, the reflecting layer can be formed at a face opposed to the light taking out face 335 or a face disposed on a side opposed to the luminescent layer 332. When the reflecting layer is provided, light incident on the waveguide 329 from the luminescent layer 332 is more reflected to reach the light taking out face 335 and therefore, an increase in the light amount can be achieved. Further, the reflecting layer may be formed only at either face of the face opposed to the light taking out face 335 and the face disposed on the side opposed to the luminescent layer 332.

Further, the light taking out face 335 of the wave guide 329 can be formed with diffusion restricting means for narrowing an angle of diffusing light emitted from the light taking out face 335 or constituting parallel light from the light, that is, restraining diffusion of light. Further, in the formed diversion restraining means 337, other than a curved face lens of a convex lens or a concave lens, there is a lens of an iron doping type or a UV modifying type in a slit-like shape, a mesa structure utilizing total reflection as shown by FIG. 34, or a taper reflection structure arranged with a mirror face at a position equivalent to that of a total reflection face of the mesa structure. Further, the lens can restrain diffusion of light by an integrated lens such as a structure of forming lenses to individual ones of the light taking out faces 335 one by one, a structure formed with a plurality of lenses to a single one of the light taking face 35, or a structure of forming a single lens to a plurality of the light taking out faces 335, or a structure of a single cylindrical lens or a one-dimensional mesa structure for all of the taking out faces.

Further, when the light taking out face 335 of the wave guide 329 and each of the photosensitive drums 310a through 313a are arranged at positions extremely proximate to each other, for example, at a distance equal to or smaller than a diagonal line of a pixel, light emitted from the light taking out face 335 is irradiated to the photosensitive drum without interposing each of image transmission optical systems 306f through 309f. Or, when the light taking out face 335 and each of the photosensitive drums 310a through 313a are arranged at positions remote from each other, light is focused on each of the photosensitive drums 310a through 313a in an erected image at equal magnification by passing each of the image transmission optical systems 306f through 309f.

Although in the above-described explanation, an explanation has been given of case of applying the invention to the color image forming apparatus, the invention is applicable also to an image forming apparatus of single color of black or the like. Further, when the invention is applied to the color image forming apparatus, developed colors are not limited to four colors of yellow, magenta, cyan and black.

(Embodiment 2)

FIG. 35 is a sectional view showing an essential portion of an organic electroluminescence element used as a light source of an exposing portion of a color image forming apparatus according to Embodiment 2 of the invention. Further, according to the embodiment, an apparatus constitution of the color image forming apparatus is similar to that in FIG. 26 through FIG. 29 referred to in Embodiment 1.

Further, in FIG. 35, between the anode 330 and the cathode 331, there are respectively formed a first luminescent layer 338 having a luminescent region and disposed on a side of the anode 330 (on a side proximate to the anode 330) and a second luminescent layer 339 having a luminescent region and disposed on a side of the cathode 331 (on a side proximate to the cathode 331).

Further, between the first luminescent layer 338 and the second luminescent layer 339 on the side proximate to the cathode 331, there is formed a charge generating layer 340 for injecting electrons to the first luminescent layer 338 and injecting holes to the second luminescent layer 339.

Further, a first hole transporting layer 341 is formed between the anode 330 and the first luminescent layer 338, a first electron transporting layer 342 is formed between the first luminescent layer 338 and the charge generating layer 340, a second hole transporting layer 343 is formed between the charge generating layer 340 and the second luminescent layer 339 and a second electron transporting layer 344 is formed between the second luminescent layer 339 and the cathode 331.

When current is applied by constituting a plus electrode by the electrode 330 of each of the organic electroluminescence elements 306b through 309b having the structure shown in FIG. 335 and constituting a minus electrode by the cathode 331, the first luminescent layer 338 is injected with holes from the anode 330 via the first hole transporting layer 341 and injected with electrons from the charge generating layer 340 via the first electron transporting layer 342 and the second luminescent layer 339 is injected with electrons from the cathode 331 via the second electron transporting layer 344 and injected with holes from the charge generating layer 340 via the second hole transporting layer 343. At the first luminescent layer 338 and the second luminescent layer 339, the luminescent phenomenon is brought about when holes and electrons injected in this way are recombined and excitons generated in accordance therewith are shifted from the excited state to the ground state.

Further, since luminescence is carried out by a plurality of luminescent layers of the first luminescent layer 338 and the second luminescent layer 339, the luminescent amount of the organic electroluminescence element can be increased.

Here, as the charge generating layer 340 of the organic electroluminescence element, there is used a material which is transparent to light emitted from the luminescent layer and can efficiently inject hole-electron pairs and there is disclosed a metal oxide of, for example, ITO (indium-tin oxide), V₂O₅ (vanium oxide) or the like or an organic substance of 4F-TCNQ (4 fluoride-tetracyanoquinodimethane) or the like in the 63th Applied Physic society Conference Proceeding 27a-ZL 12. Other than these, there can be used various members of conductor, semiconductor, dielectric substance, insulating substance or a laminated film laminated with a plurality of materials for the charge generating layer 340.

Here, according to the organic electroluminescence element having the above-described constitution, when the charge generating layer 340 is a conductor, work function of the charge generating layer 340 is set to be higher than ionization potential of the second luminescent layer 339 on the side proximate to the cathode 31. Or, when the charge generating layer 340 comprises a semiconductor, a dielectric substance, an insulating substance, it is preferable to set electron affinity of the charge generating layer 340 to be lower than electron affinity of the first luminescent layer 338 on the side proximate to the anode 330 and set ionization potential of the charge generating layer 340 to be higher than ionization potential of the second luminescent layer 339.

The reason is as follows. When the electron affinity of the charge generating layer 340 is lower than the electron affinity of the first luminescent layer 338 on the side opposed to the cathode 330, an efficiency of injecting electrons from the charge generating layer 340 to the first luminescent layer 38 on the side proximate to the anode 330 is increased, further, when the work function of the charge generating layer 340 is higher than the ionization potential of the second luminescent layer 339 on the side proximate to the cathode 331, or when the ionization potential of the charge generating layer 340 is higher than the ionization potential of the second luminescent layer 339 on the side proximate to the cathode 331, an efficiency of injecting holes from the charge generating layer 340 to the second luminescent layer 339 on the side proximate to the cathode 330 is increased and therefore, luminescent light amounts of the first luminescent layer 338 on the side proximate to the anode 330 and the second luminescent layer 339 on the side proximate to the cathode 331 are further increased, as a result, the luminescent light amount of the organic electroluminescence element can further be increased.

Further, when the charge generating layer 340 is constituted by an inorganic material, it is general that the ionization potential of the second luminescent layer 339 on the side proximate to the cathode becomes higher than the ionization potential of the charge generating layer 340. In this case, when a potential difference therebetween is made to be as small as possible, for example, when the potential difference is made to be equal to or smaller than 0.6 eV, even in the case in which the ionization potential of the charge generating layer is lower than the ionization potential of the second luminescent layer on the side proximate to the cathode, the efficiency of injecting holes from the charge generating layer 340 to the second luminescent layer 339 on the side proximate to the cathode is not reduced and a high efficiency can be achieved.

Further, by using the organic electroluminescence element for the light source of the exposing portion in this way, the light amount necessary for exposure can be provided without constituting large-sized formation of the apparatus.

Further, by using the exposing apparatus in the image forming apparatus, a compact image forming apparatus can be provided.

Further, as shown by FIG. 35, the charge generating layer 340 may be constructed by a two-layer structure of a first charge generating layer 340a disposed on a side of the first luminescent layer 338 on the side proximate to the anode and a second charge generating layer 340b disposed on a side of the second luminescent layer 339 on the side proximate to the cathode, or a structure having layers of a number more than two.

In this case, it is preferable to set the first charge generating layer 340a to the electron affinity lower than that of the second electron generating layer 340b and set the second charge generating layer 340b to ionization potential higher than the first charge generating layer 340a.

Further, it is preferable to form an initially formed charge generating layer (first charge generating layer 340a or second charge generating layer 340b) by resistance heating. This is for reducing damage by a process of forming, for example, a film of the first luminescent layer 338 on the side proximate to the anode in forming the first charge generating layer 340a on the first luminescent layer 338 on the side proximate to the node. Further, the charge generating layer formed thereafter can be formed even by a process which may enhance damage by the film forming process of sputtering, plasma CVD, ion beam, electron beam or the like.

Here, when a dielectric material is used for the charge generating layer 340, it is preferable to make a specific inductive capacity of the charge generating layer 340 equal to or higher than specific inductive capacities of the first luminescent layer 338 on the side proximate to the anode and the second luminescent layer 339 on the side proximate to the cathode, for example, make the specific inductive capacity of the charge generating layer 340 about 8 through 10, and make the specific inductive capacities of the first luminescent layer 338 on the side proximate to the anode and the second luminescent layer 339 on the side proximate to the cathode about 3.

Further, it is preferable to constitute a layer in contact with the charge generating layer 340 in the luminescent layer and the hole transporting layer and the electron transporting layer disposed between an initially formed electrode (anode 330 or cathode 331) and the charging generating layer 340 (when the cathode 330 is initially formed, the first luminescent layer 338 and the first hole transporting layer 341 and the first electron transporting layer 342, when the cathode 334 is initially formed, the second luminescent layer 339 on the side proximate to the cathode and the second hole transporting layer 343 and the second electron transporting layer 344), that is, a layer in contact with the charge generating layer 340 in the layers including the luminescent layers by a polymer which is difficult to undergo damage in forming the charge generating layer 340. Further, in a case of a single layer structure of only a luminescent layer, a two-layer structure of a luminescent layer and an electron transporting layer, a two-layer structure of a hole transporting layer and a luminescent layer, or in the case of a plural layer structure having any of function layers of other hole blocking layer, hole injecting layer, electron blocking layer, electron injecting layer or the like, a layer in contact with the charge generating layer 40 in the layers is constituted by polymer.

Further, the first luminescent layer 338 on the side proximate to the anode and the second luminescent layer 339 on the side proximate to the cathode may be constituted by members the same as each other or may be constituted by different members.

Although in the above-described explanation, the organic electroluminescence element constituting the light source of exposure is driven by direct current, the element may be driven by alternating current voltage or alternating current or a pulse wave.

Further, although in the above-described explanation, an explanation has been given of the case of applying the invention to the color image forming apparatus, the invention is applicable also to an image forming apparatus of a single color of black or the like. Further, when the invention is applied to the color image forming apparatus, developed colors are not limited to four colors of yellow, magenta, cyan and black.

(Embodiment 3)

FIG. 36 is a sectional view showing an essential portion of an organic electroluminescence element used as a light source of an exposing portion of a color image forming apparatus according to Embodiment 3 of the invention. Further, according to the embodiment, an apparatus constitution of the color image forming apparatus is similar to that of FIG. 26 through FIG. 29 referred to in Embodiment 1.

The illustrated organic electroluminescence element as the exposing light source is constituted by a structure of successively laminating the anode 330, a first hole transporting layer 345, a first luminescent layer 346, a first electron transporting layer 347, the cathode 331, an insulating layer 348, the anode 330, a second hole transporting layer 349, a second luminescent layer 350, a second electron transporting layer 351 and the cathode 331 above the wave guide 329. That is, the element is constituted by a structure of alternately arranging the anode 330 and the cathode 331 via the luminescent layer 346 (350) and the hole transporting layer 345 (349) and the electron transporting layer 347 (351).

Further, for example, in Embodiment 2, it is not necessary to interpose the luminescent layers and the like between all of the anodes and the cathodes as shown by FIG. 35, but as shown by Embodiment 3, the insulating layer 348, that is, a layer other than the luminescent layer may be interposed therebetween as in a relationship between the anode 330 and the cathode 331 which are intermediate layers in FIG. 36.

When direct current voltage or direct current is applied thereto by constituting plus electrodes by the two anodes 330 of the organic electroluminescence element having such a constitution and constituting minus electrodes by the two cathodes 331, the first luminescent layer 346 is injected with holes from the anode 330 on the side of the wave guide 329 by way of the first hole transporting layer 346 and injected with electrons from the cathode 331 on the side of the insulating layer 348 by way of the first electron transporting layer 347 and the second luminescent layer 350 is injected with electrons from the cathode 331 of a topmost layer by way of the second electron transporting layer 51 and injected with holes from the anode 330 on the side of the insulating layer 348 by way of the second hole transporting layer 349. At the first luminescent layer 346 and the second luminescent layer 350, holes and electrons injected in this way are recombined and there is brought about the luminescence phenomenon when excitons generated in accordance therewith are shifted from the excited state to the ground state.

Therefore, even by such a constitution, luminescence is carried out by the plurality of luminescent layers of the first luminescent layers 346 and the second luminescent layer 350 and therefore, the luminescent light amount of the organic electroluminescence element can be increased.

Further, the insulating layer 348 may not be interposed between the anode 330 and the cathode 331 and in that case, there may be constituted a structure of successively laminating the second hole transporting layer 349, the second luminescent layer 350, the second electron transporting layer 351 and the cathode 331 in this order by constituting common electrodes by the anode 330 and the cathode 331 interposed between the first luminescent layer 346 and the second luminescent layer 350, as the cathode of injecting electrons to the first luminescent layer 346 and as the anode for injecting holes to the second luminescent layer 348, or, there maybe constituted a structure of successively laminating the second electron transporting layer 351, the second luminescent layer 350, the second hole transporting layer 349 and the anode 330 in this order by constituting common electrodes by the anode 330 and the cathode 331 interposed between the first luminescent layer 346 and the second luminescent layer 350.

Further, although organic thin film layers are respectively constituted by a three-layer structure of the hole transporting layer 345 (349), the luminescent layer 346 (350) and the electron transporting layer 347 (351), other than such a structure, there may be constituted either structure of a single layer structure of only a luminescent layer and a 2-layer structure of a hole transporting layer and a luminescent layer or a luminescent layer and an electron transporting layer. However, in the case of the 2-layer structure or the 3-layer structure, the hole transporting layer and the anode or the electron transporting layer and the cathode are formed to laminate to be brought into contact with each other. Or, there may be constituted a structure of plural layers constituting laminated layers or mixed layer by pertinently selecting layers functions of which are separated such as a structure of providing an electron blocking layer between the hole transporting layer and the luminescent layer, a structure providing a hole blocking layer between the luminescent layer and the electron transporting layer, or a structure providing a hole injecting layer between the anode and the hole transporting layer or a structure providing an electron injecting layer between the electron injecting layer and the cathode.

Further, although in the illustrated case, the nodes 330 and the cathodes 331 are formed alternately by two layers, at least single layers thereof may alternately be arranged and either of the anodes 330 and the cathodes 331 may continuously be arranged by interposing the insulating layer 348.

Further, according to the embodiment, a luminescent layer and a hole transporting layer disposed between an initially formed electrode and a successively formed electrode may be constituted by a polymer which is difficult to undergo damage. Further, in the case of a single layer structure of only a luminescent layer, a 2-layer structure of a luminescent layer and an electron transporting layer and a 3-layer structure of a hole transporting layer and a luminescent layer and an electron transporting layer, it is preferable to constitute any layers of these by polymer.

Although in the above-described explanation, the organic electroluminescence element constituting the exposing the light source is driven by direct current, the element may be driven by alternating current voltage or alternating current or a pulse wave.

Further, although in the above-described explanation, an explanation has been given of a case of applying the invention to the color image forming apparatus, the invention is applicable also to an image forming apparatus of a single color of, for example, black or the like. Further, when the invention is applied to the color image forming apparatus, developed colors are not limited to four colors of yellow, magenta, cyan and black.

The invention described in first aspect of the invention is an exposing apparatus which is an exposing apparatus comprising at least an organic electroluminescence element constituting a light source and a wave guide an end face in a sub scanning direction of which is made to constitute a light taking out face wherein light irradiated from the organic electroluminescence element and incident on the wave guide and emitted from the light taking out face is used as exposure light and wherein the organic electroluminescence element includes at least an anode constituting an electrode for injecting holes, a cathode constituting an electrode for injecting electrons and a luminescent layer formed between the anode and the cathode and having a luminescent region and a thickness of the luminescent layer is made to be thickened than a thickness of the electrode, since the thickness of the luminescent layer of the organic electroluminescence element is made to be thicker than the thickness of the electrode, a possibility of shortcircuit in the luminescent layer becomes low, shortcircuit at an initial stage caused in fabricating the element can also be restrained and therefore, an exposing apparatus having an excellent yield can be realized. Further, since the thickness of the luminescent layer is sufficiently thinner than a thickness of the board of the organic electroluminescence element and therefore, a small-sized exposing apparatus can be realized. Further, by constituting exposure light by light emitted from the light taking out face constituting the end face in the surface scanning direction of the wave guide, there can be realized an exposing apparatus capable of providing a luminescent light amount necessary for exposure without shortening element life by increasing applied current and capable of achieving small-sized formation and thin-sized formation having a high degree of freedom of arrangement.

The invention described in second aspect of the invention is an exposing apparatus which is an exposing apparatus comprising at least an organic electroluminescence element constituting a light source and a wave guide an end face in a sub scanning direction of which is made to constitute a light taking out face wherein light irradiated from the organic electroluminescence element and incident on the wave guide and emitted from the light taking out face is used as exposure light and wherein the organic electroluminescence element includes at least an anode constituting an electrode for injecting holes, a cathode constituting an electrode for injecting electron, a luminescent layer on a side proximate to the cathode having a luminescent region and disposed on the side of the anode and a luminescent layer on a side proximate to the cathode having a luminescent region disposed on the side of the cathode, which are respectively formed between the anode and the cathode, and charge generating layers formed between the luminescent layer on the side proximate to the anode and the luminescent layer on the side proximate to the cathode for injecting electrons to the luminescent layer on the side proximate to the anode and injecting holes to the luminescent layer on the side proximate to the cathode, by forming the luminescent layers of the organic electroluminescence element by a plurality of luminescent layers, a thickness of the luminescent layer is thickened in a state in which a luminescence efficiency is excellent and therefore, a possibility of shortcircuit in the luminescent layer becomes low, shortcircuit at an initial stage caused in fabricating the element can also be restrained and therefore, an exposing apparatus having excellent yield can be realized. Since luminescence is carried out by the plurality of luminescent layers, a luminescent light amount of the organic electroluminescence element can be increased. Further, since an efficiency of injecting holes to the luminescent layer and an efficiency of injecting electrons thereto are increased, the luminescent light amount at the luminescent layer is further increased, as a result, a bright exposing apparatus capable of further increasing the luminescent light amount of the organic electroluminescence element can be realized. Further, the thickness of the luminescent layer is sufficiently thinner than a thickness of the board of the organic electroluminescence element and therefore, a small-sized exposing apparatus can be realized. Further, by constituting exposure light by light emitted from the light taking out face constituting the end face in the sub scanning direction of the wave guide, there can be realized an exposing apparatus capable of providing the luminescent light amount necessary for exposure without shortening element life by increasing applied current and capable of achieving small-sized formation and thin-sized formation having a high degree of freedom of arrangement.

The invention described in third aspect of the invention is the exposing apparatus wherein an ionization potential of the charge generating layer is higher than an ionization potential of the luminescent layer on the side proximate to the cathode and since luminescence is carried out by the plurality of luminescent layers, the invention carries out operation of capable of increasing the luminescent light amount of the organic electroluminescence element. Further, a work function of the charge generating layer is set to be higher than the ionization potential of the second luminescent layer and therefore, an efficiency of injecting holes to the second luminescent layer is increased and therefore, the luminescent light amount at the second luminescent layer is increased, as a result, the invention carries out operation of capable of further increasing the luminescent light amount of the organic electroluminescence element.

The invention described in fourth aspect of the invention is the exposing apparatus, wherein an electron affinity of the charge generating layer is lower than an electron affinity of the luminescent layer on the side proximate to the cathode and since luminescence is carried out by the plurality of luminescent layers, the invention carries out operation of capable of increasing the luminescent light amount of the organic electroluminescence element. Further, since the electron affinity of the charge generating layer is set to be lower than the electron affinity of the first luminescent layer, the ionization potential of the charge generating layer is set to be higher than the ionization potential of the second luminescent layer and therefore, an efficiency of injecting holes to the respective luminescent layers and an efficiency of injecting electrons thereto are increased and therefore, luminescent light amounts of the luminescent layers are further increased, as a result, the invention carries out operation of capable of further increasing the luminescent light amount of the organic electroluminescence element.

The invention described in fifth aspect of the invention is the exposing apparatus wherein a potential difference between an electron affinity of the luminescent layer on the side proximate to the anode and the charge generating layer and a potential difference between an ionization potential of the luminescent layer on the side proximate to the cathode and the charge generating layer is set to be equal to or smaller than 0.6 eV, and luminescence is carried out by the plurality of luminescent layers and therefore, the invention carries out operation of capable of increasing the luminescent light amount of the organic electroluminescence element. Further, by adopting such a constitution, an efficiency of injecting holes to the respective luminescent layers and an efficiency of injecting electrons thereto are increased and therefore, the luminescent light amounts of the luminescent layers are further increased, as a result, the invention carried out operation of capable of further increasing the luminescent light amount of the organic electroluminescence element.

The invention described in sixth aspect of the invention is the exposing apparatus further comprising at least a first charge generating layer disposed on a side of the luminescent layer on the side proximate to the anode and a second charge generating layer disposed on a side of the luminescent layer on the side proximate to the cathode wherein the first charge generating layer is set with an electron affinity lower than an electron affinity of the second charge generating layer and the second charge generating layer is set to an ionization potential higher than the first charge generating layer, and since an efficiency of injecting holes to the respective efficient layer and the efficiency of injecting electrons thereto are increased, the luminescent light amounts of the luminescent layers are further increased, as a result, the invention carried out operation of capable of further increasing the luminescent light amount of the exposing apparatus.

The invention described in seventh aspect of the invention is the exposing apparatus wherein an initially formed charge generating layer is formed by resistance heating and the invention carries out operation of capable of alleviating damage in forming the film.

The invention described in eighth aspect of the invention is the exposing apparatus wherein the charge generating layer comprises a dielectric substance and a specific inductive capacity of the charge generating layer is equal to or larger than specific inductive capacities of the luminescent layer on the side proximate to the anode and the luminescent layer on the side proximate to the cathode and the invention carried out operation of capable of increasing the luminescent light amount of the exposing apparatus.

The invention described in ninth aspect of the invention is the exposing apparatus wherein the luminescent layer on the side proximate to the anode and the luminescent layer on the side proximate to the cathode are constituted by members the same as each other and the invention carries out operation of capable of increasing the luminescent light amount of the exposing apparatus.

The invention described in tenth aspect of the invention is an exposing apparatus which is an exposing apparatus comprising at least an organic electroluminescence element constituting a light source and a wave guide an end face in a sub scanning direction of which is made to constitute a light taking out face wherein light irradiated from the organic electroluminescence element and incident on the wave guide and emitted from the light taking out face is used as exposure light and wherein the organic electroluminescence element includes at least a plurality of anodes constituting electrodes for injecting holes, a plurality of cathodes arranged alternately with the anodes and constituting electrodes for injecting electrons and a plurality of luminescent layers respectively formed between the anodes and the cathodes and prescribed by the anodes and the cathodes and by forming the luminescent layers of the organic electroluminescence element by a plurality of luminescent layers, a thickness of the luminescent layer is thickened in a state in which a luminescence efficiency is excellent and therefore, a possibility of shortcircuit in the luminescent layer becomes low, shortcircuit at an initial stage caused in fabricating the element can also be restrained and therefore, an exposing apparatus having an excellent yield can be realized. Since luminescence is carried out by the plurality of luminescent layers, a luminescent light amount of the organic electroluminescence element can be increased. Further, an efficiency of injecting holes to the luminescent layer and an efficiency of injecting electron thereto are increased and therefore, a luminescent light amount at the luminescent layer is further increased and as a result, a bright exposing apparatus capable of further increasing the luminescent light amount of the organic electroluminescence element can be realized. Further, a thickness of the luminescent layer is sufficiently thinner than a thickness of the board of the organic electroluminescence element and therefore, a small-sized exposing apparatus can be realized. Further, by constituting exposure light by light emitted from the light taking out face constituting an end face in a sub scanning direction of the wave guide, there can be realized an exposing apparatus capable of providing the luminescent light amount necessary for exposure without shortening element life by increasing applied current and capable of achieving small-sized formation and thin-sized formation having a high degree of freedom of arrangement.

The invention described in eleventh aspect of the invention is the exposing apparatus wherein the luminescent layers are constituted by members the same as each other and the invention carried out operation of capable of increasing the luminescent light amount of the exposing apparatus.

The invention described in twelfth aspect of the invention is the exposing apparatus wherein a layer including the luminescent layer disposed between an initially formed electrode and a successively formed electrode comprises a polymer and the invention carried out operation of capable of alleviating damage in forming the film.

The invention described in thirteenth aspect of the invention is an exposing apparatus which is an exposing apparatus comprising at least an organic electroluminescence element constituting a light source and a wave guide an end face in a sub scanning direction of which is made to constitute a light taking out face wherein light irradiated from the organic electroluminescence element and incident on the wave guide and emitted from the light taking out face is used as exposure light and wherein the organic electroluminescence element at least includes an anode constituting an electrode for injecting holes, a cathode constituting an electrode for injecting electrons and a luminescent layer formed between the anode and the cathode and including a luminescent region and the luminescent layer is formed by a material capable of forming the luminescent layer at least by coating and since the luminescent layer of the organic electroluminescence element can be formed by coating, a thickness of the luminescent layer can easily be thickened and therefore, a possibility of shortcircuit in the luminescent layer becomes low. Further, the thickness of the luminescent layer is sufficiently thinner than a thickness of the board of the organic electroluminescence element and therefore, a small-sized exposing apparatus can be realized. Thereby, there can be realized an exposing apparatus capable of providing the luminescent light amount necessary for exposure without shortening element life by increasing applied current and capable of achieving small-sized formation and thin-sized formation having a high degree of freedom of arrangement.

The invention described in fourteenth aspect of the invention is an exposing apparatus which is an exposing apparatus comprising at least an organic electroluminescence element constituting a light source and a wave guide an end face in a sub scanning direction of which is made to constitute a light taking out face wherein light irradiated from the organic electroluminescence element and incident on the wave guide and emitted from the light taking out face is used as exposure light and wherein the organic electroluminescence element includes at least an anode constituting an electrode for injecting holes, a cathode constituting an electrode for injecting electrons and a luminescent layer formed between the anode and the cathode and including a luminescent region and a stepped difference formed by the board and the electrode formed above the board is made to be equal to or smaller than a thickness of the luminescent layer and since the thickness of the luminescent layer of the organic electroluminescence element is made to be thicker than the stepped difference formed by the electrode and therefore, a possibility of shortcircuit in the luminescent layer becomes low. Further, the thickness of the luminescent layer is sufficiently thinner than a thickness of the board of the organic electroluminescence element and therefore, a small-sized exposing apparatus can be realized. Thereby, there can be realized an exposing apparatus capable of providing a luminescent light amount necessary for exposure without shortening element life by increasing applied current and capable of achieving small-sized formation and thin-sized formation having a high degree of freedom of arrangement.

The invention described in fifteenth aspect of the invention is the exposing apparatus wherein a layer including the luminescent layer comprises a polymer and the invention carries out operation of capable of alleviating damage in forming the film.

The invention described in sixteenth aspect of the invention is the exposing apparatus of the invention described in any one of previous described, wherein the wave guide is integrated with the board and small-sized formation and thin-sized formation of the exposing apparatus can easily be achieved and since light is emitted from a direction of an end face of a luminescent face by the wave guide, a luminescent area can easily be enlarged in the sub scanning direction and therefore, the luminescent light amount is increased only by enlarging the area of the luminescent layer and therefore, the invention carried out operation of capable of providing the luminescent light amount necessary for exposure without shortening element life by increasing applied current. Further, since the wave guide and the board are integrated, the exposing apparatus can further be downsized, a step of pasting the wave guide is dispensed with, positioning of the wave guide is dispensed with and therefore, the invention carries out operation of capable of inexpensively realizing the exposing apparatus capable of providing a stable light amount.

The invention described in seventeenth aspect of the invention is the exposing apparatus, wherein a plurality of pieces of the wave guides optically isolated in a main scanning direction for respective pixels are aligned in parallel with each other and small-sized formation and thin-sized formation of the exposing apparatus can easily be achieved, since light is emitted from a direction of an end face of a luminescent face by the wave guide, a luminescent area can easily be enlarged in the sub scanning direction and therefore, the luminescent light amount is increased by only enlarging the area of the luminescent layer and therefore, the invention carries out operation of capable of providing the luminescent light amount necessary for exposure without shortening element life by increasing applied current. Further, the wave guides are optically isolated for the respective pixels and light can be propagated for the respective pixels and therefore, the luminescent light amount is increased by a unit of the pixel and the invention carries out operation of capable of realizing the image quality having a high resolution.

The invention described in eighteenth aspect of the invention is the exposing apparatus, wherein the wave guide is constituted by a core having a predetermined refractive index and a clad formed at an outer periphery of the core and having a reflective index smaller than the refractive index of the core and small-sized formation and thin-sized formation of the exposing apparatus can easily be achieved, since light is emitted from a direction of an end face of a luminescent face by the wave guide, a luminescent area can easily be enlarged in the sub scanning direction and therefore, light irradiated from the luminescent layer is further efficiently guided to the light taking out face and therefore, the invention carries out operation of capable of achieving a further increase in the luminescent light amount. Further, light propagated in the wave guide can be propagated in a direction of the light taking out face by total reflection at an interface between the core and the clad and therefore, light having small loss can be propagated and the invention carries out operation of capable of stably propagating light even when dust and dirt is adhered or a defect is brought about on a surface of the clad.

The invention described in nineteenth aspect of the invention is the exposing apparatus, wherein the core is provided with a refractive index smaller than a refractive index of the luminescent layer and small-sized formation and thin-sized formation of the exposing apparatus can easily be achieved, since light is emitted from a direction of an end face of a luminescent face by the wave guide, a luminescent area can easily be enlarged in the sub scanning direction and therefore, light irradiated from the luminescent layer and incident on the wave guide can further efficiently be guided by the light taking out face and therefore, the invention carries out operation of capable of achieving a further increase in the luminescent light amount. Further, light irradiated from the luminescent layer is efficiently guided to the light taking out face since the refractive index of the wave guide is small and therefore, light in the sub scanning direction in the wave guide is increased by refraction of light and therefore, the invention carries out operation of capable of achieving a further increase in the luminescent light amount.

The invention described in twentieth aspect of the invention is the exposing apparatus of the invention described in claim 18 wherein the refractive index of the core is larger than a value constituted by subtracting 0.3 from the refractive index of the luminescent layer and small-sized formation and thin-sized formation of the exposing apparatus can easily be achieved, since light can be emitted from a direction of an end face of the luminescent face by the wave guide, the luminescent area can easily be enlarged in the sub scanning direction and therefore, light irradiated from the luminescent layer and incident on the wave guide is further efficiently be guided to the light taking out face and therefore, the invention carries out operation of capable of achieving a further increase in the luminescent light amount. Further light irradiated from the luminescent layer is efficiently guided to the light taking out face by restraining total reflection at the interface of the wave guide and therefore, the invention carried out operation of capable of achieving a further increase in the luminescent light amount.

The invention described in twenty-first aspect of the invention is the exposing apparatus, further comprising a light shielding layer or a reflecting layer between the wave guides contiguous to each other, light is not made to be incident from other wave guide and therefore, the invention carries out operation of eliminating a dispersion of a light amount taken out from the light taking out face among the wave guides. Particularly when the reflecting layer is provided, light propagated as ineffective light by being incident on other wave guide is propagated as effective light and therefore, the light is further efficiently guided to the light taking out face and therefore, the invention carries out operation of capable of achieving a further increase in the luminescent light amount.

The invention described in twenty-second aspect of the invention is the exposing apparatus wherein the light taking out face is constituted by a shape in correspondence with a shape of the pixel and small-sized formation and thin-sized formation of the exposing apparatus can easily be achieved, since light is emitted from a direction of an end face of the luminescent face by the wave guide, the luminescent area can easily be enlarged in the sub scanning direction and therefore, the luminescent light amount is increased by only enlarging the area of the luminescent face and therefore, the invention carries out operation of capable of providing the luminescent light amount necessary for exposure without shortening element life by increasing applied current. Further, since the light taking out face is constituted by the shape in correspondence with the shape of the pixel, the invention carries out operation of capable of easily forming a highly fine latent image.

The invention described in twenty-third aspect of the invention is the exposing apparatus, wherein the wave guide is formed with an angle converting portion for guiding light incident on the wave guide from the luminescent layer to the light taking out face by converting an angle of the light and the invention carries out operation of capable of achieving a further increased in the light amount taken out from the light taking out face.

The invention described in twenty-fourth aspect of the invention is the exposing apparatus wherein the angle converting portion guides light in a direction other than the sub scanning direction to the light taking out face and influence on light which is inherently effectively taken out is inconsiderable and the angle of the ineffective light can be converted to that of the effective light and therefore, the invention carried out operation of capable of achieving a further increase in the light amount taken out from the light taking out face.

The invention described in twenty-fifth aspect of the invention is the exposing apparatus wherein the angle converting portion converts the angle to a direction orthogonal to either of main scanning and sub scanning to guide the light to the light taking out face and influence on the light which is inherently effectively taken out is inconsiderable and the angle of the ineffective light can be converted to that of the effective light and therefore, the invention carries out operation of capable of achieving a further increase in the light amount taken out from the light taking out face.

The invention described in twenty-sixth aspect of the invention is the exposing apparatus wherein the angle converting portion is formed at an interface between the core and the clad disposed on a side opposed to the luminescent layer and influence on light which is inherently effectively taken out is inconsiderable, the angle of the ineffective light can be converted to that of the effective light, light the angle of which is converted is propagated in the core, light propagation having small loss can be realized and therefore, the invention carries out operation of capable of achieving a further increase in the light amount taken out from the light taking out face.

The invention described in twenty-seventh aspect of the invention is the exposing apparatus wherein the reflecting layer is formed at least at any face of a face of the wave guide opposed to the light taking out face and a face of the wave guide disposed on a side opposed to the light emitting layer and light incident on the wave guide from the light emitting layer is more reflected, ineffective light reaches the light taking out face as effective light and therefore, the invention carries out operation of capable of achieving to increase the light amount.

The invention described in twenty-eighth aspect of the invention is the exposing apparatus wherein the light taking out face is formed with diffusion restraining means for restraining diffusion of light emitted from the light taking out face and small-sized formation and thin-sized formation of the exposing apparatus can easily be achieved, since light is emitted from the direction of the face of the luminescent face by the wave guide, the luminescent area can easily be enlarge in the sub scanning direction and therefore, the luminescent light amount is increased only by enlarging the area of the luminescent layer and therefore, the invention carries out operation of capable of providing the luminescent light amount necessary for exposure without shortening element life by increasing applied current. Further, by the diffusion restraining means of light, light emitted from the light taking out face strongly advances in a front direction and therefore, light emitted from the light taking out face can efficiently be utilized for exposure and therefore, the invention carries out operation of capable of realizing an efficient exposing apparatus.

The invention described in twenty-ninth aspect of the invention is the exposing apparatus wherein light emitted from the light taking out face is focused on a photosensitive member in an erected image at equal magnification and small-sized formation and thin-sized formation of the exposing apparatus can easily be achieved, since light is emitted from the direction of the end face of the luminescent face by the wave guide, the luminescent area can easily be enlarged in the sub scanning direction and therefore, the luminescent light amount is increased by only enlarging the area of the luminescent layer and therefore, the invention carries out operation of capable of providing the luminescent light amount necessary for exposure without shortening element life by increasing applied current. Further, light emitted from the light taking out face can further efficiently be utilized in exposure by a simple constitution and therefore, the invention carries out operation of capable of realizing an inexpensive and efficient exposing apparatus.

The invention described in thirtieth aspect of the invention is the exposing apparatus wherein the organic electroluminescence element is driven by an alternating current, an alternating current voltage or a pulse wave and by the organic electroluminescence element having the large luminescent light amount in which luminescence is carried out by the plurality of luminescent layers, the invention carries out operation of capable of providing the light amount necessary for exposure without constituting the apparatus by large-sized formation.

The invention described in thirty-first aspect of the invention is the exposing apparatus of the invention described in any one of claims 1 thorough 30 wherein the organic electroluminescence element is applied with a negative voltage between the anode and the cathode when light is not emitted and by the organic electroluminescence element having the large luminescent light amount in which luminescence is carried out by the plurality of luminescent layers, the invention carries out operation of capable of providing the light amount necessary for exposure without constituting the apparatus by large-sized formation.

The invention described in thirty-second aspect of the invention is an image forming apparatus including the exposing apparatus described above and a photosensitive member formed with an electrostatic latent image by the exposing apparatus and the electrostatic latent image is property formed on the photosensitive member and therefore, the invention carries out operation of capable of forming an image of high quality. The invention carries out operation of capable of providing a compact image forming apparatus by the exposing apparatus using the organic electroluminescence element having the large luminescent latent amount in which luminescence is carried out by the plurality of luminescent layers for the light source.

### Effect of Invention

As described above, according to the invention, a light source comprises at least a light emitting unit including a light emitting layer for electrically emitting a light, and a waveguide for emitting a light irradiated from the light emitting unit into air through a light take-out surface formed on an end face, wherein an area of the light take-out surface of the waveguide is set to be smaller than that of the light emitting layer. Consequently, it is possible to obtain a very small point light source having a great brightness. By using the light source and a simple optical system, furthermore, it is possible to easily provide a very small parallel light source.

As described above, according to the invention, a light source comprises at least a light emitting unit including a light emitting layer for electrically emitting a light, and a waveguide for receiving a light irradiated from the light emitting unit onto a light incidence plane and emitting the light into air from a light emitting plane formed on a surface other than the light incidence plane, wherein the waveguide has an area of the light emitting plane which is smaller than that of the light incidence plane, and has a size decreased gradually from the light incidence plane toward the light emitting plane. Consequently, it is possible to obtain a light source having a great brightness without increasing the burden of the light emitting unit, and furthermore, to provide an exposing unit using the light source or a recording apparatus using the exposing unit.

As described above, according to the invention, exposure light is constituted by light irradiated from the luminescent layer of the organic electroluminescence element and emitted from the light taking out face constituting the end face in the sub scanning direction of the wave guide and therefore, the luminescent light amount is increased only by enlarging the area of the luminescent layer without changing the area of the light taking out face to thereby achieve an effective advantage of capable of providing the luminescent light amount necessary for exposure without shortening element life by increasing applied current.

As described above, according to the invention, in the exposing apparatus constituting exposure light by light irradiated from the luminescent layer of the organic electroluminescence element and emitted from the light taking out face which is the end face in the sub scanning direction of the wave guide, the thickness of the luminescent layer can easily be thickened and therefore, there is achieved an effective advantage of capable of realizing the exposing apparatus-having a low possibility of shortcircuit brought about by being caused by a foreign matter or a stepped difference of the electrode even when the area of the luminescent layer is large, having a high yield in fabricating the exposing apparatus and excellent in long time period stability.

Further, by constructing the constitution of carrying out luminescence by a plurality of luminescent layers, there is achieved an effective advantage of capable of realizing the exposing apparatus having high yield in fabricating the exposing apparatus having a large luminescent light amount of the organic electroluminescence element and excellent in long time period stability.

The present disclosure relates to subject matter contained in Japanese Patent Application Nos. 2002-366563, filed on Dec. 18, 2002, 2002-366564, filed on Dec. 18, 2002, 2002-366565, filed on Dec. 18, 2002, and 2003-194211, filed on Jul. 9, 2003, the contents of all are herein expressly incorporated by reference in their entireties.

What is claimed is:

1. A light source comprising:
a light emitting unit including a light emitting layer for electrically emitting a light; and
a waveguide for emitting a light irradiated from the light emitting unit into air through a light take-out surface formed on an end face,
wherein an area of the light take-out surface of the waveguide is set to be smaller than that of the light emitting layer.

2. A light source according to claim 1, wherein the light emitting unit is formed on a side surface of the waveguide.

3. A light source according to claim 1, wherein a direction of a light propagation of the waveguide is different from a direction of a normal of the light emitting layer.

4. A light source according to claim 1, wherein the light emitting unit is optically coupled to the waveguide without an air layer provided therebetween.

5. A light source according to claim 1, wherein the waveguide has a lower refractive index than that of the light emitting layer.

6. A light source according to claim 1, wherein the waveguide has a refractive index which is higher than a refractive index obtained by subtracting 0.3 from a value of the refractive index of the light emitting layer.

7. A light source according to claim 1, wherein the waveguide is formed by using the same material as a material of the light emitting layer.

8. A light source according to claim 1, wherein the waveguide is provided with an angle converting layer for converting an angle of a light.

9. A light source according to claim 8, wherein the waveguide includes a core having a predetermined refractive index and a clad formed on an outer periphery of the core and having a lower refractive index than the refractive index of the core, and
the angle converting structure for converting an angle of a light is formed on an interface between the core and the clad on an opposite side to the light emitting layer.

10. A light source according to claim 1, wherein the light emitting layer is formed on two surfaces or more other than the light take-out surface of the waveguide.

11. A light source according to claim 1, wherein the waveguide is provided with a reflecting plane on an opposed surface to the light take-out surface.

12. A light source according to claim 1, wherein the waveguide has an opposed surface to the light take-out surface which is not formed perpendicularly.

13. A light source according to claim 1, wherein the light emitting unit is an organic electroluminescence element.

14. A parallel light illuminating apparatus comprising the light source according to claim 1, and an optical system.

15. An image projecting apparatus using the parallel light illuminating apparatus according to claim 14.

16. A light source comprising:
a light emitting unit including a light emitting layer for electrically emitting a light; and
a waveguide for receiving a light irradiated from the light emitting unit onto a light incidence plane and emitting the light into air from a light emitting plane formed on a surface other than the light incidence plane,
wherein the waveguide has an area of the light emitting plane which is smaller than that of the light incidence plane, and has a size decreased gradually from the light incidence plane toward the light emitting plane.

17. A light source according claim 16, wherein the waveguide has an almost trapezoidal section.

18. A light source according to claim 16, wherein the waveguide is formed with an emitting angle converting structure capable of increasing a light emitting angle on the light emitting plane.

19. A light source according to claim 16, wherein the emitting angle converting structure is of a mesa type in which a section is continuously enlarged with respect to the light emitting plane.

20. A light source according to claim 16, wherein the emitting angle converting structure is a lens formed on the light emitting plane.

21. A light source according to claim 16, wherein the waveguide forms a propagation angle converting mechanism for changing a reflecting angle of a light on a surface excluding the light emitting plane.

22. A light source according to claim 16, wherein the propagation angle converting structure is saw-toothed.

23. A light source according to claim 16, wherein the light emitting unit is constituted by an organic electroluminescence element including an anode for injecting a hole, a light emitting layer having a light emitting region and a cathode for injecting an electron.

24. A light source according to claim 16, wherein the waveguide includes a core having a predetermined refractive index, and a clad formed on an outer periphery of the core and having a lower refractive index than that of the core.

25. A light source according to claim 16, wherein the waveguide has a periphery covered with a reflecting plane.

26. A the light source according to claim 16, wherein the light emitting unit is provided with an air layer interposed together with the light incidence plane.

27. A light source according to claim 16, wherein the light emitting unit is formed with an emitting angle converting structure on a light emitting plane.

28. A light source according to claim 16, wherein the light emitting plane is formed on a surface other than an opposed surface to the light incidence plane.

29. A light source according to claim 16, wherein the waveguide has such a shape that a waveguide structure having an almost trapezoidal section and a waveguide structure having a triangular section are coupled to each other.

30. An exposing device for use as an optical printer head comprising a plurality of light emitting units arranged in a line which can emit a signal light corresponding to a data signal, and a photosensitive member capable of forming an optional latent image by irradiation of the signal light,
the exposing device comprising the light source according to claim 16.

31. The exposing device according to the claim 30, wherein a plurality of waveguides are divided optically in a main scanning direction for each pixel arranged in parallel with each other.

32. The exposing device according to claim 30, wherein the waveguide is not provided with a light shielding layer between substrates which are adjacent to each other.

33. The exposing device according to claim 30, wherein the waveguide is provided with light amount transmitting means for forming an erected equal magnification image together with a light emitting plane on an outside thereof.

34. An image forming apparatus comprising:
a photosensitive member capable of forming an electrostatic latent image;
charging means for forming a uniform electric potential on a surface of the photosensitive member by discharging means;
exposing means as claimed in claim 30 for irradiating a signal light corresponding to an image signal, thereby forming a latent image
toner sticking means for sticking a toner onto a surface on which the latent image is formed;
toner transferring means for transferring a toner onto a transfer material; and
control means for controlling each portion, wherein a recording apparatus uses.

35. An exposing apparatus comprising:
an organic electroluminescence element including an anode for injecting holes, a luminescent layer having a luminescent region and a cathode for injecting electrons, the organic electroluminescence element being formed on a board as a light source; and
a waveguide an end face in a sub scanning direction of which is made to constitute a light taking out face and light irradiated from the luminescent layer and incident on the wave guide and emitted from the light taking out face is used as exposure light.

36. The exposing apparatus as claimed in claim 35, wherein the waveguide is integrated with a board.

37. The exposing apparatus as claimed in claim 35, wherein a plurality of pieces of the waveguides optically isolated in a main scanning direction for respective pixels are aligned in parallel with each other.

38. The exposing apparatus as claimed in claim 35, wherein the waveguide includes a core having a predetermined refractive index and a clad formed at an outer periphery of the core and having a refractive index smaller than the refractive index of the core.

39. The exposing apparatus as claimed in claim 38, wherein the core is provided with a refractive index smaller than a refractive index of the luminescent layer.

40. The exposing apparatus as claimed in claim 35, wherein the refractive index of the core is larger than a value constituted by subtracting 0.3 from the refractive index of the luminescent layer

41. The exposing apparatus as claimed in claim 37, wherein a light shielding layer or a reflecting layer is provided between the waveguides contiguous to each other.

42. The exposing apparatus as claimed in claim 35, wherein the light taking out face is constituted by a shape in correspondence with a shape of a pixel.

43. The exposing apparatus as claimed in claim 35, wherein the waveguide is formed with an angle converting portion for converting an angle of light incident on the wave guide from the luminescent layer to guide to the light taking out face.

44. The exposing apparatus as claimed in claim 35, wherein the angle converting portion guides light in a direction other than the sub scanning direction to the light taking out face.

45. The exposing apparatus as claimed in claim 44, wherein the angle converting portion carries out angle conversion with respect to a direction orthogonal to either of main scanning and sub scanning to guide to the light taking out face.

46. The exposing apparatus as claimed in claim 44, wherein the angle converting portion is formed at an interface between the core and the clad disposed on a side opposed to the luminescent layer.

47. The exposing apparatus as claimed in claim 35, wherein a reflecting layer is formed at least at any face of a face opposed to the light taking out face and a face of the waveguide disposed on a side opposed to the luminescent layer.

48. The exposing apparatus as claimed in claim 35, wherein the light taking out face is formed with diffusion restraining means for restraining diffusion of light emitted from the light taking out face.

49. The exposing apparatus as claimed in claim 35, wherein light emitted from the light taking out face is focused on a photosensitive member in an erected image at equal magnification.

50. An image forming apparatus comprising:
an exposing apparatus as claimed in claim 35; and
a photosensitive member formed with an electrostatic latent image by the exposing apparatus and the electrostatic latent image is properly formed on the photosensitive member and therefore, the invention carries out operation of capable of forming a high quality image.

51. An exposing apparatus comprising:
an organic electroluminescence element including:
an anode electrode for injecting holes;
a cathode electrode for injecting electrons; and
a luminescent layer formed between the anode and the cathode and having a luminescent region and a thickness of the luminescent layer is made to be thickened than a thickness of the electrode, the organic electroluminescence element being formed on a board as a light source; and
a waveguide an end face in a sub scanning direction of which is made to constitute a light taking out face
wherein light irradiated from the organic electroluminescence element and incident on the waveguide and emitted from the light taking out face is used as exposure light.

52. An exposing apparatus comprising:
an organic electroluminescence element including:
an anode electrode for injecting holes;
a cathode electrode for injecting electrons; and
a luminescent layer on a side proximate to the anode having a luminescent region and disposed on the side of the anode and a luminescent layer on a side proximate to the cathode having a luminescent region disposed on the side of the cathode, which are respectively formed between the anode and the cathode, and
charge generating layers formed between the luminescent layer on the side proximate to the anode and the luminescent layer on the side proximate to the cathode, for injecting electrons to the luminescent layer on the side proximate to the anode and injecting holes to the luminescent layer on the side proximate to the cathode, the organic electroluminescence element being formed on a board as a light source; and
a waveguide an end face in a sub scanning direction of which is made to constitute a light taking out face
wherein light irradiated from the organic electroluminescence element and incident on the waveguide and emitted from the light taking out face is used as exposure light.

53. The exposing apparatus as described in claim 52, wherein an ionization potential of the charge generating layer is higher than an ionization potential of the luminescent layer on the side proximate to the cathode.

54. The exposing apparatus as described in claims 52, wherein an electron affinity of the charge generating layer is lower than an electron affinity of the luminescent layer on the side proximate to the cathode.

55. The exposing apparatus as described in claim 52, wherein a potential difference between an electron affinity of the luminescent layer on the side proximate to the anode and the charge generating layer and a potential difference between an ionization potential of the luminescent layer on the side proximate to the cathode and the charge generating layer is set to be equal to or smaller than 0.6 eV.

56. The exposing apparatus as described claim 52, wherein the charge generating layers comprises:
a first charge generating layer disposed on a side of the luminescent layer on the side proximate to the anode; and
a second charge generating layer disposed on a side of the luminescent layer on the side proximate to the cathode,
wherein the first charge generating layer is set with an electron affinity lower than an electron affinity of the second charge generating layer, and
the second charge generating layer is set to an ionization potential higher than the first charge generating layer.

57. The exposing apparatus as described in claim 56, wherein an initially formed charge generating layer is formed by resistance heating.

58. The exposing apparatus as described claim 52, wherein the charge generating layer comprises a dielectric substance and a specific inductive capacity of the charge generating layer is equal to or larger than specific inductive capacities of the luminescent layer on the side proximate to the anode and the luminescent layer on the side proximate to the cathode.

59. The exposing apparatus as described in claim 52, wherein the luminescent layer on the side proximate to the anode and the luminescent layer on the side proximate to the cathode are formed by members the same as each other.

60. An exposing apparatus comprising:
an organic electroluminescence element including:
a plurality of anode electrodes for injecting holes;
a plurality of cathode electrodes arranged alternately with the anode electrodes for injecting electrons; and
a plurality of luminescent layers, each having a luminescent region defined between the anode electrode and the cathode electrode; and
a wave guide an end face in a sub scanning direction of which is made to constitute a light taking out face,
wherein light irradiated from the organic electroluminescence element and incident on the wave guide and emitted from the light taking out face is used as exposure light.

61. The exposing apparatus as described in claim 60, wherein the luminescent layers are constituted by members the same as each other.

62. The exposing apparatus as described in claim 60, wherein a layer including the luminescent layer disposed between an initially formed electrode and a successively formed electrode comprises a polymer.

63. An exposing apparatus comprising:
an organic electroluminescence element including:
an anode electrode for injecting holes;
a cathode electrode for injecting electrons; and
a luminescent layer formed between the anode and the cathode and having a luminescent region, the organic electroluminescence element being formed on a board as a light source; and
a waveguide an end face in a sub scanning direction of which is made to constitute a light taking out face
wherein light irradiated from the organic electroluminescence element and incident on the waveguide and emitted from the light taking out face is used as exposure light, and
the luminescent layer is formed by a material capable of forming the luminescent layer at least by coating.

64. An exposing apparatus comprising:
an organic electroluminescence element including:
an anode electrode for injecting holes;
a cathode electrode for injecting electrons; and
a luminescent layer formed between the anode and the cathode and having a luminescent region, the organic electroluminescence element being formed on a board as a light source; and
a waveguide an end face in a sub scanning direction of which is made to constitute a light taking out face
wherein light irradiated from the organic electroluminescence element and incident on the waveguide and emitted from the light taking out face is used as exposure light, and
a stepped difference formed by the board and the electrode formed above the board is made to be equal to or smaller than a thickness of the luminescent layer.

65. The exposing apparatus as described in claim 64 wherein a layer including the luminescent layer comprises a polymer.

66. The exposing apparatus as described in claim 51, wherein the waveguide is integrated with the board.

67. The exposing apparatus as described claims 51, wherein a plurality of pieces of the waveguides optically isolated in a main scanning direction for respective pixels are aligned in parallel with each other.

68. The exposing apparatus as described in claim 51, wherein the waveguide includes a core having a predetermined refractive index and a clad formed at an outer periphery of the core and having a reflective index smaller than the refractive index of the core.

69. The exposing apparatus as described in claim 68 wherein the core is provided with a refractive index smaller than a refractive index of the luminescent layer.

70. The exposing apparatus as described in claim 68, wherein the refractive index of the core is larger than a value constituted by subtracting 0.3 from the refractive index of the luminescent layer.

71. The exposing apparatus as described in claim 51, further comprising a light shielding layer or a reflecting layer between the waveguides contiguous to each other.

72. The exposing apparatus as described in claim 51, wherein the light taking out face is constituted by a shape in correspondence with a shape of the pixel.

73. The exposing apparatus as described in claim 51, wherein the wave guide is formed with an angle converting portion for guiding light incident on the wave guide from the luminescent layer to the light taking out face by converting an angle of the light.

74. The exposing apparatus as described in claim 73 wherein the angle converting portion guides light in a direction other than the sub scanning direction to the light taking out face.

75. The exposing apparatus as described in claim 73, wherein the angle converting portion converts the angle to a direction orthogonal to either of main scanning and sub scanning to guide the light to the light taking out face.

76. The exposing apparatus as described claim 73, wherein the angle converting portion is formed at an interface between the core and the clad disposed on a side opposed to the luminescent layer.

77. The exposing apparatus as described in claim 51, wherein the reflecting layer is formed at least at any face of a face of the wave guide opposed to the light taking out face and a face of the wave guide disposed on a side opposed to the light emitting layer.

78. The exposing apparatus as described claim 51, wherein the light taking out face is formed with diffusion restraining means for restraining diffusion of light emitted from the light taking out face.

79. The exposing apparatus as described in claim 51, wherein light emitted from the light taking out face is focused on a photosensitive member in an erected image at equal magnification.

80. The exposing apparatus as described in claim 51, wherein the organic electroluminescence element is driven by an alternating current, an alternating current voltage or a pulse wave.

81. The exposing apparatus as described in claim 51, wherein the organic electroluminescence element is applied with a negative voltage between the anode and the cathode when light is not emitted.

82. An image forming apparatus including the exposing apparatus described in claim 51 and a photosensitive member formed with an electrostatic latent image by the exposing apparatus and the electrostatic latent image is property formed on the photosensitive member.
